(19) United States
(12) Patent Application Publication
(10) Pub. No.: US 2010/0311849 A1
(43) Pub. Date: Dec. 9, 2010

(54) Using Reactive Block Copolymers as Chain Extenders and Surface Modifiers

(75) Inventors: Alfonso González Montiel, Atizapan de Zaragoza (MX); Leticia Flores Santos, Metepec (MX); Pablo Esparza Hernández, Toluca (MX)

Correspondence Address: Stephen S. Hodgson;Patent Attorney, 2636 Albans Rd., Houston, TX, 77005, US

(73) Assignee: CID Centro de Investigacion y Desarrollo Tecnologico SA de CV, Lerma (MX)

(21) Appl. No.: 12/788,681

(22) Filed: May 27, 2010

Related U.S. Application Data
(63) Continuation-in-part of application No. 11/508,407, filed on Aug. 23, 2006.
Application No. 11/508,407 is a continuation-in-part of application No. 11/711,206, filed on Feb. 26, 2007.
Application No. 11/711,206 is a continuation-in-part of application No. 12/072,173, filed on Feb. 25, 2008.
(60) Provisional application No. 61/217,862, filed on Jun. 5, 2009.

(51) Int. Cl. C08J 11/04; C08F 299/00

(52) U.S. Cl. 521/48; 525/94; 525/92 B; 525/92 E; 525/92 J; 525/92 L; 525/92 M; 521/40; 521/49

(57) ABSTRACT

A process is provided for making a reactive-block-copolymer chain extender and for using the chain extender to couple polymer chains together for increasing the average molecular weight of the polymer chains. The chain extender can be reacted with polymeric materials that have functional groups and low molecular weight to couple polymer chains together and increase the average molecular weight, thereby increasing intrinsic viscosity and improving properties of the polymeric material. The chain extender is particularly useful for recycling polyethylene terephthalate (PET) and other polymers with functional groups and is also useful as a surface modifier and as a compatibilizer for polymeric materials that do not have reactive functional groups, such as polyethylene, polypropylene and polystyrene.

### CROSS REFERENCE TO RELATED APPLICATIONS

This application claims priority to U.S. Provisional Patent Application Ser. No. 61/217,862 filed Jun. 5, 2009, which is incorporated by reference, and this application is a continuation in part of each of the following U.S. patent application Ser. Nos.: 11/508,407, filed Aug. 23, 2006, 11/711,206, filed Feb. 26, 2007; and 12/072,173, filed Feb. 25, 2008, each of which is incorporated by reference. A related application entitled “Using Reactive Block Copolymers as Chain Extenders and Surface Modifiers” is filed concurrently herewith and also claims priority to U.S. Provisional Patent Application Ser. No. 61/217,862 filed Jun. 5, 2009, and is incorporated by reference. U.S. patent application Ser. No. 11/508,407, filed Aug. 23, 2006, claims priority to U.S. Provisional Patent Application Ser. No. 60/711,890, filed on Aug. 26, 2005, which is incorporated by reference.

### BACKGROUND OF THE INVENTION

1. Field of the Invention

The present invention pertains to a process for making block copolymers containing a reactive functional group, such as anhydride, epoxy, amine, amide, hydroxyl or acid groups, in two or more blocks via free radical polymerization in the presence of a stable free radical, a composition of matter comprising block copolymers containing a reactive monomer or monomers in two or more blocks via free radical polymerization and use of the composition of matter as a chain extender for polymeric materials and/or for recycling polymeric materials. The present invention further pertains to using reactive block copolymers of the present invention to modify the properties of a polymeric material, particularly the surface properties.

2. Description of the Related Art

There is a great deal of interest in recycling condensation polymers such as polyethylene terephthalate (PET), polyamides and polycarbonates. However, use and reprocessing breaks down polymer chains, reducing molecular weight and intrinsic viscosity, making it difficult to recycle used products and containers into high-value products. A number of chemical compounds have been used as chain extenders to link polymer chains together to obtain longer chains with a resulting higher molecular weight.

Firas Awajaa, Department of Applied Chemistry, RMIT University, Melbourne, Australia, and Dumitru Pavel, National Research Council of Canada, Ottawa, Canada, published an article entitled “Recycling of PET,” which provides a good review of the state of the art in recycling PET materials. See Awajaa and Pavel, “European Polymer Journal,” volume 41, issue 7, July 2005, pages 1453-1477. In particular, the authors provide a good review of papers on chain extension, chain extenders, variables that should be considered and on a reactive extrusion process.

The authors, Awajaa and Pavel, describe the current state of chain extension as a process where a low molecular weight material having di- or poly-functionality is reacted with carboxyl and/or hydroxyl end groups in PET to rejoin broken polymer chains, which may have been broken primarily due to chain scissions during melt processing. The authors' review of literature suggested that chain extenders can provide a blocking reaction where a molecule of chain extender reacts with one chain of PET or a coupling reaction where a molecule of chain extender joins two PET chains, which is the desired reaction.

Awajaa and Pavel found that a number of chemical compounds have been used as chain extenders. They found that investigators focused on raising the intrinsic viscosity [η] of the PET as this was a good indicator for whether a chain extender increased the molecular weight of a recycled PET. The papers the authors reviewed suggested that additive type di or poly functional chain extenders were preferred as chain extenders because they provided higher reaction rates than other existing chain extenders and did not generate undesirable by-products. The authors reviewed papers that reported addition-type chain extenders were effective chain extenders for linear PET, where such chain extenders included diepoxides, bis-2-oxazolines and bis-5,6-dihydro-4h-1,3-oxazines.

The authors suggested that chain extenders for PET can be classified according to the functional end group with which the chain extender reacts. The authors' review of papers found that chain extenders that react with carboxyl end groups not only lengthen chains and increase molecular weight, but also increase hydrolytic and thermal stability due to lower carboxyl content, which helps to prevent a reduction in molecular weight while the recycled PET is melt processed. Carboxyl-reactant chain extenders include 2,2′-bis(2-oxazoline), 2,2′-bis(5,6-dihydro-4h-1,3-oxazine), and N,N′-hexamethylene-bis(2-carbonyl 1,2-oxazoline). Another group of chain extenders were reported to react with hydroxyl groups on PET. Hydroxyl-reactive chain extenders include 2,2′-bis(3,1-benzoxanin-4-one).

The authors found numerous reports of problems or disadvantages in using certain chain extenders. For example, the authors found that one investigator reported that bis(2-oxazoline) (BO) is sensitive to acidic compounds due to the sensitivity of the oxazolinic ring in this chain extender. A paper reviewed by Awajaa and Pavel reported diisocyanates were more effective chain extenders than BO and diepoxides, but their use resulted in product discoloration, while bisepoxy compounds, bis(cyclic carboxylic anhydride) and diisocyanates undesirably increased branching and/or the development of less thermally stable linkages in the polymer chains. Although branching and cross-linking can beneficially increase molecular weight, gel formation becomes a problem at some point.

Gel formation is discussed in U.S. Pat. No. 6,984,694, which issued to Blasius, Jr. et al. on Jan. 10, 2006, and which is incorporated by reference. The '694 patent describes oligomeric and low molecular weight chain extenders made from epoxy-functional (meth)acrylic monomers and styrenic and/or (meth)acrylic monomers, which are said to improve the physical characteristics of polycondensates and polycondensate blends. The '694 patent claims a chain-extended polymeric composition that is substantially free of gel particles. The chain-extended polymeric composition comprises the chain extender, which has a number average molecular weight of less than 6,000, and a condensation polymer. Blasius is also the first-named inventor in U.S. Patent Application Pub. No. 20080206503, published 28 Aug. 2008 and incorporated by reference, which appears to describe a solid concentrate composition of the chain extender described in the '694 and a non-reactive carrier resin.

U.S. Pat. No. 3,391,582, issued to Muschiatti et al. and incorporated by reference, is directed to foamed material made from virgin and recycled PET. The '582 patent describes a branching agent for achieving a branched PET that is more suitable than an unbranched PET for foams and a chain extender for use with the recycled PET. The chain extenders or crosslinking agents suggested include acid, epoxy and anhydride functionalized ethylene copolymers; carboxylic acids, acid anhydrides, polyols and epoxies having low molecular weights; and partially neutralized ethylene methacrylic acid and acrylic acid copolymers.

Triphenyl phosphite (TPP) has also been evaluated for use as a chain extender for PET. See Cavalcanti, Teofilo, Rabello and Silva, “Chain Extension and Degradation during Reactive Processing of PET in the Presence of Triphenyl Phosphite,” Polymer Engineering and Science, Dec. 1, 2007. The authors found that TPP provided chain extension for PET, but the benefits of chain extension were offset by chemical degradation that was apparently caused by TPP-PET reaction by-products.

Although a number of technologies and chain extenders exist for recycling condensation polymers such as polyethylene terephthalate (PET), polyamides and polycarbonates, there remains a need for a technology and a family of chain extenders that will allow greater recycling of condensation polymers and improved properties in compositions of material that contain recycled condensation polymers.

In another aspect the present invention pertains to modification of the surface of a polymeric material, and U.S. Pat. No. 3,686,355, issued to Gaines et al. and incorporated by reference, describes a block copolymer having one block miscible or compatible with a base polymer and another block for imparting desired properties to the surface of the base polymer. Monomers such as dimethylsiloxane, pentadecafluoro-octyl methacrylate and 2-(N-propylperfluoro-octane sulfonamido) ethyl acrylate were used in the block copolymer to modify the surface properties of the base polymer.

U.S. Patent Application Pub. No. 2008/0139689 A1, listing inventors Huang et al. and incorporated by reference, describes a surface modification process using a polymer formed by controlled radical polymerization that has functional groups, which can be modified after controlled radical polymerization to form a radical. The polymer can be a block copolymer having a first group that is stimulated by an energy, such as light energy, to attach to a surface, such as a polymeric surface, and a second group for providing a desired functionality to the surface. A block copolymer film is thus adhered to a target surface by bonding between one block and the target following energy activation. Another block in the block copolymer provides functionality to the target surface to provide properties such as corrosion resistance, color, friction, biocompatibility, adsorption, wettability, friction and adhesion.

U.S. Pat. No. 6,716,926, issued to Børve and incorporated by reference, describes a process for making a polyolefin having improved adhesion performance to provide paintability. A polar material is blended into the polyolefin and migrates to the surface of an article to provide polar groups at the surface to make the surface paintable. Grafting monomers are pre-mixed with a high-flow polyolefin resin to obtain a pre-mix, which is then mixed with a low-flow polyolefin and heated above their melting points. The polyolefin that is grafted has relatively short chains and does not have suitable performance properties, so the grafted high-flow resin is blended with a low-flow resin to obtain suitable performance properties, while the grafting monomer provides polar groups for paintability.

U.S. Patent Application Pub. No. 2007/0299238 A1, listing inventors Gopferich et al. and incorporated by reference, concerns biodegradable block copolymers that can be used in humans for tissue engineering and therapeutic and diagnostic purposes and for applications such as drug-delivery and drug-targeting systems for controlled release and targeted administration of active substances. The block copolymer has a hydrophobic biodegradable polymer block and a hydrophilic polymer block. The block copolymer has one or more reactive functional groups that covalently bond a surface-modifying substance to the hydrophilic polymer block. Reactive functional groups include: a single functional group for covalent bonding to the hydrophilic polymer, for example through an activated acid function or through an epoxide, including functional groups such as an amino group, a hydroxyl group, thiol, carboxylic acid, acid chloride, keto group; dicarboxylic acids such as succinic and tartaric acid that have terminal groups such as succinimidyl esters; dialdehydes such as glutaric dialdehyde; molecules such as N-succinimidyl-3-(2-pyridyldithio)propionate (SPDP) and succinimidyl-4-(N-maleimidomethyl)-cyclohexane-1-carboxylate (SMCC); photoreactive crosslinkers such as N-hydroxysuccinimidyl-4-acidosalicylic acid and sulphosuccinimidyl-2-(p-acidosalicylic amido)ethyl-1,3′-dithiopropionate.

The surface of paper has been modified using amphiphilic block copolymers as described in International Patent Application Pub. No. WO2007063172 A1, which lists Seppaelae et al. as inventors and which is incorporated by reference, also published as EP1954878 A1. A thin layer of an amphiphilic block copolymer having a hydrophilic block and a hydrophobic block is applied to paper. Examples of monomers for the hydrophilic block include polyvinyl alcohol, polyethylene oxide, polyvinyl pyrrolidone, a water-soluble polysaccharide, polyhydroxy ethylmetacrylate, polydimethylamino-ethylmethacrylate, polyacrylamide, polyacrylic acid and polymethacrylic acid. Examples of monomers for the hydrophobic block include styrene, derivatives of acrylic acid such as methylmethacrylate and butylmethacrylate, vinyl acetate, alkyl acids such as n-octadecenyl succinic acid and alkyl anhydrides such as a succinic acid anhydride.

International Patent Application No. PCT/EP01/13132, Pub. No. WO 02/42530 A1, listing inventors Li et al., assigned to CIBA Specialty Chemicals Holdings Inc., which is incorporated by reference, describes polyolefin fibers that are made wettable by incorporation of a diblock amphiphilic co-oligomer into the polyolefin prior to making the fiber. One block of the co-oligomer is a straight or branched chain alkyl having 22 to 40 carbon atoms, and the other block consists of two to ten monomer units of vinyl alcohol, vinyl acetate, acrylic acid, methacrylic acid, ethylene imine, caprolactone, epichlorhydrin, ethylene glycol, propylene glycol, ethylene oxide and propylene oxide.

Polymeric materials having a wide variety of compositions are used in diverse applications. Although there is a great deal of technology available for adapting the surface of a polymeric material for a particular application, including, in addition to the technologies described above, surface primers and flame, corona discharge and gas plasma treatments, a need remains for surface modifiers in numerous applications.

### SUMMARY OF THE INVENTION

The present invention provides a process for making a block copolymer having a first block with functional groups provided via an acrylic monomer, where no purification step is used after polymerizing the first block so that an amount of unreacted residual monomer, which has functional groups, is intentionally left in the reaction product from the first step. A second block is added to the first block to form the block copolymer. The second block is preferably polymerized from at least one vinyl monomer and the residual unreacted monomer that has functional groups. Functional groups are consequently added into the second block, as well as into the first block. The block copolymer thus formed is reactive and performs well as a chain extender or coupling agent for a number of polymers including condensation polymers such as polyethylene terephthalate (PET), polyamides and polycarbonates. The description of these reactive block copolymers in the parent patent document emphasized their use as a compatibilizer between dissimilar materials, while it is emphasized here that the reactive block copolymers are also useful as a chain extender or coupling agent for the same and/or similar polymeric materials.

In one embodiment, the present invention provides a process for making a block copolymer, which includes the steps of reacting an acrylic monomer, which has functional groups, and one or more vinyl monomers in the presence of a free radical initiator and a stable free radical to form a reaction product, where the reaction product includes residual unreacted acrylic monomer, and reacting one or more vinyl monomers with the reaction product to form a second block, where the second block incorporates the residual unreacted acrylic monomer. The block copolymer made by this process is referred to generally herein as a reactive block copolymer. The reactive block copolymer is typically made using a nitroxide-based stable free radical, but in one embodiment, iodine is used as the stable free radical. The process preferably further includes reacting the reactive block copolymer with a first polymeric material and with a second polymeric material, wherein the first and second polymeric materials may have the same, similar and/or different compositions. The process preferably further includes recycling the first and/or second polymeric materials, where the first and/or second polymeric material is reclaimed after it was previously formed in a polymerization reaction and reacted with the block copolymer to form a recycled polymeric product that has a greater molecular weight than the reclaimed polymeric material. In one embodiment, the recycled polymeric material includes material dissimilar to the first polymeric material, and the dissimilar material is compatibilized with the first polymeric material by the block copolymer.

In one embodiment, the reactive block copolymer is adapted for use as a compatibilizer for blends of materials, particularly for blends of thermoplastic polymers, and in another embodiment, the reactive block copolymer is adapted for use as a chain extender or coupling agent. The present invention provides a composition for a recycled plastic that includes about 80 to about 99 weight percent of a polymer reclaimed from formed or molded articles and has reactive functional groups and about 1 to about 20 weight percent of the reactive block copolymer, where the reclaimed polymer and the reactive block copolymer are bound together to form the recycled plastic, and the average molecular weight of the recycled plastic is greater than the average molecular weight of the reclaimed polymer. The reclaimed polymer is preferably a polyester, and preferably, the functionalized acrylic monomer is glycidyl methacrylate.

A typical inventive chain-extended composition comprises from about 1 to about 98 wt % of a first thermoplastic polymer, which has functional groups selected from the group consisting of amino, amide, imide, carboxyl, carbonyl, carbonate, ester, anhydride, epoxy, sulfo, sulfonyl, sulfinyl, sulfhydryl, cyano and hydroxyl, from about 0.01 to about 25 wt % of a block copolymer that includes a first block, which has monomeric units of a functionalized acrylic monomer and monomeric units of a vinyl monomer and a second block, which has monomeric units of one or more vinyl monomers and monomeric units of the functionalized acrylic monomer in the first block, and from about 1 to about 98 wt % of a second thermoplastic polymer that also has functional groups, wherein the first and second thermoplastic polymers are the same and/or similar and/or different compositions, and wherein the acrylic monomer has functional groups that should react with the functional groups in both the first and second thermoplastic polymers. Preferably, the first and second thermoplastic polymers are polyesters. The functionalized acrylic monomer in the block copolymer is preferably glycidyl methacrylate. The vinyl monomer in the first and second blocks of the block copolymer is preferably styrene.

In another embodiment, the present invention provides a process for modifying the surface of a polymeric material by mixing the polymeric material with a reactive block copolymer to form a modified polymeric material, wherein the modified polymeric material has a surface energy that is different from the surface energy of the polymeric material. Preferably, the functional groups on the acrylic monomer are selected to impart a desired property on the surface of the polymeric material. In one embodiment, the stable free radical controlling agent is preferably dibenzyl trithiocarbonate, which is believed to form a triblock reactive block copolymer.

Another embodiment of the present invention provides a process for increasing the average molecular weight of a polymeric material and changing the surface properties of the polymeric material, comprising the steps of reacting a first polymer with a reactive block copolymer, and reacting a second polymer with the reactive block copolymer, where the first and second polymers may be the same polymers or different polymers, where the first and second polymers have reactive functional groups whereby a bond forms between the first polymer and the reactive block copolymer and a bond forms between the second polymer and the reactive block copolymer such that the reactive block copolymer serves as a common backbone for the first and second polymers, and where the functional groups on the acrylic monomer alter the surface properties of the first and second polymers.

### BRIEF DESCRIPTION OF THE DRAWINGS

A better understanding of the invention can be obtained when the detailed description of exemplary embodiments set forth below is considered in conjunction with the attached figures, which are described as follows.

FIG. 1 is a graph of torque measurements taken every 30 seconds over a five-minute period for recycled PET with no chain extender (example 14), with 5% wt random copolymer (example 16) and with 5% wt chain extender of the present invention (example 15).

FIG. 2 is a graph of torque measurements taken every 30 seconds over a seven-minute period for recycled PET comparing no chain extender (example 17) with 3% wt chain extender of the present invention (example 18) and with 3% wt of a methacrylic ester-acrylic ester copolymer chain extender with greater than 98 wt % glycidyl methacrylate (example 19), 3% wt of a mixture of bisphenol A and an aliphatic glycidyl ether chain extender (example 20), and with 3% wt triphenyl phosphine chain extender (example 21).

FIG. 3 is a graph of torque measurements taken every 30 seconds over a seven-minute period for recycled PET comparing no chain extender (example 17) with 5% wt chain extender of the present invention (example 22) and with 5% wt of a methacrylic ester-acrylic ester copolymer chain extender with greater than 98 wt % glycidyl methacrylate (example 23), 5% wt of a mixture of bisphenol A and an aliphatic glycidyl ether chain extender (example 24), and with 5% wt triphenyl phosphine chain extender (example 25).

FIG. 4 is a graph of torque measurements taken every 30 seconds over a seven-minute period for recycled PET comparing no chain extender (example 17) with 7% wt chain extender of the present invention (example 26) and with 7% wt of a methacrylic ester-acrylic ester copolymer chain extender with greater than 98 wt % glycidyl methacrylate (example 27), 7% wt of a mixture of bisphenol A and an aliphatic glycidyl ether chain extender (example 28), and with 7% wt triphenyl phosphine chain extender (example 29).

FIG. 5 is a graph of torque measurements taken every 30 seconds over a seven-minute period for recycled PET comparing no chain extender (example 17) with 3% wt chain extender of the present invention (example 18) and with 0.5% wt of an epoxy functionalized oligomer in a carrier resin (example 30), 1% wt of the epoxy functionalized oligomer in a carrier resin (example 31), and with 2% wt of the epoxy functionalized oligomer in a carrier resin (example 32).

FIG. 6 is a graph of torque measurements taken every 30 seconds over a thirty-minute period for polylactic acid comparing no chain extender (example 48) with chain extender of the present invention at use levels of 4% wt (example 49), 6% wt (example 50), 8% wt (example 51) and with 8% wt polystyrene (example 52).

FIG. 7 is a graph of torque measurements taken every 30 seconds over a thirty-minute period for polycarbonate comparing no chain extender (example 53) with chain extender of the present invention at use levels of 4% wt (example 54) and 8% wt (example 55) and with 8% wt polystyrene (example 56).

FIG. 8 is a graph of torque measurements taken every 30 seconds over a thirty-minute period for an equal-parts blend of polycarbonate and recycled PET comparing no chain extender (example 57) with chain extender of the present invention at use levels of 4% wt (example 58), 6% wt (example 59) and 8% wt (example 60) and with 8% wt polystyrene (example 61).

FIG. 9 is a graph of torque measurements taken every 30 seconds over a thirty-minute period for polybutylene terethphalate (PBT) comparing no chain extender (example 62) with chain extender of the present invention at a use level of 8% wt (example 63) and with 8% wt polystyrene (example 92).

FIG. 10 is a graph of torque measurements taken every 30 seconds over a thirty-minute period for a 70:30 blend of PBT and recycled PET, respectively, comparing no chain extender (example 65) with chain extender of the present invention at a use level of 8% wt (example 66) and with 8% wt polystyrene (example 67).

FIG. 11 is a graph of torque measurements taken every 30 seconds over a five-minute period for recycled PET with no chain extender (example 70) with 1 wt % (example 71), 3 wt % (example 72) and 5% wt (example 73) chain extender of the present invention.

FIG. 12A shows graphically the contact angle of 63.8° between the surface of a bead of water with respect to the surface of untreated polypropylene.

FIG. 12B shows graphically the contact angle of 45.4° between the surface of a bead of water with respect to the surface of a sample that contains 90% polypropylene and 10% wt of a diblock copolymer of the present invention.

### DETAILED DESCRIPTION OF THE EXEMPLARY EMBODIMENTS

The present invention provides a process, a block copolymer made by the process in which the composition, microstructure and molecular weight of the block copolymer are carefully controlled, and applications for the block copolymer as a compatibilizer, chain extender, coupling agent and/or as a crosslinking agent. The term microstructure refers to a detailed sequence or arrangement of units of each of the monomers in an average or typical copolymer chain. The term composition refers to the overall average relative amount of monomers in copolymer chains, which can be expressed in a molar or weight basis. In particular, one embodiment of the invention comprises block copolymers having a first block of a random copolymer with a total length between 1 and 720 monomeric units and a second block that incorporates residual monomers left over from polymerizing the first block and one or more additional monomers, where the second block has a length between 100 and 2000 monomeric units.

A block copolymer can be made according to the present invention using a two-step process comprising: (1) reacting an acrylic monomer having functional groups and one or more vinyl monomers in the presence of a free radical initiator and a stable free radical to form a reaction product, wherein the reaction product includes residual unreacted acrylic monomer, and (2) reacting one or more vinyl monomers with the reaction product from step one to form a second block, wherein the second block incorporates the residual unreacted acrylic monomer. Monomers are polymerized using a stable free radical and a traditional free radical initiator or an alcoxyamine, and in a second step, monomers and optionally more initiator are added. An initial portion of the second block may tend to have a higher proportion of the acrylic monomer because the acrylic monomer may become depleted before a final portion of the second block is formed by polymerization of the one or more vinyl monomers in the near absence of acrylic monomer. Solvents can be used optionally in either or both steps.

The block copolymer of the present invention has a number of applications, one of which is as a compatibilizer for making blends of different materials, such as two different thermoplastics or of a thermoplastic and a glass or clay, that are otherwise relatively immiscible. Such compatibilizers used in the past for blending were often a block copolymer having a first block compatible with a first material and a second block compatible with a second material, where the first and second blocks were each essentially pure. The present inventors discovered unexpectedly that a block copolymer having a relatively impure second block, where the second block includes monomer used in the first block, performs well as a chain extender and as a surface modifier.

Parent U.S. patent application Ser. No. 11/508,407, filed Aug. 23, 2006, published as U.S. Publication No. 20070049696 A1, which is incorporated in its entirety by reference for all purposes, focused on using the reactive block copolymers of the present invention as compatibilizers for different polymers and materials, but it has been discovered that the reactive block copolymers of the present invention also have application for the same or similar materials, although the term “compatibilizer” is not generally used for applications involving the same or similar materials. In applications involving connecting together the same or similar polymer materials, the term “chain extender” is used frequently. The terms “coupling agent” and “crosslinking agent” are also used with respect to connecting the same, similar and/or different polymeric materials together. The reactive block copolymers of the present invention can be tailored for applications as compatibilizers, chain extenders, coupling agents, crosslinking agents and as surface modifiers.

Chemical Synthesis of Reactive Block Copolymers

In a first step, an acrylic monomer that has functional groups is copolymerized in a reactor with at least one vinyl monomer using a free radical initiator and a stable free radical, which forms a first block in the reactor. The reaction is conducted so as to leave an amount of residual unreacted acrylic monomer after the completion of the first step so that the first block is mixed in with the residual unreacted acrylic monomer. A solvent can be used in the first step when it is deemed necessary. In either the same reactor or in a different reactor, at least one vinyl monomer is reacted with the first block and the residual unreacted acrylic monomer to add a second block to the first block to form a block copolymer having at least first and second blocks. The first block typically contains more functional groups from the acrylic monomer than the second block, but the second block has some functional groups because the residual unreacted acrylic monomer from the first step was added into the polymer chain of the second block.

The synthesis of block copolymers by a procedure in which the first block is not purified or has not converted to 100% was addressed in 1994 by Georges et. al. (U.S. Pat. No. 5,401,804). More recently Visger, et. al (U.S. Pat. No. 6,531,547B1) and Po, et. al (WO 2004/005361A1) disclosed the synthesis of block copolymers using a process that comprises polymerizing at least one vinylaromatic monomer until a certain conversion is obtained (5-95 mole % in the case of Visger and 5-99% in the case of Po) and then adding a monomer deriving from methacrylic acid (Po) or an acrylic monomer and optionally additional vinyl aromatic monomers (Visger). Po discusses the advantage of not isolating the first block in terms of eliminating the onerous precipitation and recovery phase of the first polymeric block. International Pub. No. WO 99/47575, which lists Vertommen et al. as inventors (“Vertommen”), is directed to “a process to make low-molecular weight (block) copolymers of one or more vinyl and one or more maleic monomers, by radically polymerizing said monomers in the presence of an Miter.” Vertommen abstract. “The ethylenically unsaturated monomers typically polymerized in the process according to the [Vertommen] invention are styrene and maleic anhydride.” Vertommen, page 7, lines 27-28. Vertommen exemplifies a special case for a reactive block copolymer. Maleic anhydride reacts in an alternating fashion with styrene, and a copolymer block of maleic anhydride and styrene will form with equal molar amounts of each. The reactivity of maleic anhydride with styrene is greater than the reactivity of styrene with styrene, and maleic anhydride does not readily homopolymerize under the conditions of the present invention. See Davies, Dawkins and Hourston, Radical Copolymerization of Maleic Anhydride and Substituted Styrenes by Reversible Addition-Fragmentation Chain Transfer (RAFT) Polymerization, Science Direct, Polymer 46 (2005) 1739-1753. Consequently, Vertommen is believed to describe a process that typically makes a first block of alternating maleic anhydride and styrene and a second block of essentially pure styrene.

The present invention, believed to be in contrast to Vertommen, makes a first block of a random copolymer of acrylic and vinyl monomers, excepting the special case of maleic anhydride and styrene, leaving residual, unreacted acrylic monomer, which is incorporated randomly in the vinyl monomer(s) of the second block. In the present invention, a functional acrylic monomer is polymerized in the first block (in contrast to a vinyl aromatic monomer), in order to incorporate reactive groups (epoxy, acid, anhydride, amine, amide and hydroxyl groups) that are required in different applications described below (for example, reacting with a functional thermoplastic polymer in polymeric blends). In contrast with the prior art, in the present invention, the conversion of monomers in the first block and the amount of initial functional acrylic monomer are calculated in order to assure the presence of residual functional acrylic monomer that will be incorporated in subsequent blocks, and not merely as means of facilitating the next polymerization step, avoiding a purification step. In the present invention, we have unexpectedly found that the presence of reactive groups in the second block is useful for the application of these block copolymers as compatibilizers, chain extenders and surface modifiers for different blends and composites.

The presence of the functional acrylic monomer in subsequent blocks has at least two advantages. One advantage is that the acrylic monomer modifies the polarity of subsequent blocks in order to match the polarity of one of the polymer blend components. The advantage of using functional acrylic monomers is that, in general, they are more polar than monomers such as vinyl aromatic monomers, and the presence of a controlled amount of functional acrylic monomers in the second and/or subsequent blocks can raise the polarity improving their miscibility with different materials such as thermoplastic polymers.

Another advantage is that in the case of applications such as blend compatibilizers, previous investigators had proven the superior performance of pure diblock copolymers over random copolymers. Thus, the need of a purification step for the first block is a requisite to obtain good results (Stott, P., U.S. Pub. No. 2005/004310 A1), unless the monomers used in the synthesis of the first block formed structures such as an alternating block, eliminating the need of a purification step (Saldivar, et. al., U.S. Pub. No. 2004/0077788A1). In contrast, in the present work the present inventors unexpectedly found that diblock copolymers, which were not purified after the first block was synthesized, and which include functional reactive groups in both the first and the second or subsequent blocks, perform well as compatibilizers and as chain extenders. The present inventors believe that one of the possible explanations to this behavior is that the second block (miscible with a non functional thermoplastic polymer), containing reactive functional groups (incorporated from the unreacted monomers of the first step), is able to attach to the reactive thermoplastic polymer at different points, as illustrated in Illustration 1 below, improving the interface contact between a non-reactive and a reactive thermoplastic polymer. (See for example, a comparison between the behavior of a diblock vs. a triblock, and the stable structure formed by a triblock in Chin-An, et. al., Macromolecules, 1997, 30, 549-560.) In the case of random copolymers this advantage is usually not obtained since the functional groups are distributed randomly along the chain, and the number of monomeric units of vinyl monomers miscible with the thermoplastic polymer is probably not large enough to form entanglements with the thermoplastic monomer, and although it is strongly attached to the functional thermoplastic polymer, its interaction with the thermoplastic polymer is not good enough.

Illustration 1 is a schematic representation of the structure of a pure diblock, a pure triblock and a block copolymer containing reactive functional acrylic monomer in both blocks according to the present invention. In the three cases, it is considered that the number of vinyl monomeric units compatible or miscible with the thermoplastic polymer is enough to entangle with the thermoplastic polymer (above the entanglement polymerization index).

One stable free radical for use in the inventive process contains the group .O—N< and is selected from the family of nitroxy radical compounds. Typical examples of nitroxy radical compounds include, but are not limited to,

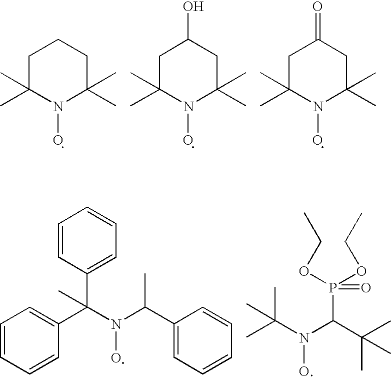

Compounds in the family include those mentioned in parent patent document U.S. Pub. No. 20070049696 and in U.S. Pat. No. 4,521,429, issued to Solomon et al., WO2004014926 (A3), issued to Couturier, Jean Luc, et. al., US2003125489, issued to Nesvadba Peter, et. al., US2001039315, issued to Nesvadba Peter, et. al. In cases where larger amounts of methacrylic monomer are polymerized, nitroxides, such as tert-butyl 1-diethylphosphono-2,2-dimethylpropyl nitroxide, tert-butyl 1-phenyl-2-methylpropyl nitroxide, are preferred.

Free radical initiators for use in the inventive process include peroxide and azo compounds. Typical examples include, but are not limited to, 2,2′-Azobis (2-Methylpropanenitrile), 2,2′-Azobis (2-Methylbutanenitrile), dibenzoyl peroxide (BPO), tert-Amyl peroxy-2-ethylhexanoate, tert-Butyl peroxy-2-ethylhexanoate, 2,5-Bis(2-ethylhexanoylperoxy)-2,5-dimethylhexane and tert-Butyl peroxydiethylacetate.

A nitroxide-mediated radical polymerization method was used to prepare reactive block copolymers of the present invention, but those skilled in the art will recognize that any of the other well-known, so called “living”, “pseudo-living” or “controlled” radical polymerization methods can be used in the present invention. Such stable free radical polymerization methods include the presence of species which reversibly terminate chains by: i) reversible homolytic cleavage of covalent species, ii) reversible formation of persistent hypervalent radicals and iii) degenerative transfer. (Moad, G.; Solomon, D., The Chemistry of Radical Polymerization. 2^{nd} edition. Elsevier, UK, 2006, chapter 9; Controlled Radical Polymerization, Matyjaszewski, K., editor, American Chemical Society, Washington, D.C., 1997, Chapter 1; Sawamoto, et. al., Chem. Rev. 2001, 101, p3691). These methods include, but are not limited to, iniferters, organosulfur iniferters, Reversible Addition-Fragmentation Transfer (RAFT) reactions, sulfur-centered radical-mediated polymerization, Atom Transfer Radical Polymerization (ATRP), reverse atom transfer radical polymerization (reverse-ATRP), metal complex-mediated radical polymerization, oxygen-centered radical-mediated polymerization, nitrogen-centered radical-mediated polymerization, iodine-transfer polymerization, telluride-mediated polymerization, stibine-mediated polymerization. Any one of these methods for providing a stable free radical polymerization can be used according to the present invention.

Iodine was also used as a stable free radical to prepare reactive block copolymers of the present invention, which is a process that is often referred to as degenerative iodine transfer. Solid crystal molecular iodine was substituted for the nitroxy radical compound, and unexpectedly, the iodine was found to work quite well, possibly better than nitroxy radical compounds. The molecular iodine and a free-radical initiator, which was a different free-radical initiator than used with the nitroxy radical compound, were mixed with the monomers in an extruder. The molecular iodine was found to be more reactive than the nitroxy radical compounds, which allowed the extruder to be run at a substantially lower temperature than was used with the nitroxy radical compounds. The extruder was typically operated at about 120° C. for the nitroxy radical compounds, but at about 60° C. for when the molecular iodine was used as the stable free radical. Further polymerization has been observed at lower temperatures, possibly as low as room temperature, after the reactive block copolymer was polymerized in the extruder, and some further experimentation will be required to optimize the polymerization process for making the reactive block copolymers using molecular iodine. An iodine chain transfer agent can be used in addition to, or instead of, molecular iodine

U.S. Pat. No. 7,034,085, issued to Mestach et al. (Mestach) and incorporated by reference, describes a process for making a block copolymer using degenerative iodine transfer. However, the process described in Mestach requires that “iodine atom-containing intermediate polymers [ ] be formed initially (forming the ‘first block’ if a block polymer is to be made)[, which] should predominantly comprise monomers of the methacrylate type, i.e. the polymer comprises at least 50 mole % of methacrylate monomers . . . . [Mestach defines] methacrylate monomers [to] include methacrylic acid or esters, amides or anhydrides thereof, or methacrylonitrile.” Mestach, column 3. line 62, to column 4, line 1. The acrylic monomers of the present invention, which have functional groups, fall within the Mestach definition for methacrylate monomers. The present invention uses less than 50 mole % of methacrylate monomers, as defined by Mestach, preferably substantially less than 50 mole %. Using the Mestach definition, the present invention uses from about 0.10 to about 49 mole % of methacrylate monomers, preferably from about 1.0 to about 30 mole %, more preferably from about 5 to about 20 mole %, and typically less than about 25 mole % of methacrylate monomers. Examples are provided below in which the methacrylate monomer ranged from about 1.5 mole % to about 30.0 mole %, and examples were provided in the parent patent document that ranged from about 2.0 to about 18.1 mole % methacrylate monomer in the first block.

In the present invention one of the monomers is an acrylic monomer having functional groups which is added during the first step. Acrylic monomers contain vinyl groups, that is, two carbon atoms double bonded to each other, directly attached to the carbonyl carbon (C═C—CO—). The functional groups contained in the acrylic monomers include, but are not limited to, epoxy, acid, anhydride, amine, amide and hydroxyl groups. Preferred acrylic monomers that have functional groups include: glycidyl methacrylate, acrylic acid, methacrylic acid, 2-hydroxyethyl methacrylate, maleic anhydride, 2-dimethylaminoethyl methacrylate and 2-diethylaminoethyl methacrylate. Reference to functional groups herein includes, but is not limited to, the following common functional groups: halogen (halo), hydroxyl, carbonyl, aldehyde, carbonate ester, carboxylate, carboxyl, ether, ester, hydroperoxy, peroxy, carboxamide, amine, ammonium, ketimine, aldimine, imide, azide, cyanate, isocyanide, isocyanate, isothiocyanate, nitrate, nitrile, nitrosooxy (nitrite), nitro, nitroso, oxazoline, pyridyl, phosphino, phosphodiester, phosphono, phosphate, sulfonyl, sulfo, sulfinyl, thiol, sulfhydryl, thiocyanate and disulfide groups.

In the present invention one or more vinyl monomers are added in the first step and in the second step of the polymerization process. A vinyl monomer is a compound that has a vinyl group C═C—. Examples of vinyl monomers are styrene, substituted styrenes, ethylene, isoprene, isobutylene, butadiene, acrylates, methacrylates, substituted acrylates, substituted methacrylates, acrylonitrile, N-phenyl maleimide, N-cyclohexyl maleimide, maleic anhydride. Preferred vinyl monomers in the first step include styrene, substituted styrenes, acrylates, methacrylates, substituted acrylates and substituted methacrylates. Preferred vinyl monomers in the second step include styrene, substituted styrenes, acrylonitrile, N-aromatic substituted maleimides, N-alkyl substituted maleimides, maleic anhydride, acrylic acid, methyl methacrylate, alkyl substituted acrylates, aryl substituted acrylates, alkyl substituted methacrylates, aryl substituted methacrylates and 2-hydroxyethyl methacrylate. In some applications, the vinyl monomer used in the first and/or second step can have one or more of the functional groups listed for the functionalized acrylic monomer, including, but not limited to, the following common functional groups: halo, hydroxyl, carbonyl, aldehyde, carbonate ester, carboxylate, carboxyl, ether, ester, hydroperoxy, peroxy, carboxamide, amine, ammonium, ketimine, aldimine, imide, azide, cyanate, isocyanide, isocyanate, isothiocyanate, nitrate, nitrile, nitrosooxy (nitrite), nitro, nitroso, oxazoline, pyridyl, phosphino, phosphodiester, phosphono, phosphate, sulfonyl, sulfo, sulfinyl, thiol, sulfhydryl, thiocyanate and disulfide groups.

In one embodiment, the functional acrylic monomer is selected from the group consisting of glycidyl methacrylate, maleic anhydride, 2-hydroxyethyl methacrylate, acrylic acid and 2-diethylaminoethyl methacrylate and the vinyl monomer used in the first step is styrene. In one embodiment, the vinyl monomers in the second step can be selected from, but not restricted to, the group consisting of styrene, N-phenyl maleimide, methyl methacrylate and butyl methacrylate.

In a preferred embodiment, the functional acrylic monomer is glycidyl methacrylate, and styrene is used as the vinyl monomer in the second step, while optionally, the vinyl monomer in the second step includes N-aromatic substituted maleimides or N-alkyl substituted maleimides.

In a specific embodiment, the vinyl monomer in the second step is selected from the group consisting of styrene, substituted styrenes, acrylonitrile, N-aromatic substituted maleimides, N-alkyl substituted maleimides, maleic anhydride, acrylic acid, methyl methacrylate, alkyl substituted acrylates, aryl substituted acrylates, alkyl substituted methacrylates, aryl substituted methacrylates and 2-hydroxyethyl methacrylate, and the acrylic monomer is selected from the group consisting of glycidyl methacrylate, acrylic acid, methacrylic acid, 2-hydroxyethyl methacrylate, maleic anhydride, 2-dimethylaminoethyl methacrylate and 2-diethylaminoethyl methacrylate.

In specific embodiments, the acrylic monomer is acrylic acid or maleic anhydride, and the vinyl monomer used in the first step is styrene; or the acrylic monomer is 2-hydroxyethyl methacrylate and the vinyl monomer used in the first step is styrene; or the acrylic monomer is 2-diethylaminoethyl methacrylate and the vinyl monomer used in the first step is styrene, or the acrylic monomer is glycidyl methacrylate, the vinyl monomer used in the first step is styrene while the vinyl monomers used in the second step are styrene and N-phenylmaleimide, or the acrylic monomer is glycidyl methacrylate, the vinyl monomer used in the first step is styrene and the vinyl monomers used in the second step are styrene, N-phenylmaleimide and methyl methacrylate, or the acrylic monomer is glycidyl methacrylate, the vinyl monomer used in the first step is styrene and the vinyl monomers used in the second step are styrene, methyl methacrylate and butyl acrylate.

In the present invention the proportion of the functional acrylic monomer in step one is in the range of from about 0.1 to about 98 percent by weight, more preferably in the range of from about 5 to about 95 percent by weight. In some cases, such as when using degenerative iodine transfer, it may be preferable to use less than 50 mole % functional acrylic monomer in the first block, preferably less than 40 mole %, and more preferably less than about 30 mole %. The amount of functional acrylic monomer in the first block is typically between about 15 and about 20 mole %.

In the present invention the reaction product from step 1 contains residual unreacted monomers. The residual monomers from the first block contain at least 1% w/w of the functionalized acrylic monomer, but more preferably contain in the range of 5-95% w/w, and most preferably in the range of 5-85% w/w. The weight or mass percentage of a component is the weight or mass of the component divided by the weight or mass of the mixture that contains the component and is indicated by the notation % w/w or % wt or wt %.

In cases where the monomers do not react with acids, acids can be used as promoters to reduce the reaction time. Promoters include, but are not limited to, strong acids, mineral acids, sulfonic acids, acidic clays, organic sulfonic acids, carboxylic acids, acidic salts of any of these acids and monoester of sulfurous and sulfuric acids.

Process Conditions

The synthesis conditions of the polymerization reaction for obtaining the reactive block copolymers of the present invention are described next. Bulk or solution processes can be employed. For the solution process, any solvent that forms a solution with the initial monomers, initiator and stable free radical or alcoxyamine can be used. In the cases where a solvent is added during the second step, any solvent that forms a solution with the initial block, remaining monomers and additional monomers can be used. Typical solvents include aromatic or substituted aromatic hydrocarbons, as well as aliphatic and substituted aliphatic hydrocarbons. If used, the preferred solvents are substituted aromatics, more preferably toluene, xylene or ethyl benzene or polar solvents like acetone, chloroform, ethyl acetate or water. When used, the solvent is preferably present in amounts of about 5 to about 95% by weight on the basis of the mixture of monomers and solvent.

With a low percentage of solvent, the solvent process is similar to a bulk process, and the solvent is mainly used to control the reaction rate, to better remove the heat of reaction, to lower the viscosity and to allow for larger compositions of monomers that are non miscible in all proportions (for example styrene/maleic anhydride or styrene/N-phenylmaleimide, or styrene/acrylamide) without having phase separation. A low percentage of solvent is preferably 10-30% by weight and more preferably 15-25% by weight with respect to the mixture of monomers and solvent. A solvent percentage of less than about 5% is of practically no use as the advantages of using solvent are not apparent. It may be better to switch to a bulk process rather than use a very low percentage of solvent.

With a high percentage of solvent, the solution process is a typical solution process presenting much lower viscosity, lower rate of reaction, as well as easier temperature control and removal of heat generated by the polymerization reaction. A high solvent percentage preferably ranges between about 60 and about 95 percent by weight, more preferably between about 70 and about 90 weight % and most preferably between about 75 and about 88% by weight with respect to the mixture of monomers and solvent. A solvent percentage larger than about 95% leaves too little polymer to be produced, and the process becomes inefficient. Solvent percentages between about 30 and about 60% can be used, but are not recommended because they are too diluted to present the high productivity advantage of a bulk process and too concentrated to have the benefits given by the low viscosity of a typical solution process.

Preferred process temperatures are in the range of about 70 to about 180° C., but more preferably in the range of about 90 to about 170° C. and most preferably between about 110 and about 130° C. Temperatures lower than about 70° C. do not allow the nitroxide-type radical to act as a live polymer capping-decapping moiety, as is further explained below, because at these temperatures the nitroxide-type radical hinders the living character of the polymerization. Temperatures higher than about 200° C. promote too many side reactions, and the living character of the polymerization is also hindered under these conditions. However, when using degenerative iodine transfer, where molecular iodine or an iodine chain transfer agent is used, the process temperature can be substantially lower than about 120° C., preferably lower than 100° C., and more preferably lower than about 80° C. A typical operating temperature for a reactive extruder, where the stable free radical is provided by iodine, may be about 60° C., which allows production of product without thermal degradation of the reactants or of the product. This is particularly beneficial in the case of temperature-sensitive functional acrylic monomers.

The initiator is typically used in a proportion of about 1 part of initiator to about 50 to about 12,000 parts in moles of monomer, more preferably about 1 mole of initiator to about 100 to about 3,000 moles of monomer and most preferably about 1 mole of initiator to about 100 to about 1,500 moles of monomer. Mole proportions of about 1 part of initiator to less than about 50 parts of monomer yield polymer of very low molecular weight, which are usually not very good for applications involving compatibilization of polymer blends.

The aforementioned initiators have half-life times in the order of a few minutes or less, typically less than 10 min., at the preferred process temperatures. The amount of stable free radical (SFR) with respect to initiator is preferably in the range of about 1 to about 1.9 moles per mole of initiator, more preferably between about 1 and about 1.6 moles per mole of initiator. Ratios of SFR to initiator smaller than about 1 mole of SFR per mole of initiator lead to loss of the living character of the polymerization. However, ratios larger than about 1.9 moles of SFR per mole of initiator can slow down the reaction too much and make the process uneconomical. Additional amounts of initiator can also be added in the second step of the polymerization.

After charging the ingredients, monomers, initiator and stable free radical or an alcoxyamine instead of the initiator and nitroxide, into a reactor and quickly heating to the proper temperature, most of the polymeric chains will start early in the reaction, since the initiator will decompose very fast at the specified temperature. The nearly simultaneous initiation of most of the chains will contribute to narrowing the polydispersity. Also, soon after initiation, and having added only one or to a few monomeric units, each living (growing or active) polymer chain will become dormant (deactivation) after being capped by the stable free radical, which will be present in a slight excess with respect to the number of growing or living chains. The dormant chain will remain in that state for some time until the stable free radical is released again (activation) and the chain becomes active or living again, and capable of adding one or more monomeric units until it becomes again dormant. The cycle of states living-dormant-living-dormant repeats itself a number of times until no more monomer is available for reaction, or the temperature is lowered below the minimum temperature for activation of the stable free radical, which is below around 100° C. for most of the available nitroxy radicals, but lower for iodine.

Irreversible termination reactions, such as those occurring by coupling reactions between two living chains, are hindered due to the lower effective concentration of living polymer. The resulting process is similar to a true living process (for example, anionic polymerization) and it is therefore considered to be quasi-living (also called “controlled”). Since all the chains grow at approximately the same rate and are initiated at about the same time, the molecular weight distribution tends to be narrow, with relatively low polydispersity. It is well known in the art that the degree of livingness of such polymerizations can be measured by the degree of linearity of the polymer number average molecular weight growth with conversion, and by the shifting of curves of the molecular weight distribution toward larger values as the polymerization proceeds.

After heating from 1 to 10 hours, more typically 1-6 hours, a conversion of about 10-95%, more typically around 40-85% is reached. Up to this point, a first block of a pseudo living random copolymer, with or without some degree of alternation, has been formed. At this point, a mixture of one or more vinyl monomers is added. These monomers, together with the remaining monomers from the first step, will constitute a second block. Once the solution is heated again the chains will continue growing, due to the dormant-living repetitive cycles, adding monomer units from the residual (unreacted) monomer from the first step and also from the monomers added in the second step, according to their reactivity, until all the monomer is depleted or the reaction is terminated otherwise.

In the process just described, the temperature can be constant and set at one of the values mentioned in the preferred embodiments of the present invention or can be changed in an increasing fashion, still in the range given in the preferred embodiments of this invention, in order to accelerate the monomer depletion after the initial conversion stages.

Structure of the Reactive Block Copolymers

Block copolymers according to the present invention comprise a first block comprising monomeric units of a functionalized acrylic monomer and monomeric units of a vinyl monomer and a second block comprising monomeric units of one or more vinyl monomers and monomeric units of the functionalized acrylic monomer in the first block.

Given the synthesis procedure described above, and the fact that the reactivity ratios determine the instantaneous composition of the copolymer chains being added to the growing chains, each main block or portion of the copolymer will show some drift in composition, strictly making each one of the main portions a gradient copolymer. In this way, these blocks or portions will have some random character as well as some gradient character. What character dominates each block or portion will depend on how different the reactivity ratios are and the addition sequence of monomers followed during the synthesis. Also, the synthesis procedure will dictate the average composition of each of the main blocks or portions in the final copolymer chain. In the case where the vinyl monomers added in the second step tend to alternate with the remaining monomers from the first step, the polymerization will yield a triblock, since once the monomer that tends to alternate is depleted, the other monomers will continue to homo or copolymerize.

A typical composition of the copolymers obtained is:

R(I)-{(A)ₘ(B)ₙ}-{(A)ₒ(B)ₚ(C)_{q}}_{z}-I(R)

where
R is the residue of a nitroxide used to regulate the polymerization of the compatibilizer;
I is the residue of a radical initiator used to initiate polymerization or the labile alkyl group originally bonded to oxygen of the nitroxide group contained in an alcoxyamine;
A is an acrylic monomer having functional groups,
B and C are vinyl monomers, which are either different or the same;
m is an integer from 5 to 500;
n is an integer from 1 to 400;
o is an integer from 1 to 450; o is smaller than m;
p is an integer from 0 to 350; p is smaller than n; and
q is an integer from 1 to 900.

Considering the composition of these main blocks or portions of the final resulting copolymer formed, one possible architecture will comprise: i) a block of mostly random copolymer A and B (with composition drift), ii) a mostly gradient copolymer portion or block, consisting of a terpolymer A, B and C (possibly only A and C if monomer B was depleted during the first stage), and iii) towards the end of the second portion or block, the chain will consist only of a block of C and possibly A, which can be considered a block on its own. In the case that some monomer B remains after the first stage, the second block or portion will be a gradient copolymer gradually richer in C and less rich in B.

More monomers can be included in the block copolymers. For example, if a fourth monomer D is added during the first block synthesis, the resulting structure will include monomer D in the first and second block, in a concentration that depends on its initial concentration and reactivity. Thus the composition of this diblock could be described as: R(I)-{(A)ₘ(B)ₙ(D)ᵣ}-{(A)ₒ(B)ₚ(D)ₜ(C)_{q}}-I(R) where r is an integer from 1 to 400 and t is an integer, smaller than r. If monomer D is added during the second block synthesis, the resulting structure will include D only in the second block. Thus the composition of this diblock could be described as: R(I)-{(A)ₘ(B)ₙ}-{(A)ₒ(B)ₚ(C)_{q}(D)ₜ}-I(R), where t is an integer from 1 to 400. In case where monomer D tends to alternate with the remaining monomers from the first step, the polymerization will yield a triblock, since once monomer D is depleted, the other monomers will continue to homo or copolymerize.

The functional groups contained in the acrylic monomers can be, but are not limited to, epoxy, acid, anhydride, amine, amide and hydroxyl groups. Preferred acrylic monomers having functional groups include glycidyl methacrylate, acrylic acid, methacrylic acid, 2-hydroxyethyl methacrylate, maleic anhydride, 2-dimethylaminoethyl methacrylate and 2-diethylaminoethyl methacrylate.

Examples of vinyl monomers are styrene, substituted styrenes, ethylene, isoprene, isobutylene, butadiene, acrylates, methacrylates, substituted acrylates, substituted methacrylates, acrylonitrile, N-phenyl maleimide, N-cyclohexyl maleimide, maleic anhydride. Preferred vinyl monomers in the first block are styrene, substituted styrenes, acrylates, methacrylates, substituted acrylates and substituted methacrylates.

Preferred vinyl monomers in the second block are styrene, substituted styrenes, acrylonitrile, N-aromatic substituted maleimides, N-alkyl substituted maleimides, maleic anhydride, acrylic acid, methyl methacrylate, alkyl substituted acrylates, aryl substituted acrylates, alkyl substituted methacrylates, aryl substituted methacrylates and 2-hydroxyethyl methacrylate.

Preferred concentration of the residual functional acrylic monomer in the residual monomers from the first block range about 1-95% w/w, but more preferably in the range of from about 5 to about 85% w/w. Preferred concentration of the functionalized acrylic monomer in the block copolymer ranges between about 0.5 and about 70 weight percent but more preferably in the range of from about 0.5 to about 50% w/w. When using degenerative iodine transfer, it may be preferable to use less than 50 mole % functional acrylic monomer in the first block, preferably less than 40 mole %, and more preferably less than about 30 mole %. The amount of functional acrylic monomer in the first block is typically between about 15 and about 20 mole %.

To form a specific embodiment 1, shown below, in a system of monomers, A is glycidyl methacrylate, B is styrene and C is styrene. Glycidyl methacrylate tends to react in a random fashion with styrene forming a first block consisting of poly(styrene-co-glycidyl methacrylate). In the second step, styrene will be added resulting in a gradient block containing fewer glycidyl methacrylate molecules, since the remaining glycidyl methacrylate from the first block is diluted with more styrene added in the second step, forming embodiment 1. The amount of monomeric units in the first block can be controlled with the first block conversion, and the amount of monomeric units in the second block can be controlled either with the amount of monomer added in the second step or with the final conversion. The composition of each block can be controlled by the mole percent of monomers added during the first and second step.

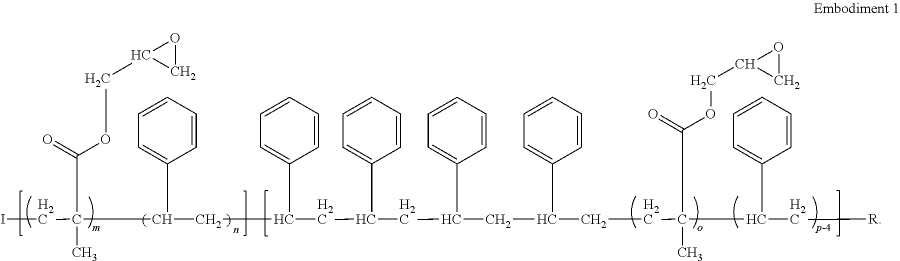

### Where:

I is the residue of a radical initiator used to initiate polymerization or the labile alkyl group originally bonded to oxygen of the nitroxide group contained in an alcoxyamine;
R is the residue of a nitroxide used to regulate the polymerization of the compatibilizer;
m is an integer from 5 to 500;
n is an integer from 1 to 400;
o is an integer from 1 to 450; o is smaller than m; and
p is an integer from 0 to 350.

Considering the composition of these main blocks or portions of the final resulting copolymer formed, one possible architecture will comprise: i) a block of mostly random copolymer A and B (with composition drift), ii) an alternating copolymer consisting of a terpolymer A, B and C or an alternating copolymer of A and C or an alternating copolymer of B and C, depending on the reactivities of each monomer, and iii) once monomer C is depleted, the remaining monomer or monomers will continue to homo or copolymerize forming a third block.

Another typical composition of the copolymers obtained is:

R(I)-{(A)ₘ(B)ₙ}-{(A)ₒ(B)ₚ(C)_{q}}_{z}-{(A)ᵣ(B)ₛ}_{z}-I(R)

where
R is the residue of a nitroxide used to regulate the polymerization of the compatibilizer;
I is the residue of a radical initiator used to initiate polymerization or the labile alkyl group originally bonded to oxygen of the nitroxide group contained in an alcoxyamine;
A is an acrylic monomer having functional groups;
B and C are different vinyl monomers;
m is an integer from 5 to 500;
n is an integer from 1 to 400;
o is an integer from 1 to 450; o is smaller than m;
p is an integer from 0 to 350; p is smaller than n;
q is an integer from 1 to 900;
r is an integer from 0 to 450; r is equal or smaller than o; and
s is an integer from 0 to 350; s is equal or smaller than p.

In a specific embodiment the monomers are: A=glycidyl methacrylate, B=styrene, C=N-phenyl maleimide and D=styrene. Monomers A and B are charged in the first step, producing a random copolymer. After a 66-70% conversion is reached, monomers C and D are added. In this second block, styrene will alternate with N-phenyl maleimide also incorporating the remaining glycidyl methacrylate. Depending on the proportions of monomers A, B, C and D, and the conversion reached in the second block, the second block can be: i) mainly an alternating block, or ii) mainly an alternating block and after monomer C and A are depleted, monomer B/D can continue forming a third block of homopolymer or iii) mainly an alternating block and after monomer C is depleted, monomers B/D and A can continue forming a third copolymer block. The structures obtained in each case (i, ii, and iii) are shown below as Embodiments 2a, 2b and 2c.

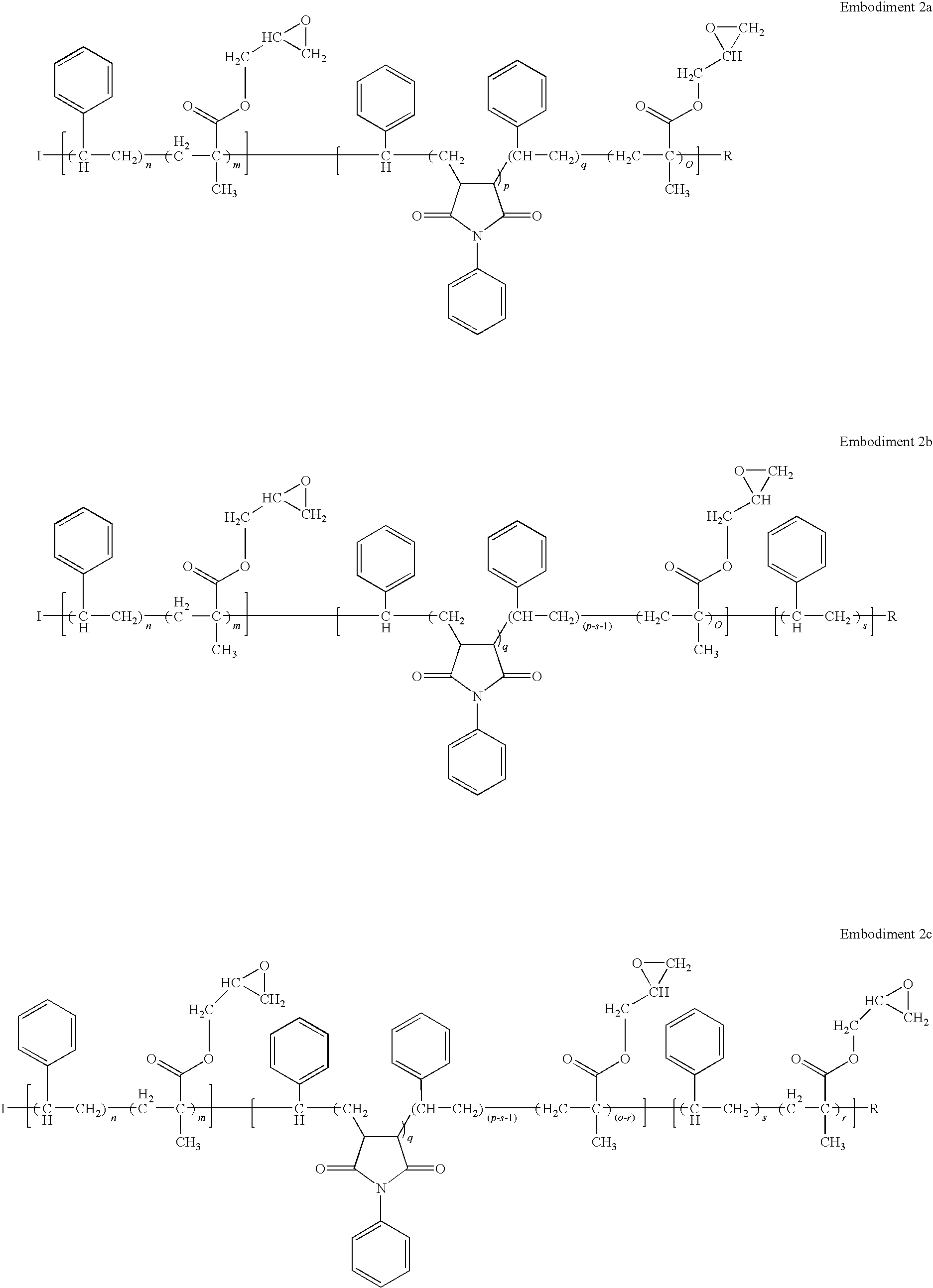

### Where in Embodiments 2a, 2b and 2c:

I is the residue of a radical initiator used to initiate polymerization of the compatibilizer or the labile alkyl group originally bonded to oxygen of the nitroxide group contained in an alcoxyamine;
R is the residue of a nitroxide used to regulate the polymerization of the compatibilizer;
m is an integer from 5 to 500;
n is an integer from 1 to 400;
o is an integer from 1 to 450; o is smaller than m;
P is an integer from 0 to 350; p is smaller than n;
q is an integer from 1 to 900;
r is an integer equal or smaller than o; and
s is an integer smaller than p.

The different structures shown in Embodiments 2a, 2b and 2c can be obtained by modifying the proportions of monomers and the conversions of the first and the second block, which makes this a very versatile procedure for obtaining a variety of structures.

The block copolymers of the present invention use acrylic monomers as “carriers” of functional groups since one can find almost all important functional groups in commercially available and relatively economic acrylic monomers. For example, the epoxy group can be introduced by using glycidyl methacrylate, the acid group by using acrylic acid, the anhydride group by using maleic anhydride, the amine group by using 2-(diethylamino)ethyl methacrylate, the amide group by using acrylamide or maleimide and the hydroxyl group by using 2-hydroxyethyl methacrylate. Another advantage is that the functional acrylic monomer that is incorporated in the second block can raise its polarity making it more miscible with certain thermoplastic polymers (this polarity can be tuned by adjusting the amount of residual functional acrylic monomer and the amount of monomers added in the second step), since acrylic monomers, in general, have higher polarities compared to other monomers, such as vinyl aromatic monomers. The presence of functional acrylic monomers in the first block and in the remaining unreacted monomers of the first step, yields a mixture with a high enough polarity to directly incorporate other highly polar monomers in the second step, such as N-phenyl maleimide and methyl methacrylate, without having to add a solvent. The commercial availability and variety of functional groups found in relatively inexpensive acrylic monomers and the higher polarity of these types of monomers are advantageous over the use of vinyl aromatic monomers with functional groups, such as described in U.S. Pat. No. 6,531,547 B1 and in International Application Publication No. WO 2004 005361 A1.

Depending on the nature of the functional acrylic monomers, the block copolymers can be water soluble, they can carry positive or negative charge or charges in their functional groups or they can be neutral. Also depending on the nature of the functional acrylic monomers and the vinyl monomers, block copolymers can form amphiphilic copolymers. In prior art processes for the production of block copolymers using living polymerizations, a sequence of several chemical steps is necessary: in a first step the monomer forming the first block is homopolymerized until it is consumed, if pure blocks are to be obtained. If the first monomer is not totally consumed, it has to be removed before the second monomer is added. In a further chemical step, a second monomer is added, and it polymerizes, extending the living chains formed during the first step and generating a second block. The need to remove the residual monomer before the charge of a second monomer represents an additional and likely difficult step, which is avoided by the process of the present invention.

Triblock Copolymer

A triblock copolymer can be made according to the present invention using a two-step process comprising: 1) reacting an acrylic monomer having functional groups and one or more vinyl monomers in the presence of a bifunctional controlling agent (see for example U.S. Pat. No. 6,258,911 B1) to form a reaction product, wherein the reaction product includes residual unreacted acrylic monomer, and 2) reacting one or more vinyl monomers with the reaction product from step one, wherein the blocks formed incorporate the residual unreacted acrylic monomer. Solvents can be used optionally in either or both steps. Radical initiators can be used optionally in either or both steps.

One possible structure of triblock copolymers is:

R-{(A)ₒ(B)ₚ(C)_{q}}_{z}-{(A)ₘ(B)ₙ(I-I)}-{(A)ₒ(B)ₚ(C)_{q}}_{z}-R

where
R is the residue of a nitroxide or controlling agent used to regulate the polymerization of the compatibilizer;
I-I is the residue of a molecule used to initiate polymerization or the labile alkyl group originally bonded to oxygen of the nitroxide group contained in an alcoxyamine;
A is an acrylic monomer having functional groups;
B and C are different or equal vinyl monomers;
m is an integer from 5 to 500;
n is an integer from 1 to 400;
o is an integer from 1 to 450; o is smaller than m;
p is an integer from 0 to 350; p is smaller than n; and
q is an integer from 1 to 900.

Depending on the different vinyl monomers added during the first and second step, the amount of controlling agent and initiator and the conversion of each step, a wide variety of structures can be obtained.

A procedure that can be used to obtain triblock copolymers containing functional acrylic monomers in two or three of their blocks consists of continuing the polymerization after a certain conversion of the second block polymerization has been reached. The third block can be optionally synthesized after the diblock is purified, by dissolving it in one or more vinyl monomers. Optionally, more initiator can be added, and optionally, solvent can be used.

Batch Process

The present invention also provides a chemical batch process to perform the polymerization reaction, which is performed in two process stages as follows:
a) A first stage involving adding all the reactants comprising the first block of the block copolymer into a reactor with agitation and heating to reach conversions of about 14 to about 95%, and
b) A second stage involving adding additional monomers to the product of the first reactor and continuing the reaction in a different reactor vessel or vessels without agitation, up to conversions of about 90 to about 100%.

The reactor used in the first step is a well agitated reactor supplied with a helical-type or anchor-type impeller. This reactor must also have some means of exchanging heat with the exterior by a device such as a jacket or a coil for heating and cooling. After reaching conversions in the range of 14-95%, more preferably 50-90%, the viscosity of the reaction mixture will increase and stirring will be difficult, so the reaction product is transferred to a mixing tank where additional monomers are added prior to a final transfer to a reactor where the reaction is completed. This second reactor is preferably a vessel without an agitation device for easier cleaning, such as a slab-shaped or cylinder-shaped reactor or reactors. This second reactor should also be provided with some way of exchanging heat such as an external jacket, immersion in a thermal fluid, or any other similar means. After reaching high conversion, which can be aided by increasing the temperature as the reaction time proceeds, the polymer is removed from the second stage reactor or reactors and ground into smaller pieces in a mechanical mill. Final conversions of less than about 90% are not convenient as much residual monomer would be left, affecting the properties and handling of the final product.

The batch process is described briefly below, and the specification and drawings from the parent U.S. patent application Ser. No. 11/508,407, which was published as U.S. Publication No. 2007/0049696 A1, are incorporated by reference for further description of the invention. In a batch process according to the present invention, a solution of nitroxy radical (or molecular iodine or an iodine chain transfer agent), an initiator, an acrylic monomer having functional groups and one or more vinyl monomers are added to a tank, and the mixture is pumped into a reactor, which may be a continuous stirred tank reactor. After the first block of the block copolymer is formed in reactor, the copolymer and unreacted monomer are pumped to mixing tank. A solution of one or more vinyl monomers is added to the mixing tank. After the additional monomers are thoroughly mixed, the solution is pumped to a reactor that provides a quiescent reaction zone, such as a set of slab molds or a tubular reactor. Conversion in the reactor is typically in the range of from about 14 to about 95%. The quiescent reactor provides a second reactor vessel, which is not agitated or mixed, and heat is removed, such as by a jacketed reactor or by circulation of reactants through a heat exchanger. Solid polymer is recovered from the quiescent reactor and ground up using a granulator, such as a rotary knife granulator or a hammer mill. The ground product is preferably dried in an oven to remove any residual monomer left over from the final polymerization step, after which it is packaged for shipping or shipped in bulk.

The acrylic monomer having functional groups, one or more vinyl monomers, nitroxy radical and initiator can be charged directly to the reactor. By adjusting or manipulating the ratio of initiator to monomer and/or the ratio of the nitroxy radical to initiator, the molecular weight of the copolymer can be controlled. Examples in the parent patent document provide further insight on the impact of these ratios on molecular weight. In this manner, the microstructure of the block copolymer can be controlled and thus made as desired.

Continuous Process

The present invention further provides a bulk or solution continuous process to perform the polymerization reaction, comprising two process steps in series as follows:
a) A first step involving heating the reaction mixture in a continuous stirred tank reactor with exit conversions between 14 and 95% weight, and
b) A second step involving heating in a kneader-mixer reactor in which the exit conversion is between about 60 and about 100%.

The reactor used in the first step is preferably a well agitated reactor supplied with a helical-type or anchor-type impeller and provided with some means of exchanging heat with the exterior. The preferred conversions are between about 10-95%, more preferably 50-90% at the temperatures preferred in this invention. Conversions less than about 10% will make the use of the first reactor inefficient and conversions greater than about 95% will make the process difficult to control due to the high viscosity of the reaction mixture and may broaden too much the molecular weight distribution of the polymer, rendering the material heterogeneous. The second reactor is preferably a kneader-mixer, as shown for example in U.S. Pat. Nos. 4,824,257; 5,121,992; and 7,045,581 and in Publication No. WO2006034875, which provides further conversion without broadening too much the molecular weight distribution and allows for easier polymer transport and heat removal. Kneader-mixers exhibit narrower residence time distributions than their agitated tank counterparts, and it is well known in the art that, for living or quasi-living polymerization reactions, the molecular weight distribution of the polymer is determined by the residence time distribution of the reactor. Also, since the conversion in the second reactor is higher than in the first one, the viscosity will also be very high and in these conditions kneader-mixers provide an ideal way to transport the polymer and remove the heat of reaction, since these reactors generally have a better area-to-volume ratio for heat exchange. Conversions less than about 60% at the exit result in an inefficient use of the second reactor and leave too much unreacted monomer. After the second reactor, the process should provide some means of removing the unreacted monomer, such as devolatilizer equipment or an extruder with venting. Unreacted monomer can be recovered and recycled to the process.

In a continuous process, a solution of nitroxy radical, an acrylic monomer having functional groups and one or more vinyl monomers are added to a tank, and the contents and an initiator are fed to a continuous stirred tank reactor. The first block of the block copolymer is formed in the reactor, and conversion is preferably in the range of from about 14 to about 95%. The copolymer and unreacted monomer from the first step and a solution of one or more vinyl monomers are fed into a tubular-type reactor, which can be a kneader-mixer. A conversion ranging from about 60 to about 100% is achieved in the tubular-type reactor, and the block copolymer and unreacted monomer are fed into a devolatilizer. Un-used monomer and product block copolymer are recovered from the devolatilizer.

Blend Compatibilization

The invention provides many applications in which the inventive block copolymer is used as a compatibilizer, which provides a composition of matter for a compatibilized blend as well as a method of use for the compatibilizer. One embodiment of this invention is the use of the reactive block copolymers as a compatibilizer in compositions, comprising:
(a) 1-98 wt % of a thermoplastic having functional groups selected from the group comprising: amino, amide, imide, carboxyl, carbonyl, carbonate, ester, anhydride, epoxy, sulfo, sulfonyl, sulfinyl, sulfhydryl, cyano and hydroxyl;
(b) 0.01-25 wt % of a block copolymer comprising:
   i) a first block comprising monomeric units of a functionalized acrylic monomer and monomeric units of a vinyl monomer; and
   ii) a second block comprising monomeric units of one or more vinyl monomers and monomeric units of the functionalized acrylic monomer in the first block, where the block copolymer contains functional groups capable of reacting with the chemical moieties of thermoplastics including the thermoplastics having the functional groups in component (a), preferably having Mn of 5,000 to 350,000; and
(c) 1-98 wt % of a thermoplastic polymer miscible or compatible with the second block of the block copolymer described in component (b). The number average molecular weight, Mn, for block copolymers of the present invention (in thousands) ranges from about 5 to about 350, preferably from about 8.5 to about 200, more preferably from about 10 to about 150 and most preferably from about 20 to about 120.

Polymers miscible or compatible with the first block of the aforementioned block copolymer include those which may be described as hydrogenated or partially hydrogenated homopolymers, and random, tapered, or block polymers (copolymers, including terpolymers, tetrapolymers, etc.) of conjugated dienes and/or monovinyl aromatic compounds. The conjugated dienes include isoprene, butadiene, 2,3-dimethylbutadiene and/or mixtures thereof, such as isoprene and butadiene. The monovinyl aromatic compounds include any of the following and mixtures thereof: monovinyl monoaromatic compounds, such as styrene or alkylated styrenes substituted at the alpha-carbon atoms of the styrene, such as alpha-methylstyrene, or at ring carbons, such as o-, m-, p-methylstyrene, ethylstyrene, propylstyrene, isopropylstyrene, butylstyrene, isobutylstyrene, tert-butylstyrene (e.g., p-tertbutylstyrene). Also included are vinylxylenes, methylethyl styrenes, and ethylvinylstyrenes. Specific examples include random polymers of butadiene and/or isoprene and polymers of isoprene and/or butadiene and styrene and also estero-specific polymers such as syndiotactic polystyrene. Typical block copolymers include polystyrene-polyisoprene, polystyrene-polybutadiene, polystyrene-polybutadiene-polystyrene, polystyrene-ethylene butylene-polystyrene, polyvinyl cyclohexane-hydrogenated polyisoprene, and polyvinyl cyclohexane-hydrogenated polybutadiene. Tapered polymers include those of the previous monomers prepared by methods known in the art. Other non-styrenic polymers miscible or compatible with the second block of the copolymer include, but are not limited to, polyphenylene ether (PPE), polyvinyl methyl ether and tetramethyl polycarbonate, methyl methacrylate, alkyl substituted acrylates, alkyl substituted methacrylates and their copolymers with styrene. It also comprises polyolefins, where the term polyolefin is defined as a polymer the majority of whose monomers are olefins and may be polyethylene, polypropylene or co-polymers of ethylene and either propylene or vinyl acetate. It also comprises engineering thermoplastic such as: aliphatic and aromatic polycarbonates (such as bisphenol A polycarbonate), polyesters (such as poly(butylene terephthalate) and poly(ethylene terephthalate)), polyamides, polyacetal, polyphenylene ether or mixtures thereof. All these engineering thermoplastics are prepared according to well known commercial processes. Reference to such processes can be found in technical publications such as Encyclopedia of Polymer Science and Engineering, John Wiley and Sons., 1988, under the respective engineering thermoplastic polymer topic heading.

Thermoplastic Polymers that have Functional Groups

Preferred thermoplastic polymers having functional groups are selected from the group consisting of: aliphatic and aromatic polycarbonates (such as bisphenol A polycarbonate), polyesters (such as poly(butylene terephthalate) and poly(ethylene terephthalate)), polyamides, polyacetal, polyphenylene ether, polyolefins having epoxy, anhydride or acid functionalities, polysulfones, polurethanes and mixtures thereof. All these thermoplastics are prepared according to well-known commercial processes. Reference to such processes can be found in technical publications such as Encyclopedia of Polymer Science and Engineering, John Wiley and Sons., 1988, under the respective thermoplastic polymer topic heading. Specific details on polycondensation engineering thermoplastics follow.

The polyphenylene ethers and polyamides of the present invention are as described in U.S. Pat. No. 5,290,863, which is incorporated herein by reference. The polyphenylene ethers comprise a plurality of structural units having the formula:

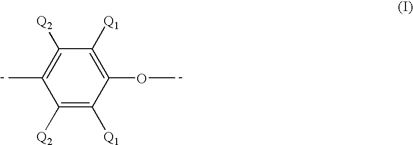

In each of said units, each independent Q1 is independently halogen, primary or secondary lower alkyl (i.e. alkyl containing up to 7 carbon atoms), phenyl, haloalkyl, aminoalkyl, hydrocarbonoxy, or halohydrocarbonoxy wherein at least two carbon atoms separate the halogen and oxygen atoms; and each Q2 is independently hydrogen, halogen, primary or secondary lower alkyl, phenyl, haloalkyl, hydrocarbonoxy or halohydrocarbonoxy as defined for Q1.

Examples of suitable primary or lower alkyl groups are methyl, ethyl, n-propyl, n-butyl, isobutyl, n-amyl, isoamyl, 2-methylbutyl, n-hexyl, 2,3-dimethylbutyl, 2-, 3- or 4-methylpentyl and the corresponding heptyl groups. Examples of secondary lower alkyl are isopropyl and sec-butyl.

Preferably, any alkyl radicals are straight chain rather than branched. Most often, each Q1 is alkyl or phenyl, especially C1-4 alkyl, and each Q2 is hydrogen. Suitable polyphenylene ethers are disclosed in a large number of patents.

The polyphenylene ethers are typically prepared by the oxidative coupling of at least one corresponding monohydroxyaromatic compound. Particularly useful and readily available monohydroxyaromatic compounds are 2,6-xylenol, wherein each Q1 is methyl and each Q2 is hydrogen and wherein the resultant polymer is characterized as a poly(2,6-dimethyl-1,4-phenylene ether), and 2,3,6-trimethylphenol, wherein each Q1 and one Q2 are methyl and the other Q2 is hydrogen.

Both homopolymer and copolymer polyphenylene ethers are included. Suitable homopolymers are those containing, for example, 2,6-dimethyl-1,4-phenylene ether units. Suitable copolymers include random copolymers containing such units in combination with, for example, 2,3,6-trimethyl-1,4-phenylene ether units. Many suitable random copolymers, as well as homopolymers, are disclosed in the patent literature.

Also included are polyphenylene ethers containing moieties which modify properties such as molecular weight, melt viscosity and/or impact strength. Such polymers are described in the patent literature and may be prepared by grafting onto the polyphenylene ether in known manner such vinyl monomers as acrylonitrile and vinyl aromatic compounds (e.g. styrene), or such polymers as polystyrenes or elastomers. The product typically contains both grafted and ungrafted moieties. Other suitable polymers are the coupled polyphenylene ethers in which the coupling agent is reacted in known manner with the hydroxy groups of two polyphenylene ether chains to produce a higher molecular weight polymer containing the reaction product of the hydroxy groups and the coupling agent. Illustrative coupling agents are low molecular weight polycarbonates quinones, heterocycles and formals.

The polyphenylene ether generally has a number average molecular weight within the range of about 3,000-40,000 and a weight average molecular weight within the range of about 20,000-80,000, as determined by gel permeation chromatography. Its intrinsic viscosity is most often in the range of about 0.15-0.6 dl/g, as measured in chloroform at 25° C.

The polyphenylene ethers which may be employed for the purposes of this invention include those which comprise molecules having at least one of the end groups of the formulae

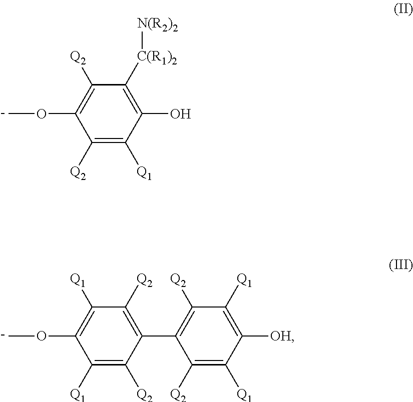

wherein Q₁ and Q₂ are as previously defined; each R₁ is independently hydrogen or alkyl, with the proviso that the total number of carbon atoms in both R₁ radicals is 6 or less; and each R₂ is independently hydrogen or a C₁₋₆ primary alkyl radical. Preferably, each R₁ is hydrogen and each R₂ is alkyl, especially methyl or n-butyl.

Polymers containing the aminoalkyl-substituted end groups of formula (II) may be obtained by incorporating an appropriate primary or secondary monoamine as one of the constituents of the oxidative coupling reaction mixture, especially when a copper- or manganese-containing catalyst is used. Such amines, especially the dialkylamines and preferably di-n-butylamine and dimethylamine, frequently become chemically bound to the polyphenylene ether, most often by replacing one of the α-hydrogen atoms on one or more Q1 radicals. The principal site of reaction is the Q1 radical adjacent to the hydroxy group on the terminal unit of the polymer chain. During further processing and/or blending, the aminoalkyl-substituted end groups may undergo various reactions, probably involving a quinone methide-type intermediate of the formula

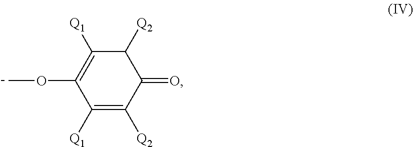

with numerous beneficial effects often including an increase in impact strength and compatibilization with other blend components, as pointed out in references cited in U.S. Pat. No. 5,290,863.

It will be apparent to those skilled in the art from the foregoing that the polyphenylene ethers contemplated for use in the present invention include all those presently known, irrespective of variations in structural units or ancillary chemical features.

Polyamides included in the present invention are those prepared by the polymerization of a monoamino-monocarboxylic acid or a lactam thereof having at least 2 carbon atoms between the amino and carboxylic acid group, of substantially equimolar proportions of a diamine which contains at least 2 carbon atoms between the amino groups and a dicarboxylic acid, or of a monoaminocarboxylic acid or a lactam thereof as defined above together with substantially equimolar proportions of a diamine and a dicarboxylic acid. The term “substantially equimolar” proportions include both strictly equimolar proportions and slight departures there from which are involved in conventional techniques for stabilizing the viscosity of the resultant polyamides. The dicarboxylic acid may be used in the form of a functional derivative thereof, for example, an ester or acid chloride.

Examples of the aforementioned monoamino-monocarboxylic acids or lactams thereof which are useful in preparing the polyamides include those compounds containing from 2 to 16 carbon atoms between the amino and carboxylic acid groups, said carbon atoms forming a ring containing the CO(NH) group in the case of a lactam. As particular examples of aminocarboxylic acids and lactams there may be mentioned—aminocaproic acid, butyrolactam, pivalolactam, -caprolactam, capryllactam, enantholactam, undecanolactam, dodecanolactam and 3- and 4-aminobenzoic acids.

Diamines suitable for use in the preparation of the polyamides include the straight chain and branched chain alkyl, aryl and alkaryl diamines. Illustrative diamines are trimethylenediamine, tetramethylenediamine, pentamethylenediamine, octamethylenediamine, hexamethylenediamine (which is often preferred), trimethylhexamethylenediamine, m-phenylenediamine and m-xylylenediamine.

The dicarboxylic acids may be represented by the formula

HOOC—B—COOH (V)

where B is a divalent aliphatic or aromatic group containing at least 2 carbon atoms. Examples of aliphatic acids are sebacic acid, octadecanedioic acid, suberic acid, glutaric acid, pimelic acid and adipic acid.

Both crystalline and amorphous polyamides may be employed, with the crystalline species often being preferred by reason of their solvent resistance. Typical examples of the polyamides or nylons, as these are often called, include, for example, polyamide-6 (polycaprolactam), 6,6 (polyhexamethylene adipamide), 11, 12, 4, 6, 6, 10 and 6, 12 as well as polyamides from terephthalic acid and/or isophthalic acid and trimethylhexamethylenediamine; from adipic acid and m-xylylenediamines; from adipic acid, azelaic acid and 2,2-bis(p-aminophenyl)propane or 2,2-bis-(p-aminocyclohexyl)propane and from terephthalic acid and 4,4′-diaminodicyclohexylmethane. Mixtures and/or copolymers of two or more of the foregoing polyamides or prepolymers thereof, respectively, are also within the scope of the present invention. Preferred polyamides are polyamide-6, 4,6, 6,6, 6,9, 6,10, 6,12, 11 and 12, most preferably polyamide-6,6. Commercially available thermoplastic polyamides may be advantageously used in the practice of this invention, with linear crystalline polyamides having a melting point between 165 and 230° C. being preferred.

Polyesters which may be employed as a component in compositions of the invention are, in general, relatively high in molecular weight and may be branched or linear polymers. These include polyesters such as polyethylene terephthalate (PET), polybutylene terephthalate (PBT), polycyclohexane-bis-methylene terephthalate (PCT) and thermoplastic elastomeric, or combinations of these thermoplastic elastomeric polyesters with other above polyesters such as PBT. Polyesters suitable for compositions of the present invention include, in general, linear saturated condensation products of diols and dicarboxylic acids, or reactive derivatives thereof. Preferably, they are polymeric glycol esters of terephthalic acid and isophthalic acid. These polymers are available commercially or can be prepared by known techniques, such as by the alcoholysis of esters of the phthalic acid with a glycol and subsequent polymerization, by heating glycols with the free acids or with halide derivatives thereof, and similar processes. Such polymers and methods for their preparation are described further in references cited in U.S. Pat. No. 5,290,863, and elsewhere.

Preferred polyesters are of the family comprising high molecular weight, polymeric glycol terephthalates or isophthalates having repeating units of the formula

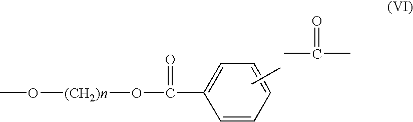

where n is a whole number from two to ten, and more usually from two to four, and mixtures of such esters, including copolyesters of terephthalic and isophthalic acids of up to 30 mol percent isophthalic units.

Especially preferred polyesters are poly(ethylene terephthalate) and poly(1,4-butylene terephthalate).

Especially favored when high melt strength is important are branched high melt viscosity poly(1,4-butylene terephthalate) resins which include small amounts, for example, up to 5 mol percent based on the terephthalate units, of a branching component containing at least three ester forming groups. The branching component can be one which provides branching in the acid unit portion of the polyester, or in the glycol unit portion, or it can be a hybrid. Illustrative of such branching components are tri- or tetracarboxylic acids, such as trimesic acid, pyromellitic acid, and lower alkyl esters thereof, and the like, or preferably, tetrols, such as pentaerythritol, triols, such as trimethylolpropane, or dihydroxy carboxylic acids and hydroxydicarboxylic acids and derivatives, such as dimethyl hydroxyterephthalate, and the like. The addition of a polyepoxide, such as triglycidyl isocyanurate, which is known to increase the viscosity of the polyester phase through branching can aid in improving the physical properties of the present blends.

The branched poly(1,4-butylene terephthalate) resins and their preparation are described in U.S. Pat. No. 3,953,404.

Illustratively, the high molecular weight polyesters useful in the practice of this invention have an intrinsic viscosity of at least about 0.2 deciliters per gram, and more usually from about 0.4 to 1.5 deciliters per gram as measured in solution in ortho-chlorophenol or a 60/40 phenol/tetrachloroethane mixture at 25° to 30° C.

The linear polyesters include thermoplastic poly(alkylene dicarboxylates) and alicyclic analogs thereof. They typically comprise structural units of the formula:

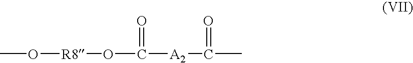

where R8 is a saturated divalent aliphatic or alicyclic hydrocarbon radical containing about 2 to 10 and usually about 2 to 8 carbon atoms and A2 is a divalent aromatic radical containing about 6 to 20 carbon atoms. They are ordinarily prepared by the reaction of at least one diol such as ethylene glycol, 1,4-butanediol or 1,4-cyclohexanedimethanol with at least one aromatic dicarboxylic acid such as isophthalic or terephthalic acid, or lower alkyl ester thereof. The polyalkylene terephthalates, particularly polyethylene and polybutylene terephthalate and especially the latter, are preferred. Such polyesters are known in the art as illustrated by references cited in U.S. Pat. No. 5,290,863.

The linear polyesters generally have number average molecular weights in the range of about 20,000 to 70,000, as determined by intrinsic viscosity at 30° C. in a mixture of 60% (by weight) phenol and 40% 1,1,2,2-tetrachloroethane. When resistance to heat distortion is an important factor, the polyester molecular weight should be relatively high, typically above about 40,000.

The polycarbonates suitable to be used in the present compositions include aliphatic and aromatic polycarbonates. Starting materials for aliphatic polycarbonates are diols and carbonates, eg, diethyl of diphenyl carbonate which are obtained by phosgenation of hydroxy compounds or 1,3-dioxolan-2-ones formed from CO2 and oxiranes. Aliphatic polycarbonates may also be prepared from 1,3-dioxan-2-ones obtained by thermal depolymerization of the corresponding polycarbonates.

Current methods for the preparation of aliphatic polycarbonates include transesterification of diols with lower dialkyl carbonates, dioxolanones or diphenyl carbonate in the presence of catalyst such as alkali metal, tin and titanium compounds. Ring-opening polymerization of six-membered cyclic carbonates (1,3-dioxan-2-ones), in the presence of bicyclic carbonates which act as crosslinking agents, leads to hard, tough thermosets. Crosslinked polycarbonates with outstanding properties are also obtained by free radical polymerization of diethylene glycol bis(allylcarbonate). Based on ethylene glycol carbonate, other phosgene routes have been found, starting with CO2 with urea or a dialkyl carbonate as an intermediate, or from CO. Other routes involves the cationic or free radical, ring-opening polymerization of cyclic ortho esters of carbonic acid. These reactions give polyether polycarbonates.

The molecular weights of linear aliphatic polycarbonates are process-dependent and are between 500 and 5000. Polycarbonates with molecular weights up to about 30,000 are obtained by transesterification, whereas those with a molecular weight greater than 50,000 are prepared by polymerization of carbonates possessing six-membered rings.

Among the preferred polycarbonates are the aromatic polycarbonate homopolymers. The structural units in such homopolymers generally have the formula

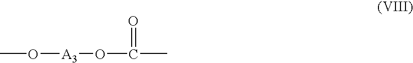

wherein A₃ is an aromatic radical. Suitable A₃ radicals include m-phenylene, p-phenylene, 4,4′-biphenylene, 2,2-bis(4-phenylene)propane, 2,2-bis(3,5-dimethyl-4-phenylene)propane and similar radicals such as those which correspond to the dihydroxyaromatic compounds disclosed by name or formula, generically or specifically, in U.S. Pat. No. 4,217,438. Also included are radicals containing non-hydrocarbon moieties. These may be substituents such as chloro, nitro, alkoxy and the like, and also linking radicals such as thio, sulfoxy, sulfone, ester, amide, ether and carbonyl. Most often, however, all A₃ radicals are hydrocarbon radicals.

The A3 radicals preferably have the formula

-A₄-Y(A5( (IX)

wherein each of A4 and A5 is a single-ring divalent aromatic radical and Y is a bridging radical in which one or two atoms separate A4 from A5. The free valence bonds in formula IX are usually in the meta- or para-positions of A4 and A5 in relation to Y. Such A3 values may be considered as being derived from bisphenols of the formula HO (A4 (Y (A5 (OH. Frequent reference to bisphenols will be made hereinafter, but it should be understood that A3 values derived from suitable compounds other than bisphenols may be employed as appropriate.

In formula IX, the A4 and A5 values may be unsubstituted phenylene or substituted derivatives thereof, illustrative substituents being one or more alkyl, alkenyl (e.g., crosslinkable-graftable moieties such as vinyl and allyl), halo (especially chloro and/or bromo), nitro, alkoxy and the like. Unsubstituted phenylene radicals are preferred. Both A4 and A5 are preferably p-phenylene, although both may be o- or m-phenylene, or one may be o-phenylene or m-phenylene and the other p-phenylene.

The bridging radical, Y, is one in which one or two atoms, preferably one, separate A4 from A5. It is most often a hydrocarbon radical, and particularly a saturated radical such as methylene, cyclohexylmethylene, 2-[2,2,1]-bicycloheptylmethylene, ethylene, 2,2-propylene, 1,1-(2,2-dimethylpropylene), 1,1-cyclohexylene, 1,1-cyclopentadecylene, 1,1-cyclododecylene or 2,2-adamantylene, especially a gemalkylene radical. Also included, however, are unsaturated radicals and radicals which are entirely or partially composed of atoms other than carbon and hydrogen. Examples of such radicals are 2,2-dichloroethylidene, carbonyl, thio, oxy, and sulfone. For reasons of availability and particular suitability for the purposes of this invention, the preferred radical of formula IX is the 2,2-bis(4-phenylene)propane radical, which is derived from bisphenol-A and in which Y is isopropylidene and A4 and A5 are each p-phenylene.

Various methods of preparing polycarbonate homopolymers are known. They include interfacial and other methods in which phosgene is reacted with bisphenols, transesterification methods in which bisphenols are reacted with diaryl carbonates, and methods involving conversion of cyclic polycarbonate oligomers to linear polycarbonates. The latter method is disclosed in U.S. Pat. Nos. 4,605,731 and 4,644,053.

A preferred polyhydric phenol is a dihydric phenol such as bisphenol A. Suitable polycarbonate resins for the practice of the present invention may be any commercial polycarbonate resin. The weight average molecular weight of suitable polycarbonate resins (as determined by gel permeation chromatography relative to polystyrene) may range from about 20,000 to about 500,000, preferably from about 40,000 to about 400,000. However, compositions in which polycarbonates have a molecular weight in the range of about 80,000-200,000 often have favorable properties.

It is also possible in the polymer mixture according to the invention to use a mixture of different polycarbonates as mentioned hereinbefore as an aromatic polycarbonate.

Use of Reactive Block Copolymers as a Compatibilizer

Generally a minimum of about 0.5 wt % of reactive block copolymer of the invention and preferably a range of from about 1 to about 7 will be sufficient to observe compatibilization effects on the engineering thermoplastic blend compositions, such as improvements in mechanical properties. The block copolymer can also be used in amounts higher than the minimum but limited to a range so that it will positively affect the blend characteristics without substantially degrading other sought characteristics. Thus, typical blends will comprise the following: (a) thermoplastic having functional groups, 98-1 wt % (b) thermoplastic polymer miscible or compatible with the second block of the block copolymer, 1-98 wt %; and (c) reactive block copolymer, 1-20 wt %. Preferred blends of this invention comprise from about 40 to about 90 wt % thermoplastic having functional groups, 10-60 wt % thermoplastic miscible or compatible with the second block of the block copolymer and about 2 to about 5 wt % of the reactive block copolymer. This range of compositions will usually yield materials with improved impact properties and mechanical strength.

Generally, the blend compositions of the invention can be prepared by mixing the thermoplastic having functional groups, the thermoplastic miscible/compatible with one of the blocks of the copolymer and the reactive block copolymer of the invention, in any order and subjecting the mixture to temperatures sufficient to melt the mixture, for example, 180° C. and up. Such mixing and heating can be accomplished using conventional polymer processing equipment known in the art, such as batch mixers, single or multiple screw extruders, continuous kneaders, etc. Furthermore, the compatibilized compositions of the present invention may contain various additives, for example, stabilizers, flame retardants, anti-oxidants, fillers, processing aids and pigments in normal and conventional amounts, dependent upon the desired end-use. As examples of the fillers, there may be mentioned, e.g., metal oxides such as iron and nickel oxide, nonmetals such as carbon fiber, silicates (e.g. mica, aluminum silicate (clay)), titanium dioxide, glass flakes, glass beads, glass fibers, polymer fibers, etc. If used, the conventional additives and fillers are mechanically blended and the compositions of the invention are then molded in known methods.

Use of Reactive Block Copolymers as Chain Extenders

Using the block copolymers of the present invention as a chain extender is similar to using the block copolymers as a polymeric compatibilizer, except polymeric compatibilization concerns bonding polymeric chains of two different materials to a reactive block copolymer molecule, while chain extension concerns bonding at least two polymeric chains of the same or similar materials to a reactive block copolymer molecule. It is believed that a block copolymer of the present invention serves as a backbone to which a reactive functional group in a polymer chain bonds. Since the inventive block copolymer may have more than one reaction site, more than one polymer chain having a functional group may bond to the inventive block copolymer backbone. Chain extension is thus believed to be provided because relatively small polymer chain fragments, which have at least one reactive functional group, may be joined through the inventive block copolymer backbone to a relatively large polymer chain that has at least one reactive functional group or to another relatively small polymer chain fragment, which in any case provides a longer polymer chain, albeit with at least one inventive block copolymer backbone bound within the longer polymer chain.

Chain extension is particularly useful in recycling polymeric materials because the recycling process itself tends to break long polymer chains into shorter polymer chain fragments. The shorter polymer chain fragments hurt the performance characteristics of a polymeric material that contains the shorter polymer chain fragments. The recycling process for virgin polymeric materials tends to reduce the molecular weight of the recycled polymeric material, probably due to thermal and physical breakage of polymer chains. Consequently, recycled polymeric material has historically been considered a lower-quality material compared to its virgin, un-used counterpart with respect to rheological, mechanical and thermal properties. The present invention provides a process for repairing the damage to polymer chains caused by recycling. Under the process of the present invention, relatively small polymer chain fragments in recycled polymeric material can be joined together and/or can be joined to relatively large polymer chain fragments and/or can be joined to undamaged polymer chains through the block copolymer of the present invention, which in each case leads to a recycled polymeric material having improved rheological, mechanical and thermal properties compared to a counterpart recycled material that was not processed according to the present invention.

While chain extension is particularly useful in recycling polymeric materials, the present invention is not limited to recycling. The present invention provides a block copolymer composition and a method for using the block copolymer to effectively increase the average molecular weight of a batch or stream of polymeric material, which improves the rheological, mechanical and thermal properties of the polymeric material. The present invention can be used to improve the properties of virgin material, in addition to its use in improving the properties of recycled materials. For example, if there is a virgin polymeric material, which has reactive functional groups, that is considered relatively low quality for an application due to low average molecular weight, the average molecular weight can be increased by reacting the block copolymer of the present invention with the low-quality material, thereby improving the rheological, mechanical and thermal properties of the virgin polymeric material.

The parent patent document, which was published as U.S. Publication No. 2007/0049696 A1 and which is incorporated by reference, emphasized blend compatibilization as an important use for the block copolymers of the present invention. The composition of a compatibilized blend may comprise:
(a) 1-98 wt % of a thermoplastic having functional groups selected from the group comprising: amino, amide, imide, carboxyl, carbonyl, carbonate, ester, anhydride, epoxy, sulfo, sulfonyl, sulfinyl, sulfhydryl, cyano and hydroxyl;
(b) 0.01-25 wt % of a block copolymer comprising:
   i) a first block comprising monomeric units of a functionalized acrylic monomer and monomeric units of a vinyl monomer; and
   ii) a second block comprising monomeric units of one or more vinyl monomers and monomeric units of the functionalized acrylic monomer in the first block, where the block copolymer contains functional groups capable of reacting with the chemical moieties of thermoplastics including the thermoplastics having the functional groups in component (a), preferably having Mn of 5,000 to 350,000; and
(c) 1-98 wt % of a thermoplastic polymer miscible or compatible with the second block of the block copolymer described in component (b).

The inventors discovered that components (a) and (c) can be the same or similar thermoplastic polymers, which is referred to as chain extension rather than compatibilization. In compatibilization, thermoplastic polymer (a) was stated to have functional groups, while the first block of the copolymer was stated to comprise monomeric units of a functionalized acrylic monomer and monomeric units of a vinyl monomer, and thermoplastic polymer (c) was stated to be miscible or compatible with the second block of the block copolymer, where the second block comprises monomeric units of one or more vinyl monomers and monomeric units of the functionalized acrylic monomer in the first block.

For chain extension, the present invention provides a process for modifying polymers using a reactive block copolymer as a chain extender, comprising the steps of:

reacting a first polymer with the chain extender;
wherein the chain extender is made by a process comprising:
a) reacting an acrylic monomer having functional groups and one or more vinyl monomers in the presence of a free radical initiator and a stable free radical in a first step to form a reaction product, wherein the reaction product includes residual unreacted acrylic monomer; and
b) reacting in a second step one or more vinyl monomers with the reaction product from the first step to form a second block, wherein the second block incorporates the residual unreacted acrylic monomer; and

reacting a second polymer with the chain extender, wherein the first and second polymers may be the same polymers, similar and/or different polymers, and wherein the first and second polymers each have at least one functional group selected from the group consisting of amino, amide, imide, carboxyl, carbonyl, carbonate, ester, anhydride, epoxy, sulfo, sulfonyl, sulfinyl, sulfhydryl, cyano and hydroxyl.

The functional group on the first and second polymers may be the same or different, and/or the first and second polymers may each have more than one functional group, in which case the functional groups may be entirely the same, entirely different or a combination where there is both sameness and difference among functional groups. The first and second polymers can be any of the polymers mentioned herein with respect to blend compatibilization, but are preferably selected from the group comprising polyesters, polycarbonates, polyurethanes, polylactic acids, lactide polymers, polyhydroxyalkanoate (PHA) polymers, polysulfones, polyacetals, polyamides, polyimides, polyether imides, polyether sulfones, polyphenylene ethers, polyether ketones, polyether-ether ketones, polyarylether ketones, polyarylates, polyphenylene sulfides and polyalkyls. Thus, this is a list of polymers for which it is expected that the reactive block copolymer of the present invention may be used for chain extension. Many embodiments of the reactive block copolymer, also referred to as the chain extender, have been described herein. If the reactive block copolymer is used to aggregate two or more polymers that are the same, or different, through a reaction with the functional groups of the two or more polymers, then such process shall be generally referred to herein as chain extension, but if the reactive block copolymer is used to aggregate two or more polymers that are different and neither miscible nor compatible, then such process shall be generally referred to herein as compatibilization.

The more typical application for chain extension is expected to be an application in which a single polymeric material has relatively long polymeric chains and relatively short polymeric chains, and the reactive block copolymer of the present invention is used to effectively connect the relatively short polymeric chains to the relatively long polymeric chains, thereby increasing the average molecular weight and thereby improving the rheological, mechanical and thermal properties of the polymeric material. A typical application for chain extension is in recycling a polymeric material, where the recycling process tends to break and cleave polymer chains, leaving a distribution of polymer chain lengths that ranges from relatively short to relatively long. Typical polymeric materials, which are recycled and which have functional groups for reacting with and bonding to the reactive block copolymer, include polyesters, polycarbonates, polylactic acid, lactide polymers, and polyhydroxyalkanoate (PHA) polymers. In particular, a great deal of polyethylene terephalate or PET is used and recycled, and the process of the present invention can be used to improve, particularly, recycled PET, although the process is also useful for improving the quality of virgin, never-used PET.

An example of a typical application for the chain extenders of the present invention in recycling PET is described in U.S. Patent Application Pub. No. 20080093777 A1, which lists Sequeira and Farha as inventors and which is incorporated by reference. Paragraph 39 of the '777 application states “[v]arious compounds are useful as chain extenders or crosslinkers. The degree of chain extension or crosslinking achieved depends on the structure and functionalities of the compounds used. For example, compounds containing di- or multi-functional epoxy (e.g. glycidyl) or anhydride functional groups can be used. These functional groups can react with the hydroxyl or carboxyl groups in PET to extend chain length and/or create branching or cross-linking in the resin. Examples of useful compounds include trimellitic anhydride, pyromellitic dianhydride (PMDA), trimellitic acid and their haloformyl derivatives. Chain branching agents like pentaerythritol or trimethylolpropane may also be used (see U.S. Pat. No. 4,219,527). Commercial chain extenders such as CESA-Extend from Clariant, may also be used.” It is believed that the chain extenders of the present invention will be preferred for recycling PET over the prior art chain extenders based on the properties of the recycled PET, the ease of use of the present chain extenders, and/or the cost of the present chain extenders.

The present invention is also useful in recycling polycarbonate materials, for which a typical use is in making compact discs for storage of electronic information in the form of data, music and movies. U.S. Pat. No. 7,105,632, issued to Ikeda et al. and incorporated by reference, describes a method for recycling polycarbonate resin waste, where a polycarbonate oligomer and a polycarbonate waste component are combined, the polycarbonate waste component is subjected to a transesterification reaction and/or to a polycondensation reaction, and OH group concentration of the polycarbonate waste component is changed to suppress the formation of a branched compound. The polycarbonate recycling method described in the '632 patent appears to be relatively complex, while in the present invention a simple reactive co-extrusion of original, but used, polycarbonate material with less than 10 weight percent of the reactive block copolymer of the present invention will maintain the properties of the original polycarbonate material in a recycled product, as indicated by torque as an indicator of intrinsic viscosity. An example is provided below.

The present invention provides a method for recycling plastics, which includes a step in which an amount, typically less than about 25 weight percent, preferably less than about 20 wt %, more preferably less than about 15 wt % and most preferably less than about 10 wt %, of the reactive block copolymer of the present invention is reacted with the plastic that is to be recycled, where the plastic has a functional group that will react with the reactive block copolymer. The reactive block copolymer is made or selected for functionality for a particular application, meaning the reactive groups on the reactive block copolymer are selected while bearing in mind the functional groups on the plastic to be recycled. Epoxy functional groups on the reactive block copolymer are particularly useful in practicing the present invention, but other functional groups described above for the various reactive block copolymers are also useful.

U.S. Pat. No. 6,436,322, issued to Fredl and incorporated by reference, describes a method for recycling PET flakes, which are made from recycled PET bottles. In the '322 patent, reclaimed PET bottles are received loose or packed in bales. The bottles are washed, separated according to color, and ground into flake. The flake is fed to an extruder described in the '322 patent as having three gas-venting sections, which are believed to be for cleaning the recycled flake prior to using the recycled material to make beverage bottles via blow molding. The '322 patent describes extruding the PET flakes in a two-screw extruder running at about 1350 to 1450 rpm, where the screws have a diameter of about 200 mm. The recycled flake is melted as it passes through the extruder, which may be operated at about 280° C. An extrudate is cooled and stripped to increase viscosity, as blow molding of bottles is successful within only a narrow range of viscosity, producing a granulate. The granulate is blended and dried in a tumble drier for about 10 to about 12 hours. The drum for the tumble drier has a large capacity, such as about 44 cubic meters, which allows blending of recycled flake to achieve a desired viscosity prior to blow molding.

With the present invention, a desired amount of reactive block copolymer is fed to an extruder, such as described in the '322 patent, to produce a granulate of recycled PET having a viscosity suitable for blow molding beverage bottles. A recycler can also make a pelletized product of recycled plastic using an extruder in a similar manner. The pelletized product recycled plastic can be used for a variety of products made using various molding techniques, and if the recycled plastic is not used in a food-grade application, then some of the cleaning steps described in the '322 patent, such as the gas-venting sections in the extruder, may not be necessary. A suitable reactive block copolymer can be made as described herein, such as by using styrene and glycidyl methacrylate, which provides epoxy functional groups in the reactive block copolymer. The amount of reactive block copolymer fed to the extruder depends on the intrinsic viscosity of the extrudate prior to addition of the reactive block copolymer and the desired intrinsic viscosity, but is generally less than about 25 weight percent, preferably less than about 20 wt %, more preferably less than about 15 wt % and most preferably less than about 10 wt % of the extruded recycled material combined with the reactive block copolymer of the present invention. Positive results are shown in the examples below for concentrations of reactive block copolymer that are substantially less than 10 wt %, particularly in the range of from about 4 to about 8 wt % of the reactive block copolymer.

U.S. Patent Application Publication No. 2004/0155374, listing Hutchinson and Royall as inventors and incorporated by reference, describes another method for recycling PET. The '374 application concerns itself with blending recycled PET with virgin, un-used PET, particularly for achieving a desired color for the blend prior to making a bottle preform, but also for achieving acceptable values for intrinsic viscosity, melting point and crystallinity. The '374 application describes using a single-screw Sterling extruder, which is vented, with a die-face cut pelletizer made by Gala followed by a cyclone dryer or a twin-screw, ring extruder with co-rotation and contra-rotation. The reactive block copolymer of the present invention can be incorporated into the process described in the '374 patent application, in which case, the reactive block copolymer can be fed to the extruder along with recycled PET to achieve acceptable properties in the recycled material, and if necessary or desired, virgin, un-used PET can also be fed to the extruder. By adding the reactive block copolymer of the present invention to the process described in the '374 application, it is possible to reduce the amount of virgin, un-used PET that is required for a desired set of properties, and it may be possible to eliminate the virgin PET completely.

U.S. Pat. No. 5,951,940, issued to Nosker et al. and incorporated by reference, describes a method for recycling a mix of post-consumer plastics waste that includes polyolefins, such as low density and high density polyethylene and polypropylene, and non-polyolefin components, such as PET and polycarbonates. The '940 patent describes concentrating the polyolefin waste through a sorting process, but contemplates products containing some non-olefin material due to imperfect separation. In the '940 patent, compatibilizers are described as being a part of the post-consumer recycle mix, such as container-label adhesives that contain ethylene vinyl acetate (EVA) and tie layers from laminates, which may contain ethylene vinyl alcohol (EVOH). The '940 patent notes that such intrinsic compatibilizers, as well as added or extrinsic compatibilizers, can improve the quality of products made from mixed post-consumer plastics waste. The non-polyolefin material is referred to as a minor phase that is micro-dispersed in the polyolefin phase, such as by melt-compounding the mixed waste plastics in a multi-screw extruder, which is preferably a non-intermeshing, counter-rotating multi-screw extruder.

The present invention provides reactive block copolymers that are both a chain extender and a compatibilizer. Thus, the reactive block copolymer of the present invention can be tailored for use in recycling mixed plastics waste that contains polymeric material, as well as some non-polymeric material in the waste such as wood, paper and/or metal, where the polymeric material includes polymer chains with reactive functional groups, such as polyesters, polycarbonates and polylactic acid, and some polymer chains without reactive functional groups, such as polyethylene, polypropylene and polystyrene. The reactive block copolymer of the present invention can compatibilize the polymeric material that does not have reactive functional groups, along with any non-polymeric material, with the polymeric material that contains reactive functional groups, and the same reactive block copolymer can serve as a chain extender, where the reactive functional groups react with, and thereby bond to, the reactive block copolymer for effectively extending the length of polymer chains in the polymeric material that contains reactive functional groups. By adding an appropriate reactive block copolymer of the present invention to the melt compounder or extruder described in the '940 patent, the properties of the extrudate in the '940 patent can be improved due to both compatibilization and chain extension.

Thus, the present invention provides a method for compatibilization and/or for chain extension of a heterogeneous or homogeneous polymeric material, comprising reacting and/or mixing the polymeric material with a reactive block copolymer, wherein the reactive block copolymer is made by a process comprising the steps of:

(a) reacting an acrylic monomer having functional groups and one or more vinyl monomers in the presence of a free radical initiator and a stable free radical in a first step to form a reaction product, wherein the reaction product includes residual unreacted acrylic monomer; and

(b) reacting in a second step one or more vinyl monomers with the reaction product from the first step to form a second block, wherein the second block incorporates the residual unreacted acrylic monomer.

The acrylic monomer is preferably selected from the group consisting of glycidyl methacrylate, acrylic acid, methacrylic acid, 2-hydroxyethyl methacrylate, maleic anhydride, 2-dimethylaminoethyl methacrylate and 2-diethylaminoethyl methacrylate. The vinyl monomer in the first step is preferably styrene, and the vinyl monomer(s) in the second step is preferably selected from the group consisting of styrene, N-phenylmaleimide, methyl methacrylate and butyl acrylate. The reaction product preferably includes at least 0.03 mole percent unreacted residual acrylic monomer; the stable free radical is preferably a nitroxyl or iodine free radical; and the stable free radical is preferably formed from an alkoxyamine or molecular iodine, respectively. The stable free radical is preferably selected from the group consisting of 2,2,6,6-tetramethyl-1-piperidinyloxy, 4-hydroxyl-2,2,6,6-tetramethyl-1-piperidinyloxy, 4-oxo-2,2,6,6-tetramethyl-1-piperidinyloxy, tert-butyl 1-diethylphosphono-2,2-dimethylpropyl ntroxide, tert-butyl 1-phenyl-2-methylpropyl nitroxide, and derivatives thereof. The free radical initiator is preferably selected from the group consisting of: 2,2′-azobis (2-methylpropanenitrile), 2,2′-azobis (2-methylbutanenitrile), dibenzoyl peroxide (BPO), tert-amyl peroxy-2-ethylhexanoate, tert-butyl peroxy-2-ethylhexanoate, 2,5-bis(2-ethylhexanoylperoxy)-2,5-dimethylhexane, tert-butyl peroxydiethylacetate, molecular iodine and an iodine chain transfer agent.

For chain extension, the polymeric material is primarily homogeneous, preferably contains reactive functional groups, and is typically one or more of the following: polyesters, polycarbonates, polyurethanes, polylactic acids, lactide polymers, polyhydroxyalkanoate (PHA) polymers, polysulfones, polyacetals, polyamides, polyimides, polyether imides, polyether sulfones, polyphenylene ethers, polyether ketones, polyether-ether ketones, polyarylether ketones, polyarylates, polyphenylene sulfides and polyalkyls. In chain extension, typically one, but possibly more than one, of the following thermoplastic polymers is reacted with the reactive block copolymer of the present invention: aliphatic or aromatic polycarbonates, polyesters, polyamides, polyphenylene ether, polyolefins having epoxy, anhydride or acid functionalities, polysulfones, polyurethanes and mixtures thereof. For compatibilization, the polymeric material is primarily heterogeneous and contains typically one or more of the materials listed above that contain reactive functional groups and one or more of the following thermoplastic polymers: polystyrene, poly substituted styrenes, styrenic random copolymers, styrenic block copolymers, high impact polystyrene, hydrogenated block copolymer of styrene and a diene monomer, polyphenylene ether, polyacrylates, polymethacrylates, acrylate random copolymers, acrylate block copolymers, methacrylate random copolymers, methacryalte block copolymers, polyolefins, polyurethanes, polyvinyl chloride, polyvinylidiene chloride, polyvinyl fluoride, polyvinylidiene fluoride styrene acrylic copolymers, copolymers containing units of styrene and acrylonitrile, copolymers containing units of styrene acrylonitrile and butadiene, copolymers containing units of styrene acrylonitrile and n-butyl acrylate, copolymers containing units of styrene acrylonitrile, butadiene and n-butyl acrylate, and mixtures thereof. The present invention can be used to improve the properties of homogeneous and/or heterogeneous mixtures of these various thermoplastic polymers, which may be used, reclaimed and recycled or virgin and un-used, as well as mixtures of used and un-used thermoplastics.

The reactive block copolymer is preferably mixed with and/or reacted with the polymeric material in an extruder under reactive conditions, particularly with respect to temperature and mixing conditions, which may be referred to as reactive extrusion. Other equipment and vessels may also be used to react the reactive block copolymer with the polymeric material, including a dry, heated tumbler, a melt blender, a solution blender, a Banbury mixer, a roll mill, a continuous mixer such as by Farrell, and a Buss co-kneader. A reactive extruder is expected to be the reaction vessel most commonly used, and it may have a single screw, twin screws or multiple screws of various lengths and designs operating at a suitable speed or revolutions per minute (RPM) in order to achieve an adequate residence time, which typically ranges from about 0.5 to about 15 minutes and is preferably more than about 2.0 minutes and more preferably more than about 4.0 minutes, at a sufficiently high temperature, which depends on the polymeric material, but which is preferably above the glass transition temperature of the reactive block copolymer and of the polymeric material and possibly above the melting point of each. When using a nitroxyl free radical, the temperature of the reaction mixture is typically above 100° C., preferably above 150° C., more preferably above about 200° C., and most preferably above 250° C. Some of the examples were carried out at 270° C. However, it was discovered, unexpectedly, that when using iodine as the stable free radical, the operating temperature can be substantially lower, typically below 150° C., often below 110° C., preferably below 100° C. and more preferably below 75° C. Examples are provided below, where iodine was used as a stable free radical to make a reactive block copolymer at reaction temperatures of 60° C. and 65° C.

The polymer product, which is typically pelletized, resulting from the reaction and/or mixing between the reactive block copolymer and the heterogeneous or homogeneous polymeric material can be formed into useful products using standard processing equipment including blow molding, injection molding, and film and fiber formation. However, the polymer product may be formed directly in end-product processing equipment, without first making and recovering the polymer product, in which case ingredients such as fillers, stabilizers, pigments and antioxidants, as well as other desired additives, may be added into the end-product processing equipment.

The present invention also provides a method for increasing the intrinsic viscosity of a polymeric material, comprising (a) mixing the polymeric material with a chain extender in a reactor, wherein the polymeric material has an intrinsic viscosity, and wherein the chain extender comprises a first block comprising monomeric units of a functionalized acrylic monomer and monomeric units of a vinyl monomer and a second block comprising monomeric units of one or more vinyl monomers and monomeric units of the functionalized acrylic monomer in the first block; and (b) forming a product material having an intrinsic viscosity, wherein the intrinsic viscosity of the product material is greater than the intrinsic viscosity of the polymeric material.

In another aspect, the present invention provides a composition for a recycled plastic, comprising: 80-99 weight percent of reclaimed polymer, wherein the reclaimed polymer is a polymeric material formed by polymerization and molded into one or more articles, wherein the reclaimed polymer is derived from the articles, and wherein the reclaimed polymer has reactive functional groups and an average molecular weight; and 1-20 weight percent of a chain extender comprising a block copolymer comprising first and second blocks, wherein the first block comprises monomeric units of a functionalized acrylic monomer and monomeric units of a vinyl monomer, and wherein the second block comprises monomeric units of one or more vinyl monomers and monomeric units of the functionalized acrylic monomer in the first block, wherein the reclaimed polymer and the chain extender are bound together to form the recycled plastic, and wherein the recycled plastic has an average molecular weight that is greater than the average molecular weight of the reclaimed polymer. The reclaimed polymer preferably comprises a polyester. The polyester is preferably selected from the group consisting of polyethylene terephthalate (PET), polybutylene terephthalate (PBT), polyethylene naphthalate (PEN), polycyclohexane-bis-methylene terephthalate (PCT), copolymers of PET, copolymers of PBT, copolymers of PEN and copolymers of PCT. The chain extender can be made from one of the processes described herein for making reactive block copolymers, and preferably, the acrylic monomer is glycidyl methacrylate, and preferably, the vinyl monomer in the first and second steps for making the chain extender is styrene. In the process for making the chain extender, the functionalized acrylic monomer preferably comprises from about 5 to about 15 weight percent of the chain extender; the reaction product from the first step preferably includes at least 0.03 mole percent unreacted residual acrylic monomer; and/or the stable free radical is preferably a nitroxyl or iodine free radical.

### EXAMPLES

The following examples illustrate a number of aspects of the present invention with respect to chain extension. Examples in parent U.S. patent application Ser. No. 11/508,407 filed Aug. 23, 2006, which was published as U.S. Publication No. 2007/0049696 A1, pertain to compatibilization applications for the present invention and are incorporated by reference. A wide variety of properties can be obtained in different blends by merely changing the molecular weight of the reactive block copolymer (which is referred to as the chain extender or the compatibilizer), the amount of reactive monomers and the conversion of the first block. The following examples illustrate the invention in more detail, but they should not to be construed as limiting the present invention to the particular examples provided. The scope of the invention is properly determined by the claims that are ultimately under consideration.

A. Preparation of Reactive Block Copolymer Chain Extenders

Reagents: Styrene (St) was acquired from Quimir; glycidyl methacrylate (GMA) was acquired from Dow Quimica Mexicana S.A. de C.V.; benzoyl peroxide (BPO) was acquired from Akzo Nobel; 4-hydroxy tempo was acquired from CIBA. The reagents were used as received.

### Examples 1-7

General Procedure (see Table 1 for the amount of reagents in each example). Styrene (St), glycidyl methacrylate (GMA), nitroxide and initiator (benzoyl peroxide, BPO) were placed in a double-jacket glass reactor and oxygen was removed with nitrogen bubbling for 3 minutes. Oil was preheated to 130° C. and then circulated through the outside jacket, and the mixture was stirred at 145 rpm. After the desired conversion was reached in 17-20 hours, heating was suspended and additional styrene was added to the reactor with stirring. After 3 min. of stirring, the reaction was either continued in the glass reactor until 10-20% more conversion was reached or directly poured into a second reactor. Nitrogen was bubbled through, and the reactor was immersed in an oil bath, which was previously heated to 125-130° C., for 16-24 hours to reach the desired conversion. Total reaction time for steps one and two ranged from 33 to 44 hours.

TABLE 1
Reactive block copolymers. First-step composition.

| | First Step | | | | | |
|---|---|---|---|---|---|---|
| | | | | Ni- | | Con- |
| Example | St | GMA | GMA | troxide | BPO | version |
| Number | (mmol) | (mmol) | (% mol)^{a} | (mmol) | (mmol) | % |
| 1 | 582.81 | 8.86 | 1.52 | 2.4999 | 1.9230 | 70.00 |
| 2 | 470.76 | 93.39 | 19.84 | 1.4740 | 1.1340 | 69.35 |
| 3 | 293.10 | 58.72 | 20.03 | 4.3024 | 3.3095 | 70.00 |
| 4 | 278.88 | 69.86 | 25.05 | 4.0936 | 3.1497 | 69.96 |
| 5 | 265.84 | 79.87 | 30.05 | 3.9093 | 3.0079 | 74.37 |
| 6^{b} | 293.10 | 58.72 | 20.03 | 4.3024 | 3.3095 | 100.00 |
| 7 | 179.72 | 35.68 | 19.85 | 0.5625 | 0.4327 | 70.00 |

^{a}Considering the initial GMA to St ratio
^{b}Example six is a reference material, a random copolymer with the same amount of epoxy groups and % mol GMA as in example 3.

TABLE 2
Reactive block copolymers. Second-step composition.

| | Second Step | | |
|---|---|---|---|
| Example | St | GMA | Conversion |
| Number | (mmol) | (% mol)^{a} | % |
| 1 | 356.24 | 0.94 | 100 |
| 2 | 356.37 | 11.29 | 100 |
| 3 | 571.79 | 6.79 | 100 |
| 4 | 571.79 | 8.21 | 100 |
| 5 | 571.79 | 9.54 | 100 |
| 6^{b} | — | 20.03 | — |
| 7 | 729.52 | 3.92 | 100 |

^{a}Considering the total GMA to St ratio (first and second step)
^{b}Example six is a reference material, it's a random copolymer with the same amount of epoxy groups than example 3.

Molecular weight distributions relative to polystyrene were determined through GPC (ASTM D3536-91) using a Waters 410, RI detector, THF eluent, 1.0 mL/min, at 40° C.; Styragel linear columns HR 4 and HR 3. Results are shown in Table 3.

TABLE 3
Properties of reactive block copolymers.

| Diblock | | | | | | |
|---|---|---|---|---|---|---|
| Copolymer | | | | | | |
| example | First Step | | | Total | | |
| Number | Mn | Mw | PDI | Mn | Mw | PDI |
| 1 | 15052 | 16403 | 1.09 | 27312 | 32841 | 1.20 |
| 2 | 27668 | 37994 | 1.37 | 50508 | 71264 | 1.41 |
| 3 | 7826 | 8857 | 1.13 | 16994 | 20353 | 1.20 |
| 4 | 7359 | 9220 | 1.25 | 17837 | 28496 | 1.6 |
| 5 | 9914 | 12874 | 1.30 | 21725 | 37023 | 1.70 |
| 6^{a} | 7826 | 8857 | 1.13 | — | — | — |
| 7 | 20212 | 22546 | 1.12 | 92618 | 142527 | 1.5 |

B. Analyzing PET with Various Chain Extenders

Raw materials: Three different types of recycled polyethylene terephthalate were acquired: PETr1 from Industria Mexicana de Reciclaje (IMER) located in Toluca, Estado de México, México and PETr2 and PETr3 from Tecnología de Reciclaje located in Tecamac, Estado de México, México with the following melt viscosities: PETr1 intrinsic viscosity (IV, ASTM 4603-03)=0.692 dL/g; PETr2 melt viscosity=1159 poises; and PETr3 melt viscosity=467 poises. Materials were used as received. Considering that the ASTM 4603-03 method has many sources of error during the viscosity determination (weighting errors, incomplete solubility, temperature fluctuations, manual time lag measurement), in most of the cases, melt viscosity was used. Melt viscosity was measured using an advanced rheometer of TA Instruments Model RA 2000 using the following conditions: peak hold method with 40 mm parallel plates at 270° C. and 0.02 rad/sec.

### Examples 8-13

General procedure. PETr1 and the block copolymer were mixed in a torque rheometer (Brabender Plastograph EC, and a 30/50EHT mixer) at 80 rpm and 270° C. for 7 minutes. The blend was cooled and the intrinsic viscosity (IV) was determined. Results are shown in Table 4. The intrinsic viscosities were determined with a Glass Capillary Viscometer Ubbelohde (ASTM D 4603-03).

TABLE 4
Intrinsic viscosity of PETr1 mixed with reactive block copolymers.

Blends

| | | Diblock | Diblock | |
|---|---|---|---|---|
| Example | PETr1 | Copolymer | Copolymer | IV |
| Number | (%) | Example | % | (dL/g) |
| 8 | 100 | — | 0 | 0.692 |
| 9 | 95 | 1 | 5 | 0.700 |
| 10 | 95 | 2 | 5 | 0.720 |
| 11 | 95 | 3 | 5 | 0.751 |
| 12 | 95 | 4 | 5 | 0.749 |
| 13 | 95 | 5 | 5 | 0.715 |

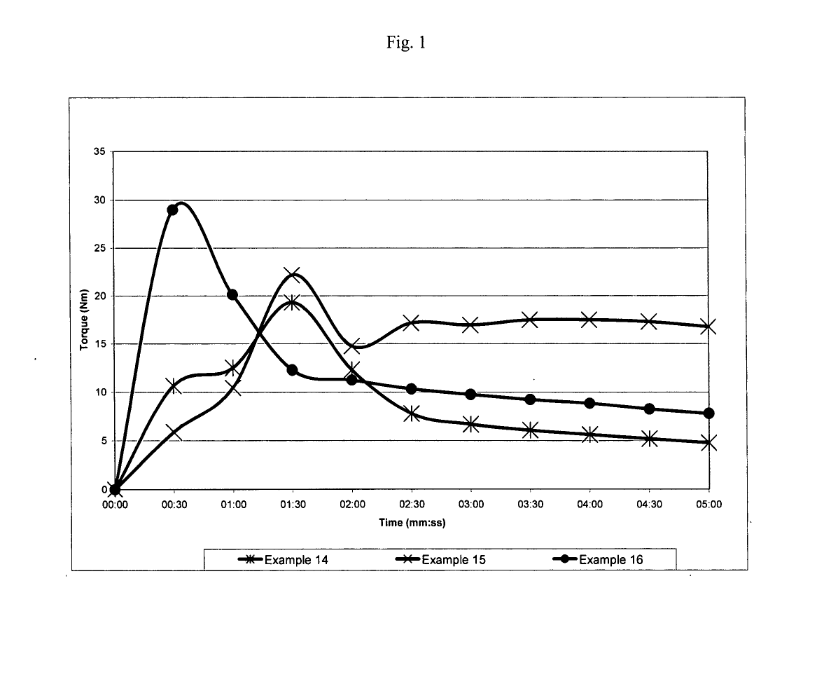

A viscosity increase is observed in all cases, showing the good performance of reactive block copolymers as chain extenders, since one can infer that the molecular weight of the recycled PET increased as the intrinsic viscosity increased. The highest increase in viscosity for this series of examples is observed when the diblock copolymer from example 3 is used. In order to demonstrate that the performance of diblock reactive block copolymers as chain extenders is superior compared with random copolymers, the torque evolution of a blend of PETr1 containing diblock copolymer from example 3 was compared with the performance of a random copolymer containing the same amount of epoxy groups (example 6). The results are collected in examples 14 to 16 and are shown graphically in FIG. 1.

### Example 14-16

Polyethylene terephthalate recycled (PETr1) and reactive block copolymer (RBC) from example 3 and PETr1 and random copolymer (Random) from example 6 were mixed in a Brabender at 80 rpm and 270° C. for 5 minutes. The blends were cooled, and the torque was analyzed. Compositions are shown in Table 5, and torque measurement results are shown graphically in FIG. 1.

TABLE 5
Composition of PETr1 and copolymer blends.

| | Blends | | Amount of |
|---|---|---|---|
| Example | PETr1 | Copolymer | Copolymer |
| Number | (%) | Example | wt % |

| 14 | 100 | — | | 0 |
|---|---|---|---|---|
| 15 | 95 | 3 | (RBC) | 5 |
| 16 | 95 | 6 | (Random) | 5 |

The torque measurements shown in FIG. 1 indicate that the random copolymer of example 6 does improve PETr1 torque (from 5 to approximately 7 Nm after 5 min. of blending), but the increment is very small compared with the torque observed when reactive diblock copolymer from example 3 was reacted with PETr1, where a torque of around 17 Nm was measured after 5 min. of blending. This result shows that the reactive block copolymer chain extenders of the present invention show a huge improvement (40% in the case of the random copolymer of example 6 versus 240% in the case of reactive diblock copolymer of example 3) in terms of chain extension, observed through an increase in torque from which one can infer an improvement in intrinsic viscosity. FIG. 1 clearly shows that the performance of diblock copolymer from example 3 is better at all times than the performance of the random copolymer of example 6, which is similar to example 3 in number of epoxy groups. The increase in torque indicates a viscosity increase, which is believed to be due to a chain extension process.

### Examples 17-29

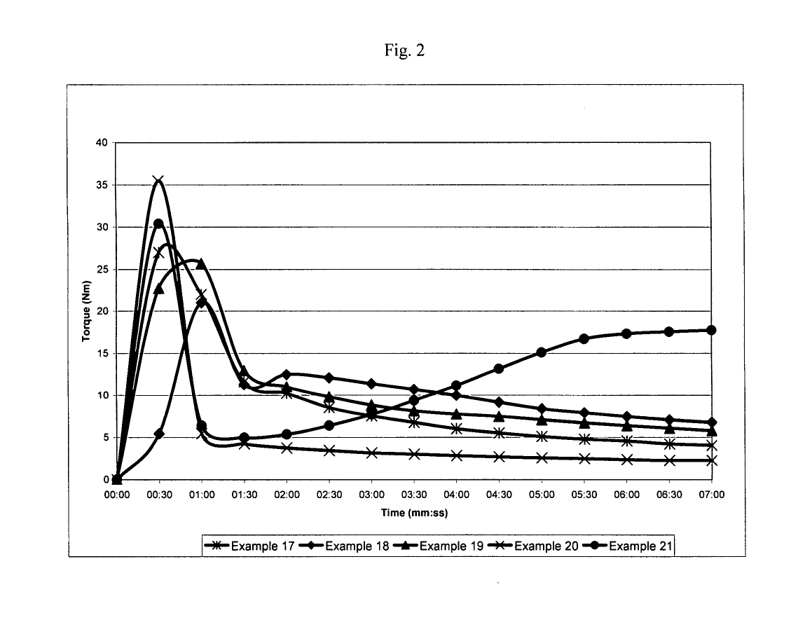

The performance of the diblock copolymers of the present invention was compared to alternative chain extenders, including triphenyl phosphite (TPP), a methacrylic ester-acrylic ester copolymer with greater than 98 wt % glycidyl methacrylate (GMA), a mixture of bisphenol A and an aliphatic glycidyl ether (BPA/GE), and an epoxy functionalized oligomer in a carrier resin (EFO). Recycled polyethylene terephthalate (PETr1) and the different chain extenders were mixed in the torque rheometer at 80 rpm and 270° C. for 7 minutes at loadings of 3, 5 and 7% wt, and results are shown in Tables 6, 7 and 8, respectively. Torque was measured during blending, and after 7 minutes, the blend was cooled and melt viscosity was determined, which is shown in the tables. The torque measurements for the loadings of 3, 5 and 7% wt are shown graphically in FIGS. 2, 3 and 4, respectively. In the figures torque measurements were acquired every two seconds, but the figures show only the results for every 30 seconds in order to improve the visual presentation.

TABLE 6
Melt viscosity of PETr1 with 3 wt % chain extender.

Blends

| | | | Chain | Melt |
|---|---|---|---|---|
| Example | PETr1 | Chain | Extender | Viscosity |
| Number | % wt | Extender | % wt | (Poise) |
| 17 | 100 | — | — | 1024 |
| 18 | 97 | Example 3 | 3 | 1882 |
| 19 | 97 | GMA | 3 | 469 |
| 20 | 97 | BPA/GE | 3 | 945 |
| 21 | 97 | TPP | 3 | 219 |

See FIG. 2 for torque measurements for examples 17-21.

TABLE 7
Melt viscosity of PETr1 with 5 wt % chain extender.

Blends

| | | | Chain | Melt |
|---|---|---|---|---|
| Example | PETr1 | Chain | Extender | Viscosity |
| Number | % wt | Extender | % wt | (Poise) |
| 17 | 100 | — | — | 1024 |
| 22 | 95 | Example 3 | 5 | 25700 |
| 23 | 95 | GMA | 5 | 798 |
| 24 | 95 | BPA/GE | 5 | 837 |
| 25 | 95 | TPP | 5 | 159 |

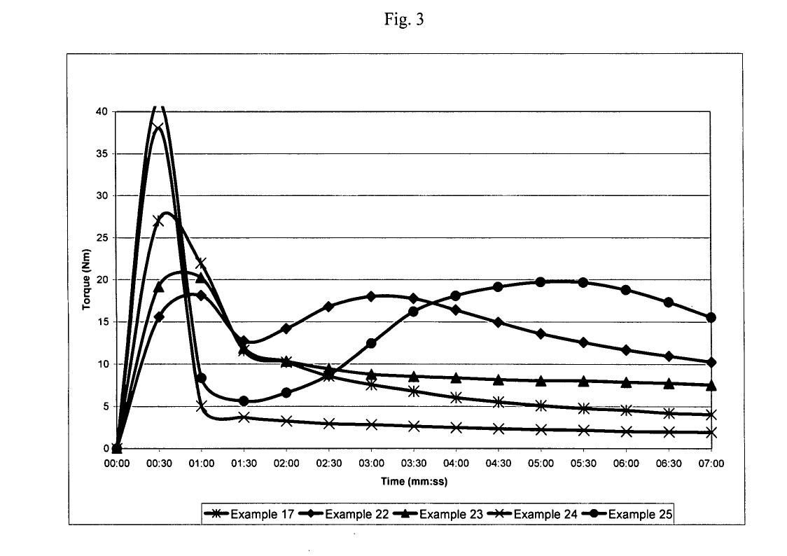

See FIG. 3 for torque measurements for examples 17 and 22-25.

TABLE 8
Melt viscosity of PETr1 with 7 wt % chain extender.

Blends

| | | | Chain | Melt |
|---|---|---|---|---|
| Example | PETr1 | Chain | Extender | Viscosity |
| Number | % wt | Extender | % wt | (Poise) |
| 17 | 100 | — | — | 1024 |
| 26 | 93 | Example 3 | 7 | 123200 |
| 27 | 93 | GMA | 7 | 800 |
| 28 | 93 | BPA/GE | 7 | 739 |
| 29 | 93 | TPP | 7 | 142 |

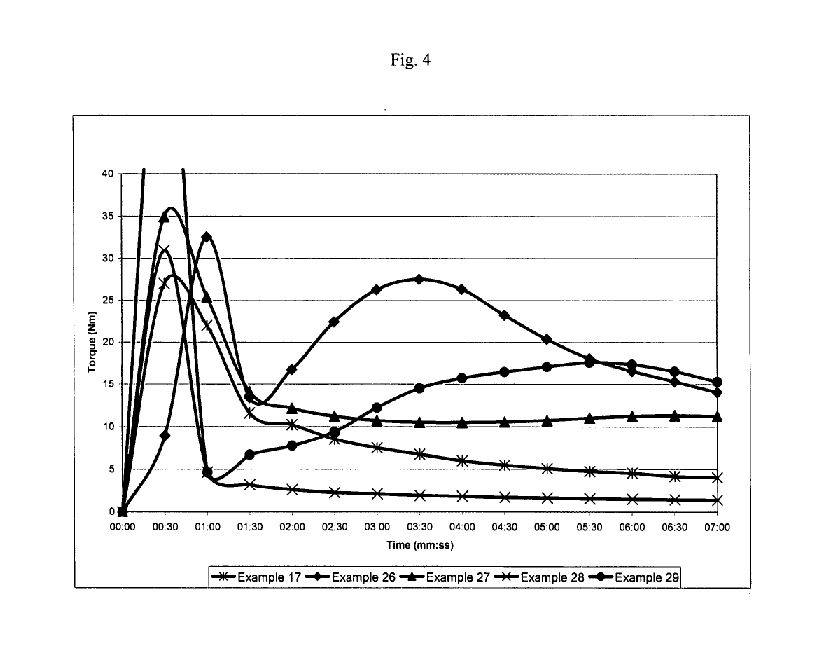

See FIG. 4 for torque measurements for examples 17 and 26-29.

FIGS. 2-4 show that the performance of the diblock copolymer of example 3 is very good, because the torque observed is higher than all the other chain extenders, with the exception of triphenyl phosphite (TPP), which has a better performance. However, triphenyl phosphite has the disadvantage of being an expensive reagent, and it is a powder, which is more difficult to add to an extrusion process. The diblock copolymers can be ground or pelletized in order to obtain granule sizes similar to the ones observed in PET, so the blending process is easily accomplished.

The results shown in FIGS. 2-4 indicate that substantial chain extension occurs, as indicated by torque, when the reactive block copolymer chain extender of the present invention (example 3) is used at loadings of 3, 5 and 7 weight percent. Example 17 in FIGS. 2-4 shows how torque decreases over time, presumably due to degradation of polymer chains and the resulting loss in molecular weight and a corresponding loss in intrinsic viscosity. Example 18, which is the inventive chain extender, in FIG. 2 provides a higher torque than in examples 19 and 20, which are GMA and BPA/GE, respectively. Similarly, example 22, which is the inventive chain extender, in FIG. 3 provides a higher torque than in examples 23 and 24, which are GMA and BPA/GE, respectively. Example 26 in FIG. 4, which is the inventive chain extender at 7 wt %, provides a higher torque than in examples 27 and 28, which are GMA and BPA/GE, respectively. The triphenyl phosphite had the highest torque measurement after seven minutes, but the lowest melt viscosity among the chain extenders (see Tables 6-8). The torque measurements for the BPA/GE was lower than even the recycled PET without a chain extender, indicating that merely adding epoxy functional groups is not helpful for increasing the molecular weight of recycled PET. The GMA chain extender appears to be next best to the chain extender of the present invention according to torque measurements, but is not even close to performing as well as the present invention with respect to melt viscosity, as shown in Tables 6-8. At 3 wt % loading in Table 6, blend 18, which has the chain extender of the present invention (example 3), provides a melt viscosity of 1,182 poise, while the GMA blend provides only 469 poise melt viscosity, and TPP provides only 219 poise melt viscosity. Thus, the melt viscosity of the inventive blend is about four times higher than the GMA blend and over eight times higher than the TPP blend. Therefore, it is expected that PET recycled with the inventive reactive block copolymer of example 3 at a loading of 3 wt % will have better performance characteristics than a similar blend with GMA or BPA/GE.

With reference to FIG. 3, example 22, which is a blend of PETr1 with 5 wt % of the inventive chain extender of example 3, has a higher torque measurement after 7 minutes (about 10 Nm) than the GMA blend of example 23 (about 7.5 Nm) or the BPA/GE blend of example 24 (about 4 Nm). The melt viscosity in Table 7 is 25,700 poise for the inventive chain extender of example 3, while the melt viscosity is 798, 837 and 159 poise for the 5 wt % blends with GMA, BPA/GE and TPP, respectively. The melt viscosity for the inventive blend is about 30 times higher than the melt viscosity for the GMA and BPA/GE and is therefore believed to provide superior performance characteristics for PET recycled with 5 wt % of the diblock copolymer chain extender of the present invention, which in the case of example 3 has a number average molecular weight of 16,994, a weight average molecular weight of 20,353 and a polydispersity index of 1.20. The results with 7 wt % chain extender, Table 8 and FIG. 4, are even more dramatic. The torque measurements shown graphically in FIG. 4 indicate that BPA/GE is detrimental, possibly increasing the breakage of polymer chains, because the torque measured for the blend with 7 wt % BPA/GE (example 28) is lower than the torque measured for PETr1 without any chain extender (example 17). After 7 minutes, the torque measured for the BPA/GE blend (example 28) was about 2.0 Nm, while the torque measured for 100 wt % PETr1 (example 17) was about 4.0 Nm. The blend with 7 wt % GMA (example 27) had a substantially higher torque value (about 11.0 Nm) than the 100 wt % PETr1 (example 17), which was about 4.0 Nm, indicating chain extension had occurred. However, the torque measured for the 7 wt % blend with the chain extender of the present invention as made in example 3 (example 26) yielded an even higher torque of about 14.0 Nm after 7 minutes, which indicates more chain extension occurred with the chain extender of the present invention than with the GMA or the BPA/GE. The TPP (example 29) still provided the highest torque at 7 wt % loading at about 15.0 Nm, but this is only slightly better than the about 14.0 Nm torque measured for the 7 wt % blend with the present invention (example 26). The melt viscosity in Table 8 for the 7 wt % blend with the present invention (example 26) is vastly greater than the melt viscosity measured for any other blend at 123,200 poise versus 800, 739 and 142 poise for 7 wt % blends with GMA, BPA/GE and TPP, respectively. In example 26, the melt viscosity for the blend of 93 wt % PETr1 and 7 wt % of the chain extender of the present invention as made in example 3 is higher beyond comparison at 123,200 poise, indicating very substantial chain extension. No gel formation was observed because when intrinsic viscosity was determined, the polymer was dissolved in an organic halogenated solvent, and no insoluble material was observed.

The reactive block copolymer chain extender of example 3 was made with styrene and about 20 mole percent glycidyl methacrylate in a first step of a controlled living free radical polymerization using a nitroxide stable free radical to about 70 percent conversion, forming a first block of styrene and glycidyl methacrylate but leaving unreacted glycidyl methacrylate in the reactor, followed by a second step in which styrene was added to the reactor and the reaction continued to 100 percent conversion, which provided a second block of primarily styrene but with the previously unreacted gylcidal methacrylate incorporated into the second block. Thus, the first block had a substantial amount of epoxy functional groups from the glycidyl methacrylate, while the second block had a minor amount of epoxy groups, but the second block was not pure polystyrene. The results in the examples show that the reactive block copolymer of the present invention performs very well as a chain extender.

### Examples 30-32

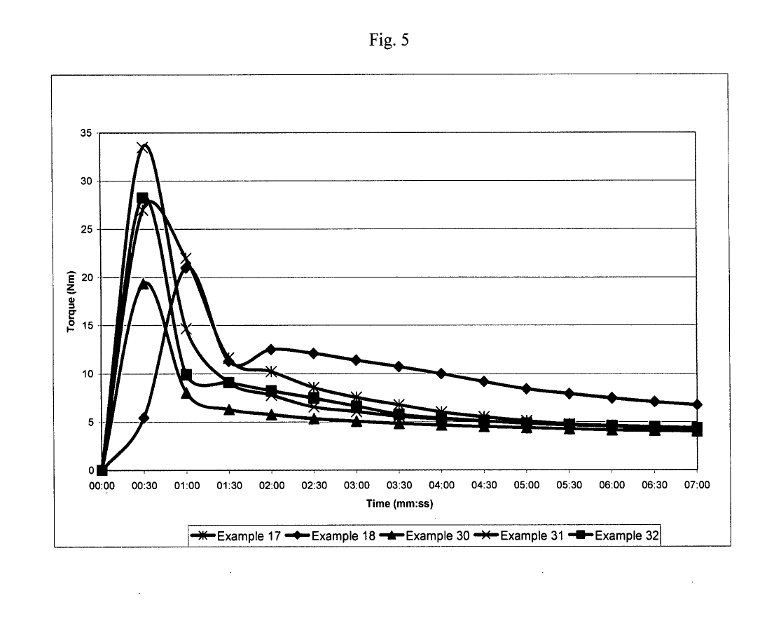

Recycled polyethylene terephthalate (PETr1) was reacted with EFO chain extender, which is the epoxy functionalized oligomer in a carrier resin, at loadings of 0.5%, 1% and 2%, which were understood to be the recommended use levels for this type of chain extender. The results for torque measurements are shown graphically in FIG. 5, and melt viscosity was determined on cooled samples after 7 minutes in the torque rheometer. The melt viscosity measurements are reported in Table 9. Example 18 from Table 6 and FIG. 2, which is the chain extender of the present invention at a loading of 3 wt %, is included in FIG. 5 and Table 9 for comparison.

TABLE 9
Melt viscosity of PETr1 with chain extender.

Blends

| | | | Chain | Melt |
|---|---|---|---|---|
| Example | PETr1 | Chain | Extender | Viscosity |
| Number | % w | Extender | % w | (Poise) |
| 17 | 100 | | — | 1024 |
| 18 | 97 | Example 3 | 3 | 1882 |
| 30 | 99.5 | EFO | 0.5 | 496 |
| 31 | 99 | EFO | 1 | 682 |
| 32 | 98 | EFO | 2 | 747 |

With reference to FIG. 5, example 17 has no chain extender, and yet, at the recommended 1.5 to 2.0 minutes processing time, the torque for example 17 is higher than the torque for examples 30, 31 and 32, which had use levels of EFO of 0.5, 1.0 and 2.0 wt %, respectively. (Torque measurements were acquired every 2 seconds, but are reported in the figures for every 30 seconds for improved visual presentation.) The torque for example 17, PETr1 with no chain extender, decreased during processing in the torque rheometer, and after 7 minutes, the torque for examples 17 and the EFO examples 30, 31 and 32 is all about the same at about 4.0 Nm. This testing did not indicate that EFO caused chain extension or an increase in molecular weight because the torque measured for the blends with EFO was about the same as the torque measured for the recycled PET with no chain extender in example 17. In contrast, after 2 minutes and throughout the 7 minutes in which torque measurements were collected, the chain extender of the present invention (example 3 in example 18 at 3 wt %) provided a blend with a higher torque than measured for the recycled PET with no chain extender in example 17. After 7 minutes in the torque rheometer, example 17 provided a torque of about 4.0 Nm, while the blend with the chain extender of the present invention in example 18 provided a torque of about 7.0 Nm. A torque of about 7.0 Nm is substantially higher than a torque of about 4.0 Nm, which indicates that the chain extender of the present invention provides a substantial amount of chain extension, which increases molecular weight, intrinsic viscosity and melt strength for a recycled PET polymeric material. The data shown graphically in FIG. 3 indicate that with 5 wt % of the chain extender of the present invention (example 22), a torque of about 10.0 Nm was achieved, and FIG. 4 indicates that with 7 wt % of the present chain extender (example 26), a torque of about 14.0 Nm was achieved. Such dramatic increase/improvements in measured torque in blends using the inventive chain extender were unexpected.

The melt viscosities reported in Table 9 are consistent with the torque measurements in FIG. 5. The melt viscosities (measured after samples were taken from the torque rheometer after 7 minutes and cooled) for the blends with EFO were inexplicably lower than the melt viscosity for the recycled PET with no chain extender. The blends in examples 30, 31 and 32 had 0.5, 1.0 and 2.0 wt % EFO, respectively, which yielded melt viscosities of 496, 682 and 747 poise, respectively, as compared to a melt viscosity of 1,024 poise for the recycled PET with no chain extender in example 17. In contrast, the melt viscosity of the recycled PET (example 17) was substantially improved/increased with the chain extender of the present invention (example 18), which provided a melt viscosity of 1,882 poise compared to the 1,024 poise for the recycled PET with no chain extender in example 17. The melt viscosity of the recycled PET was nearly doubled with 3 wt % of the inventive chain extender (Table 9), while the melt viscosity was about 25 times higher with 5 wt % of the inventive chain extender (Table 7) and about 120 times higher with 7 wt % chain extender of the present invention (example 26 in Table 8). Such dramatic results are surprising and were unexpected.

In order to exemplify the use of diblock copolymers of the present invention as additives that allow the incorporation of very low quality (low viscosity) PET to recycled PET of medium quality, the following examples show the performance of diblock copolymer from example 3 in different recycled PET blends.

### Examples 33-47

Polyethylene terephthalate recycled flakes (PETr2), polyethylene terephthalate granulated (PETr3) and diblock copolymer from example 3 were mixed in a Brabender at 80 rpm and 270° C. for 7 minutes. The blend was cooled, and the melt viscosity (MV) was analyzed. Results are shown in Table 10. Melt viscosity measurements were performed in an advanced rheometer of TA Instruments Model RA 2000 in parallel plates at 270° C. and 0.02 rad/sec.

TABLE 10
Melt viscosity of PETr2 and PETr3 blends.

| | Blends | | | |
|---|---|---|---|---|
| | | | Diblock | |
| | | | Copolymer | |
| Example | PETr2 | PETr3 | Example 3 | Melt Viscosity |
| Number | % wt | % wt | % wt | (Poise) |
| 33 | 100 | 0 | — | 1159 |
| 34 | 90 | 10 | — | 1144 |
| 35 | 70 | 30 | — | 917 |
| 36 | 50 | 50 | — | 703 |
| 37 | 30 | 70 | — | 638 |
| 38 | 10 | 90 | — | 498 |
| 39 | 0 | 100 | — | 467 |
| 40 | 90 | 10 | 1.5 | 1136 |
| 41 | 90 | 10 | 3 | 1166 |
| 42 | 90 | 10 | 5 | 8301 |
| 43 | 70 | 30 | 1.5 | 1276 |
| 44 | 70 | 30 | 3 | 1871 |
| 45 | 70 | 30 | 5 | 12960 |
| 46 | 50 | 50 | 1.5 | 974 |
| 47 | 50 | 50 | 3 | 3301 |

Table 10 shows that the incorporation of low quality PETr3 (example 39) to a medium quality PETr2 (example 33) dramatically decreases the melt viscosity, making it difficult, if not impossible, to process the blend through an extruder or a molding machine (see examples 33-37). In example 33, 100% wt of the medium quality PETr2 had a melt viscosity of 1,159 poise, as compared to the lower quality PETr3, which had a melt viscosity of 467 poise (example 39). A blend with 70% wt of PETr2 and 30% wt PETr3 had a melt viscosity of 917 poise, which is substantially lower than the MV of 1,159 poise for PETr2. The results in Table 10 show that if 1.5% wt to 5% wt of the inventive diblock copolymer from example 3 is added to these blends, an excellent improvement in melt viscosity can be easily obtained (examples 40-47). For example, comparing example 47 which is a 1:1 PETr2:PETr1 blend with 3% wt of diblock copolymer from example 3, and example 36 which is the same blend without diblock copolymer, we observe an increase from 703 poise to 3301 poise, which is an increase of 369%. If only 1.5% wt is added (example 46), then the viscosity obtained (974 poise) is nearly as high as the MV observed for the 100% PETr2 in example 33 (1,159 poise) With some experimentation, a loading of the chain extender of the present invention of between 1.5 and 3.0% wt will allow a 50:50 blend of lower quality PETr3 with higher quality PETr2 to have the same melt viscosity as the higher quality PETr2. Example 45 shows that a substantially higher MV (12,960 poise) can be obtained for a blend than in the higher-quality blend component (MV=1,159 in example 33) by adding about 5% wt of the chain extender of the present invention. Thus, lower quality PET produced in a plant can be blended with higher-quality PET, without reducing the melt viscosity of the higher-quality PET, by reaction with the chain extender of the present invention. The chain extender of the present invention can also be used to blend off poorer-quality PET with higher-quality PET, while increasing the MV of the higher quality PET, as indicated by examples 42-45 and 47, which have MV poise values of 8301, 1276, 1871, 12960 and 3301, respectively, versus the 1159 poise MV of the higher-quality PET (example 33). As another application for the chain extenders of the present invention, the poorer-quality PET could also be a recycled PET while the higher-quality PET is a virgin PET.

C. Analysis of Polyesters with Chain Extenders

Raw materials: Polycarbonate (PC) was acquired from Polymer Technology and Services, LLC of Murfreesboro, Tenn., USA.; polybutylene terephthalate (PBT) was acquired from Sabic; polyethylene terephthalate (PETr1) was acquired from IMER, Industria Mexicana de Reciclaje (Toluca, Estado de México, México); polystyrene (PS) was acquired from Resirene (Tlaxcala, Tlaxcala, México) and the chain extender of the present invention according to example 3.

### Examples 48-67

The polyesters were blended with the chain extender from example 3 in proportions shown in Table 11. In all cases the polyesters were also blended with polystyrene just to verify that the observed torque increase was not related to the addition of a “rigid” thermoplastic polymer.

TABLE 11
Polyester blends with diblock copolymer chain extender.

| | Blends | | | | | | | |
|---|---|---|---|---|---|---|---|---|
| | | | | | | Diblock | Diblock | |
| | | | | | | copolymer | copolymer | Specific |
| | PLA | PC | PBT | PETr1 | PS | example 3 | example 7 | Energy |
| Example | % w | % w | % w | % w | % w | % w | % w | KNm/gr |
| 48 | 100 | | | | | | | 0.3 |
| 49 | 96 | | | | | 4 | | 0.5 |
| 50 | 94 | | | | | 6 | | 0.6 |
| 51 | 92 | | | | | 8 | | 0.5 |
| 52 | 92 | | | | 8 | | | 0.4 |
| 53 | | 100 | | | | | | 3.9 |
| 54 | | 96 | | | | | 4 | 3.3 |
| 55 | | 92 | | | | | 8 | 3.3 |
| 56 | | 92 | | | 8 | | | 2.9 |
| 57 | | 50 | | 50 | | | | 2.2 |
| 58 | | 48 | | 48 | | 4 | | 2.3 |
| 59 | | 47 | | 47 | | 6 | | 2.7 |
| 60 | | 46 | | 46 | | 8 | | 2.5 |
| 61 | | 46 | | 46 | 8 | | | 1.7 |
| 62 | | | 100 | | | | | 0.4 |
| 63 | | | 92 | | | 8 | | 0.5 |
| 64 | | | 92 | | 8 | | | 0.4 |
| 65 | | | 70 | 30 | | | | 0.5 |
| 66 | | | 64.4 | 27.6 | | 8 | | 0.7 |
| 67 | | | 64.4 | 27.6 | 8 | | | 0.4 |

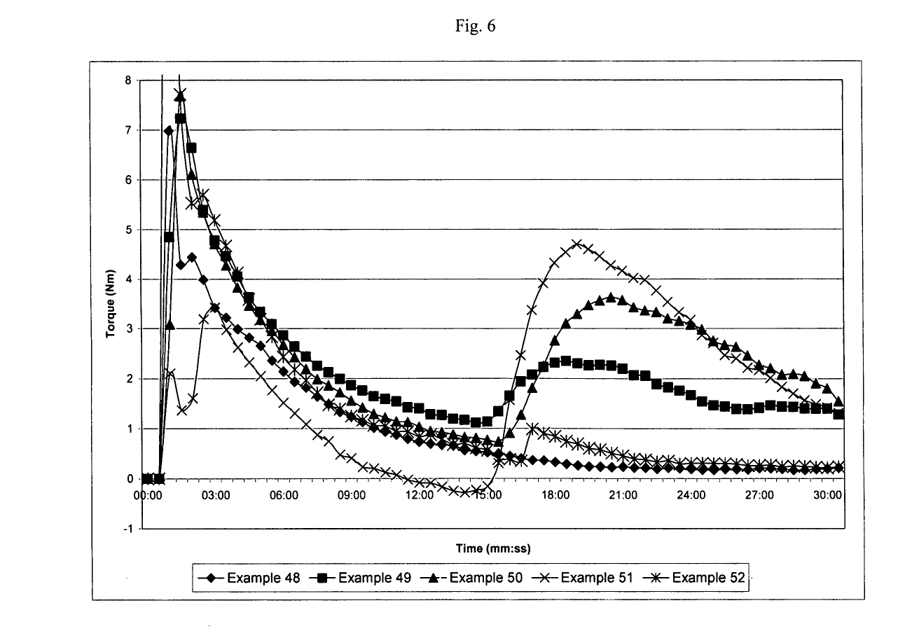

### FIG. 6. Torque Measurement of PLA with Chain Extender

FIG. 6 shows the performance of chain extender in Polylactic Acid (PLA). The Torque of the materials increases with the addition of chain extender. The blends were mixed in a torque rheometer at 80 rpm and 200° C. for 15 min., and then the specified amount of diblock copolymer from example 3 or polystyrene was added, and the torque was registered for 15 more minutes (30 minutes in total).

FIG. 6 shows that the addition of polystyrene gives only a slight improvement in torque, which is caused by the addition of a more rigid polymer. The performance of diblock copolymer from example 3, in terms of torque increase, is excellent and can be controlled by the amount of copolymer added to the blend.

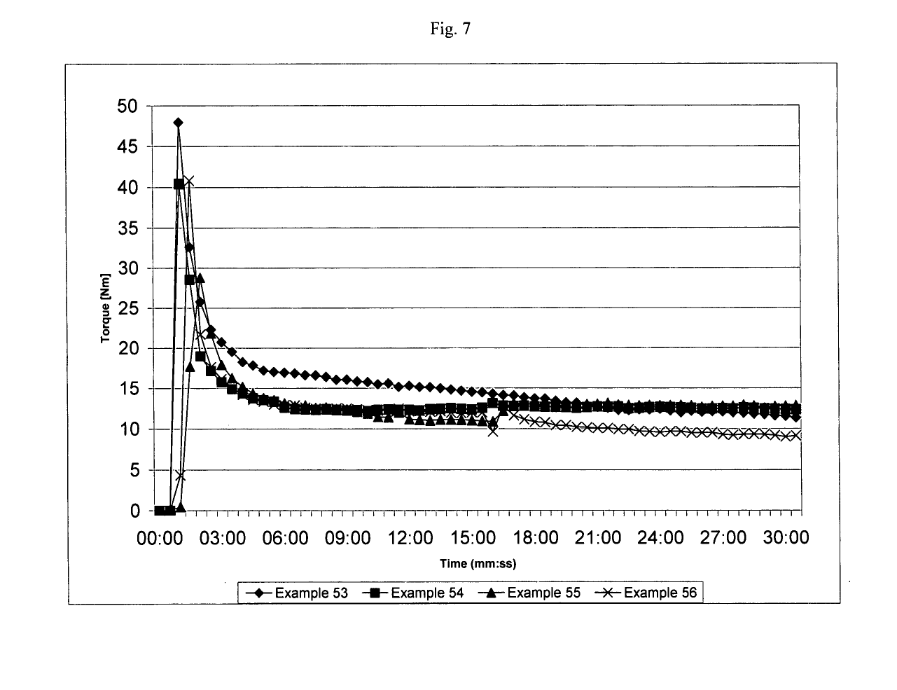

FIG. 7 shows the blends of Polycarbonate (PC) with the chain extender. In this figure we can observe that the torque, after the addition of chain extender, was maintained. The blends were mixed in a torque rheometer at 80 rpm and 270° C.; at 15 min, the specified amount of diblock copolymer from example 7 or polystyrene is added, and the torque is registered for 15 more minutes (30 minutes, total). FIG. 7 shows that the addition of polystyrene decreases the torque of the polymer, and that diblock copolymer from example 7 allows the torque to be maintained almost constant, in comparison with PC, which shows a slight, but constant, decrease in torque.

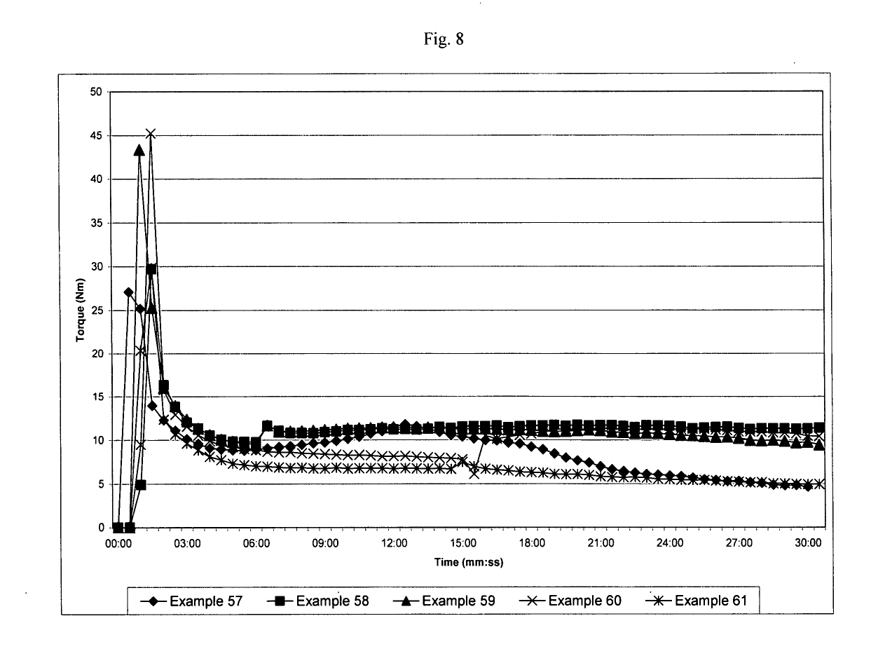

FIG. 8 shows graphically torque measurements for 50:50 blends of PC and PET with and without the inventive chain extender from example 3. The blends were mixed in a torque rheometer at 80 rpm and 270° C. Example 57 is a 50:50 blend of PC and PET without a chain extender and without polystyrene. After stabilizing after about 6 minutes, the torque for the PC-PET blend in example 57 increased from about 8.0 to about 12.0 Nm between 6 and 12 minutes, which might be attributed to a transesterification process, but then decreased between 12 and 22 minutes, after which it stabilized at about 5.0 Nm. In the 50:50 blend of example 58, after 6 minutes in the rheometer, 6% wt of the diblock chain extender from example 3 was added, which essentially immediately increased the torque from about 9.5 Nm to about 12.0 Nm, and the torque held relatively steady at about 12.0 Nm through the remainder of the 30-minute testing period. Thus, a 4% wt loading of the chain extender of the present invention increased torque after 30 minutes in the rheometer from about 5.0 Nm to about 12.0 Nm, which is a substantial increase, indicative of chain extension and its consequent increase in molecular weight and intrinsic viscosity of the 50:50 PC-PET blend. Example 59 was a 50:50 PC-PET blend into which 6 wt % chain extender of example 3 was added at 6 minutes. For about 12 minutes, the torque for the 6 wt % loading was essentially the same as the torque for the 4% wt loading, but over the remainder of the 30 minutes of testing, the torque for the 6% wt loading decreased slightly, indicating there was no advantage gained by the higher loading, which is somewhat contrary to the results seen in the testing described previously. In example 60, 8% wt of chain extender from example 3 was added to a 50:50 PC-PET blend after 15 minutes. Prior to the addition, the torque was about 8.0 Nm, and after the addition the torque increased to about 11.0 Nm and held fairly steady for the remaining 15 minutes of testing. In example 61, polystyrene was added to the 50:50 PC-PET blend after 15 minutes, which had essentially no impact on torque measurement, and which had 5.0 Nm torque equal to the torque of the blend with no chain extender (example 57) at the end of the test period. The results in FIG. 8 show that adding about 4% wt of the inventive chain extender to a 50:50 PC-PET blend (example 58) will increase torque from about 5.0 Nm to about 12.0 Nm, with no additional advantage to be gained by using a higher amount of chain extender.

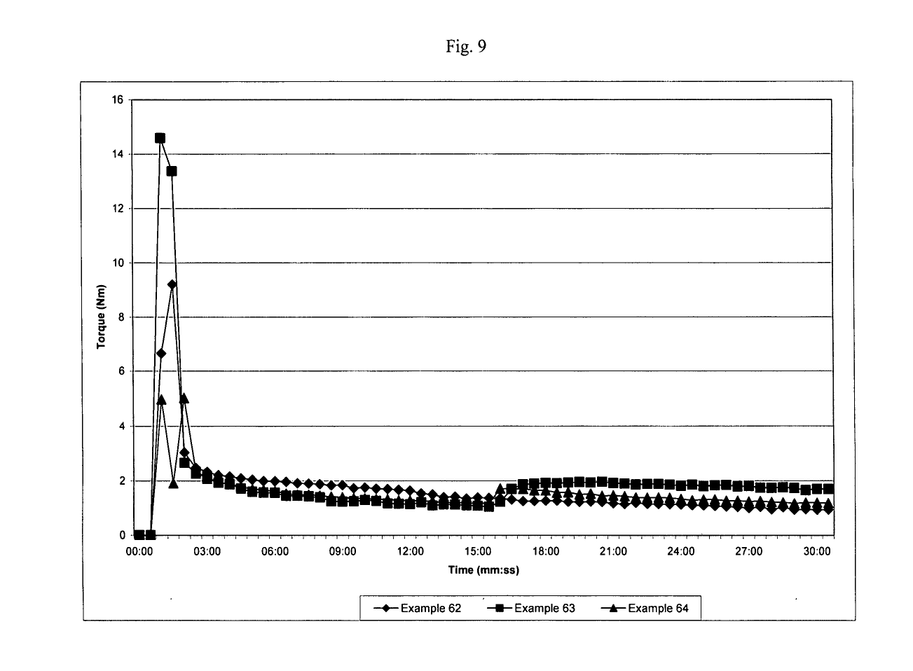

FIG. 9 shows graphically torque measurements for polybutylene terethphalate (PBT) with and without a chain extender. PBT was mixed in a torque rheometer at 80 rpm and 270° C., and after 15 min., either nothing was added (example 62) or 8% wt of the diblock copolymer from example 3 or polystyrene was added or 8% wt polystyrene (PS) was added, and the torque was registered for 15 more minutes (30 minutes total). The torque for the PBT only held fairly steady for the final 15 minutes and ended with a torque value of about 1.0 Nm (example 62). The torque of the PBT-PS blend (example 64) increased somewhat upon addition of the PS, but then gradually decreased over the remaining 15 minutes, ending a little higher than the PBT by itself (example 62) at about 1.2 Nm. Upon addition of 8 wt % chain extender from example 3, torque increased quickly to about 1.8 Nm and held that value reasonably steadily for the remainder of the 30-minute testing period (example 63). Thus, the 8 wt % addition of the chain extender of the present invention increased the torque of PBT from about 1.0 Nm to about 1.8 Nm, which is a substantial increase that indicates a substantial portion of PBT polymer chains were extended, providing an increase in average molecular weight that should result in improved performance of the modified PBT compared to the unmodified or to the PS-modified PBT.

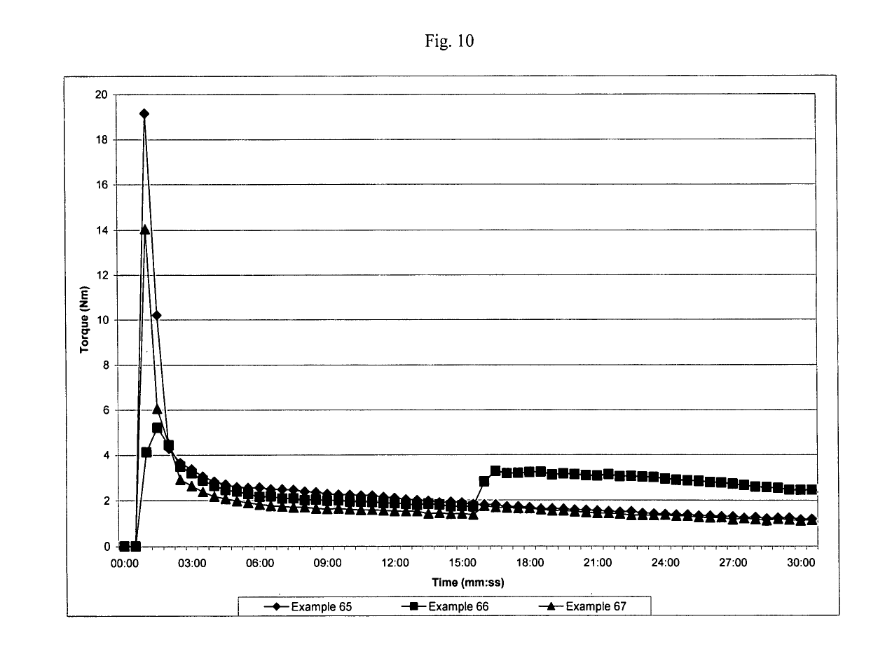

FIG. 10 shows graphically torque measurement of blends PBT-PET (70/30) with and without the chain extender of example 3 (examples 65-70 in Table 11). For example 65, a blend of 70% wt polybutylene terethphalate and 30% wt recycled polyethylene terephthalate (PETr1) was mixed in a torque rheometer at 80 rpm and 270° C. for 30 minutes, and the torque gradually decreased over time, having a value of about 2.5 Nm at 6 minutes and ending with a value of about 1.0 Nm. In example 67, polystyrene (8% wt) was added to the PBT-PETr 1 blend after 15 minutes as a control, and the PS initially increased the torque slightly, but the torque value decreased over the remaining time and ended at about the same value as the unmodified PBT-PETr 1 blend in example 65. In contrast, in example 66, 8% wt of the chain extender of the present invention according to example 3 was added to the PBT-PETr 1 blend after 15 minutes, and the torque value increased from about 1.9 Nm to about 3.5 Nm before gradually decreasing over the remaining time to about 2.5 Nm. The ending value of the torque for the blend modified with the example 3 chain extender was thus about 2.5 Nm as compared to the unmodified and PS-modified blend torque values of about 1.0 Nm, indicating that the inventive chain extender apparently provided significant chain extension, which should provide superior properties for the PBT-PETr 1 blend modified with the chain extender of the present invention.

D. Preparation of Reactive Block Copolymer Using Iodine

Turning now to another aspect of the present invention, the reactive block copolymers in examples 1-5 and 7 were made using nitroxy-mediated controlled free radical polymerization, and in particular, 4-hydroxy-2,2,6,6-tetramethylpiperidin-1-oxyl (4-hydroxy-TEMPO) from CIBA was used as the stable free radical. Iodine-transfer polymerization or degenerative iodine transfer, such as described in the Mestach patent U.S. Pat. No. 7,034,085, can be used as an alternative to provide a stable free radical for controlled free radical polymerization. The following examples demonstrate that molecular iodine can be used to make the reactive block copolymers of the present invention, which can be used in a chain extension process.

Reagents: Styrene (St) was acquired from Rexcel; Glycidyl methacrylate (GMA) was acquired from Dow Química Mexicana S.A. de C.V.; Vazo 52 from DuPont; Iodine USP grade was acquired from CEDROSA. The reagents were used as received.

### Examples 68-69

General Procedure. Styrene (St), glycidyl methacrylate (GMA), iodine and initiator (Vazo 52), in the amounts noted in Table 12, were placed in a double-jacket glass reactor and oxygen was removed with nitrogen bubbling for 3 minutes. Oil was preheated to 60° C. and then circulated through the outside jacket, and the mixture was stirred at 145 rpm. After a desired conversion of 70% was reached, which took about 6 hours, heating was suspended and additional styrene was added to the reactor with stirring (see Table 13). After 3 min. of stirring, the mixture was poured into a second reactor. Nitrogen was bubbled through, and the reactor was immersed in an oil bath, which was previously heated to 65° C., for 8-12 hours to reach a desired 100% conversion. The total reaction time for steps one and two ranged from 14 to 18 hours.

The prior examples were run with the reactive block copolymer (RBC) made in example 3 using 4-hydroxy TEMPO as a nitroxy-based stable free radical. Example 69 was instead made using solid, molecular iodine as the stable free radical. The values from Tables 1, 2 and 3 for example 3 are shown again in Tables 12, 13 and 14 for comparison to example 69.

TABLE 12
Reactive block copolymer. First-step composition.

| | First Step | | | | | |
|---|---|---|---|---|---|---|
| | | | | | | Con- |
| Example | St | GMA | GMA | Iodine | V52 | version |
| Number | (mmol) | (mmol) | (% mol)^{a} | (mmol) | (mmol) | % |
| 68 | 473.81 | 94.99 | 16.70 | 5.18 | 12.50 | 70 |
| 3 | 293.10 | 58.72 | 20.03 | — | — | 70 |

^{a}Considering the initial GMA to St ratio

TABLE 13
Reactive block copolymer. Second-step composition.

| | Second Step | | |
|---|---|---|---|
| Example | St | Conversion | GMA |
| Number | (mmol) | % | (% mol)^{a} |
| 69 | 356.24 | 100 | 8.10 |
| 3 | 571.79 | 100 | |

^{a}Considering the total GMA to St ratio (first and second step)

Molecular weight distributions relative to polystyrene were determined through GPC (ASTM D3536-91) using a Waters 410, RI detector, THF eluent, 1.0 mL/min, at 40° C.; Styragel linear columns HR 4 and HR 3. Results are shown in Table 14.

TABLE 14
Properties of the reactive block copolymer.

| Diblock | | | | | | |
|---|---|---|---|---|---|---|
| Copolymer | | | | | | |
| example | First Step | | | Total | | |
| Number | Mn | Mw | PDI | Mn | Mw | PDI |
| 69 | 8985 | 16901 | 1.88 | 24978 | 36436 | 1.46 |
| 3 | 7826 | 8857 | 1.13 | 16994 | 20353 | 1.20 |

While the RBC of example 69 is somewhat different from the RBC of example 3, they were both prepared in a similar manner with similar components, and both have similar properties. Example 69 has Mn equal to 24,978, while Mn for example 3 is 16,994. Example 69 has Mw equal to 36,436, while Mw for example 3 is 20,353. PDI is 1.46 and 1.20 for examples 69 and 3, respectively. Although the properties for examples 69 and 3 are similar, example 3 was made at a reactor temperature of about 125-130° C., while example 69 was made at a reactor temperature of only about 60-65° C. The substantially lower reactor temperature that can be used with iodine as the stable free radical as opposed to a nitroxide is significant, particularly the energy cost is lower for producing the RBC using iodine at a lower reactor temperature, and iodine is less expensive than a nitroxide-based stable free radical. Reaction time is another difference between using a nitroxide-based stable free radical and iodine as the stable free radical. Total reaction time for steps one and two ranged from 33 to 44 hours for the reactive block copolymers in examples 1-7 made with 4-hydroxy TEMPO, which is the nitroxide-based stable free radical. For example 69, where iodine was used as the stable free radical, the total reaction time for steps one and two ranged from 14 to 18 hours. The 14 to 18 hours for iodine is a substantially shorter reaction time than the 33 to 44 hours for the RBC made using the nitroxide-based stable free radical.

E. Recycled PET/Block Copolymer Blend

Raw materials: Recycled polyethylene terephthalate (PETr4, intrinsic viscosity (IV)=0.78) was acquired from PetStar located in San Cayetano de Morelos, Estado de México, Mexico was used as received.

### Examples 70-73

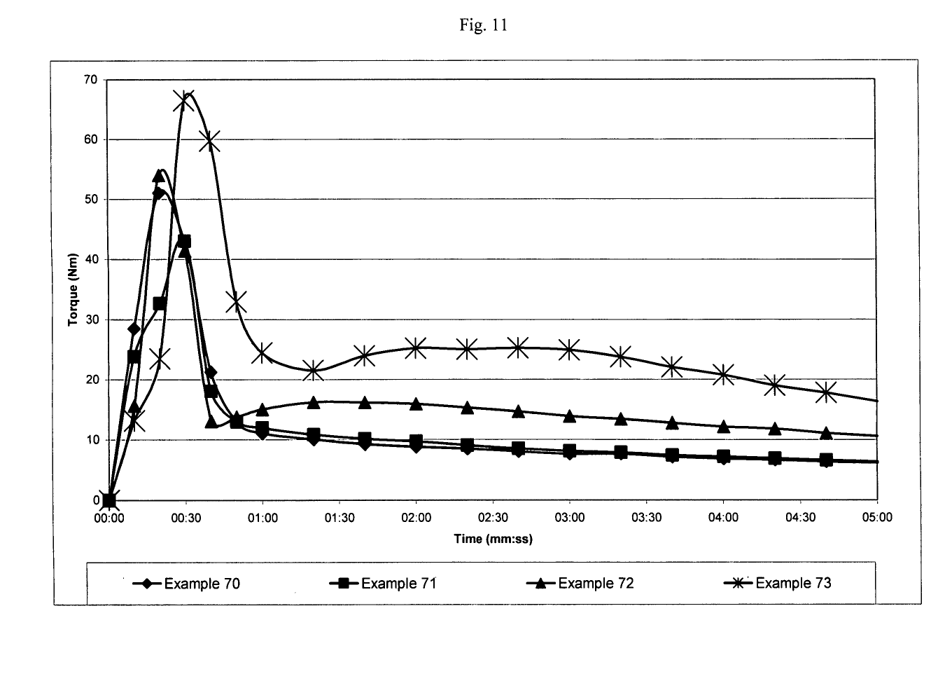

Polyethylene terephthalate recycled (PETr4) and reactive block copolymer from example 69 were mixed in a Brabender at 80 rpm and 270° C. for 5 minutes. The blends were cooled, and the torque was analyzed. Compositions are shown in Table 15, and torque measurement results are shown graphically in FIG. 11.

TABLE 15
Composition of PETr4 and copolymer blends.

| | Blends | | Amount of |
|---|---|---|---|
| Example | PETr4 | Copolymer | Copolymer |
| Number | (%) | Example | wt % |
| 70 | 100 | — | 0 |
| 71 | 99 | 69 | 1 |
| 72 | 97 | 69 | 3 |
| 73 | 95 | 69 | 5 |

With reference to FIG. 11, the recycled PET is the line indicated by the diamond shapes, which is the lowest line from 1 min. through 5 min., but the graph for example 71, recycled PET with 1 wt % reactive block copolymer (RBC) from example 69, which is the line designated by square shapes, practically lays on top of the line for recycled PET with no RBC. This indicates that adding 1 wt % RBC is not sufficient for substantial chain extension. However, with the addition of 3 wt % RBC in example 72, the line in FIG. 11 indicated by triangle shapes shows substantial chain extension, as indicated by torque measurements, because torque at 5 min. of mixing increased from about 6.2 for PET with no RBC to about 10.6 Nm for PET with 3 wt % RBC, while at 2 min. of mixing the torque increased from about 8.9 for PET with no RBC to about 15.9 Nm for PET with 3 wt % RBC Adding 5 wt % RBC (example 73) improves chain extension, as indicated by torque, even more. The line in FIG. 11 indicated by x marks is for example 73 for recycled PET with 5 wt % RBC, which was made in example 69. With 5 wt % RBC, torque at 5 min. of mixing increased from about 6.2 for PET with no RBC to about 16.3 Nm for PET with 5 wt % RBC, while at 2 min. of mixing the torque increased from about 8.9 for PET with no RBC to about 25.3 Nm for PET with 5 wt % RBC. By mixing more than about 1 wt %, preferably 2 to 5 wt %, more preferably 3 to 4 wt %, RBC from example 69 to the PETr4 in examples 70-73, it is apparent that the average length of polymer chains increased by connecting shorter chains of PET together through bonding to the RBC of example 69 through functional groups on the RBC, because torque on the extruder increased, which indicates a higher intrinsic viscosity.

Example 18 of Table 6 and FIG. 2 has 3 wt % nitroxide-formed RBC, and at 2 min. and 5 min., the torque is about 5 and 15 Nm, respectively. Example 22 of Table 7 and FIG. 3 has 5 wt % nitroxide-formed RBC, and at 2 min. and 5 min., the torque is about 14 and 13 Nm, respectively. Example 72 of Table 15 and FIG. 11 has 3 wt % iodine-formed RBC, and at 2 min. and 5 min., the torque is about 15.9 and 10.6 Nm, respectively. Example 73 of Table 15 and FIG. 11 has 5 wt % iodine-formed RBC, and at 2 min. and 5 min., the torque is about 16.3 and 25.3 Nm, respectively. Thus, for 3 wt % RBC, the torque at 2 min. is about 5 Nm for nitroxide-formed RBC versus 15.9 Nm for iodine-formed RBC. For 3 wt % RBC, the torque at 5 min. is about 15 Nm for nitroxide-formed RBC versus 10.6 Nm for iodine-formed RBC. Torque thus increased from 5 to 15.9 at 2 min. for 3 wt % loading by switching from nitroxide to iodine, and torque increased from 14 to 16.3 Nm at 2 min. for 5 wt % loading by switching from nitroxide to iodine. Torque decreased from 15 to 10.6 at 5 min. for 3 wt % loading by switching from nitroxide to iodine, but torque increased from 13 to 25.3 at 5 min. for 5 wt % loading by switching from nitroxide to iodine. It thus appears that a reactive block copolymer formed using iodine performs better than a reactive block copolymer formed using a nitroxide stable free radical, and iodine can be used at a lower reaction temperature. Further, reaction time for making the RBC is shorter when iodine is used as the stable free radical. The reaction time was 14 to 18 hours when iodine was used to make example 69, which is much shorter than the reaction time of 33 to 44 hours for the RBC made using the nitroxide-based stable free radical in examples 1-7. It thus appears that a number of benefits can be achieved by using iodine as the stable free radical for making reactive block copolymers for chain extension according to the present invention rather than a nitroxide-based chemical for the stable free radical, including a lower reaction temperature and a shorter reaction time when iodine is used as the stable free radical.

Use of Reactive Block Copolymers as Surface Modifiers

Turning to another aspect of the present invention, it has been discovered that the reactive block copolymers can be used to modify surface properties of a material, particularly with respect to polarity. One aspect of the present invention concerns using reactive block copolymers as surface modifiers for making a surface, for example, paintable, dyeable, wettable, non-wettable or waterproof and/or coatable, where the reactive block copolymers can be used to impart these and other desired properties into a surface for making, for example, the surface able to dissipate an electrostatic charge and/or to provide properties such as corrosion resistance, color, biocompatibility, adsorption, wettability, friction and adhesion. In this aspect of the present invention, it was discovered that reactive block copolymers can be mixed with and/or reacted with a material, particularly a polymeric material, to provide functional groups within and on the surface of the material, where the functional groups are used to impart a desired property on the surface of the material.

For surface modification, the functional groups on the acrylic monomer used to make the reactive block copolymer are selected to impart a desired property to the surface of a material with which the reactive block copolymer is mixed. The surface properties of a material are related to the polarity of the material, and the functional groups on the acrylic monomer used to make the reactive block copolymer can be selected and used to alter the polarity of the surface of the material to which the reactive block copolymer is added, increasing or decreasing the polarity or surface energy of the material. The material that is to be altered can be a polymeric material, a homopolymer, a copolymer, a blend of polymers and/or a mixture of a polymeric material and a non-polymeric material such as glass fiber, calcium carbonate, inert filler and/or clay.

The surface energy or surface tension on a polymeric material such as a polymer film, polymer fiber and/or a molded polymeric article is indicative of the material's ability to accept a coating of paint, to be dyed, to dissipate an electrostatic charge, etc., and contact angle as described in ASTM D 2578-84 is a useful method for the measurement of surface energy. A low contact angle approaching 0° indicates a high surface energy, which is needed for the surface to be wettable, such as for applying a printing ink and for depositing a metal substrate to the surface. Polyolefins, for example, have high contact angles and, consequently, do not readily accept a coating of paint, a dye or a printing ink. Polyethylene and polypropylene are believed to have, respectively, contact angles of 96° and 108°. To make polyolefins amenable to painting, dyeing and printing, corona or plasma discharge or flame treatment has been used to treat the surface of the polyolefin, lowering the contact angle and raising the surface energy. The present invention provides a simpler way to modify the surface energy of a polyolefin or other polymeric material. By mixing and/or reacting a reactive block copolymer of the present invention with a polymeric material, the surface tension of the polymeric material is lowered, providing good surface reactivity and, consequently, good surface adhesion.

A reactive block copolymer can be tailored to provide particular, desired properties for the surface of a polymeric material. If, for example, one desires to improve the dyeability of a polyolefin fiber, one can determine whether the dye to be used has a charge (positive or negative) or not, and then one can design the reactive block copolymer to have the opposite charge or functional groups that can react or show affinity towards the functional groups contained in the specific dye. For many applications, one will tailor the reactive block copolymer to alter the polarity of the surface of the material to be treated. The reactive block copolymer thus tailored can be mixed with the polymeric material, such as in a reactive extruder or other heated mixing device, to provide the tailored functionality for the surface as well as throughout the polymeric material. In one embodiment, the reactive block copolymer can be tailored to contain monomers that can be polymerized using controlled free radical polymerization and which contain negatively charged monomers (or monomers that upon a change in pH become negatively charged). Examples of such monomers include, but are not limited to, monomers possessing Lewis acids, Bronsted acids such as carboxyl, sulphate, sulphonate, sulfonic acid, carboxylic acids, hydroxyl, mercapto or thio, and any acid hydrogen such as alfa carboxyl hydrogens. In one embodiment the second block of the block copolymer comprises vinyl monomers which also bear functional groups. Examples of functional groups include, but are not limited to, acid, hydroxyl, epoxy, and amino groups. Related U.S. patent application Ser. No. 12/072,173, filed Feb. 25, 2008, and published as U.S. Publication No. 2008/0200601 A1 provides further information concerning selecting monomers with functional groups for positive or negative charge and is incorporated by reference.

Charged monomers (or monomers that upon a change in pH can become charged monomers) in the first block of the reactive block copolymer can have functional groups including, but not limited to, ammonium, alkyl ammonium, aryl ammonium (—N+R(3−n−m)ArmHn where (n+m)≦3), aryl and alkyl phosphonium (—P+R(3−n−m)ArmHn where (n+m)≦3), aryl and alkyl sulfonium (—S+R(2−n−m)ArmHn where (n+m)≦2), substituted ammonium, (—N+X1X2X3) phosphonium (—P+X1X2X3), or sulfonium (—S+X1X2), wherein X1, X2 and X3 are each individually H or a C1-C20 group selected form alkyl, aryl, perfluoroalkyl, arylalkyl, alkylaryl and any of these substituted with one or more oxygen, nitrogen, chlorine, fluorine, bromine, iodine, sulfur and phosphorous, imidazolium, triazolium, Lewis acids, Brönsted acids, sulphate, sulphonate, sulfonic acid, carboxylic acids, hydroxyl, mercapto, thiol, and any acid hydrogen such as alfa carboxyl hydrogens and substituted derivatives thereof. In embodiments of the present invention, the second block of the block copolymer comprises vinyl monomers, possibly with one or more functional groups. The functional groups can be selected to impart desired properties to the surface to be treated. Examples of functional groups for the vinyl monomers in the second block and/or for the acrylic monomers in the first block include, but are not limited to, the following common functional groups: halogen (halo), hydroxyl, carbonyl, aldehyde, carbonate ester, carboxylate, carboxyl, ether, ester, hydroperoxy, peroxy, carboxamide, amine, ammonium, ketimine, aldimine, imide, azide, cyanate, isocyanide, isocyanate, isothiocyanate, nitrate, nitrile, nitrosooxy (nitrite), nitro, nitroso, oxazoline, pyridyl, phosphino, phosphodiester, phosphono, phosphate, sulfonyl, sulfo, sulfinyl, thiol, sulfhydryl, thiocyanate and disulfide groups.

In some embodiments the block copolymer functional acrylic or functional vinyl monomers are monomers, which can be polymerized using controlled radical polymerization and which contain positively charged monomers or monomers that upon pH change become positively charged. Examples of functional groups contained in functional acrylic or functional vinyl monomers include ammonium, alkyl ammonium, aryl ammonium (—N+R(3−n−m)ArmHn where (n+m)≦3), aryl and alkyl phosphonium (—P+R(3−n−m)ArmHn where (n+m)≦3), aryl and alkyl sulfonium (—S+R(2−n−m)ArmHn where (n+m)≦2), substituted ammonium, (—N+X1X2X3) phosphonium (—P+X1X2X3), or sulfonium (—S+X1X2), wherein X1, X2 and X3 are each individually H or a C1-C20 group selected from alkyl, aryl, perfluoroalkyl, arylalkyl, alkylaryl and any of these substituted with one or more oxygen, nitrogen, chlorine, fluorine, bromine, iodine, sulfur and phosphorous. R refers to an alkyl group, and the term “alkyl” refers to linear or branched saturated hydrocarbon substituents having from one to about twenty carbon atoms, or preferably, one to about twelve carbon atoms. Alkyl substituents may themselves be substituted with one or more substituents such as alkoxy, hydroxyl, amino, halo, nitro, acyl, cyano, carboxy, and thioalkyl, for example. Ar refers to an aryl group, and the term “aryl” refers to a carbocyclic aromatic system containing one or more rings which may be attached together in a pendant manner or may be fused, such as phenyl, naphtyl, indane. Aryl substituents may also be substituted with one or more substituents such as alkyl, haloalkyl, alkoxy, hydroxyl, amino, halo, nitro, alkylamino, acyl, cyano, carboxy, thioalkyl, and alkoxycarbonyl. Other quaternary ammonium moieties include, but are not limited to, imidazolium, triazolium and substituted derivatives thereof. Substitution of the imidazolium or triazolium group may be with any of a variety of alkyl, aryl, arylakyl or alkylaryl groups, and/or substitution may be in the form of one or more fused rings. Other phosphonium groups include 1 to 4 aryl substituents.

After the monomers and functional groups for a reactive block copolymer are selected for a particular end-use application for a polymeric material and the reactive block copolymer has been made as described herein, the reactive block copolymer is preferably mixed with and/or reacted with the polymeric material in an extruder at an elevated temperature to provide reactive conditions. The reactive extruder may have a single screw, twin screws or multiple screws of various lengths and designs operating at a suitable speed or revolutions per minute (RPM) in order to achieve an adequate residence time, which typically ranges from about 0.5 to about 15 minutes and is preferably more than about 2.0 minutes and more preferably more than about 4.0 minutes, at a sufficiently high temperature, which depends on the polymeric material, but which is preferably above the glass transition temperature of the reactive block copolymer and of the polymeric material and possibly above the melting point of each. The temperature of the reaction mixture is typically above 100° C., preferably above 150° C., more preferably above about 200° C., and most preferably above 250° C. Other equipment and vessels may also be used instead of a reactive extruder to react the reactive block copolymer with the polymeric material, including a dry, heated tumbler, a melt blender, a solution blender, a Banbury mixer, a roll mill, a continuous mixer such as by Farrell, and a Buss co-kneader.

Although the surface of the polymeric material is to be altered or treated for subsequent applications, the reactive block copolymer is mixed thoroughly throughout the polymeric material, which alters the properties of the polymeric material on the surface and below the surface to the core of the material. This is believed to be particularly beneficial in a polymeric material that is to be dyed because it is believed the dye will penetrate deeper than if the surface of the polymeric material is merely treated by, for example, flame treatment or plasma discharge or if a thin layer of material is grafted to the surface. Reactive block copolymer customized for a particular surface-modification application can be delivered to an end user in any desired form, but it is anticipated that pellets, such as from an extruder, will be delivered to the end user. A masterbatch can be formed that contains a high concentration of the customized reactive block copolymer mixed and/or reacted with a small portion of the polymeric material, where the masterbatch is delivered to the end user, who blends, preferably by co-extrusion, the masterbatch in a desired proportion with the polymeric material.

Applications for Reactive Block Copolymers as Surface Modifiers

The reactive block copolymers can be customized for particular applications. Applications include making a polymeric material paintable, dyeable, wettable, non-wettable or waterproof, coatable, able to dissipate an electrostatic charge, resistant to corrosion, colorable, have greater surface friction, biocompatible, capable of adsorption, and capable of bonding with an adhesive. The functional groups for the acrylic monomer can be chosen to impart a desired property to a polymeric material. The vinyl monomers in the first and second blocks of the reactive block copolymer can also add functionality to the surface modifier.

Polymeric materials having surface properties that can be modified with reactive block copolymers according to the present invention include, but are not limited to, polycarbonates, polyesters such as PET, PBT and PLA, lactide polymers, polyamides such as various nylons, polyolefins such as PE and PP, PVC, polystyrene, styrenic derivatives, styrene acrylic and methacrylic copolymers, elastomers such as SBR and ABS, polyurethane, polyurethane blends and with fillers, polyhydroxyalkanoate (PHA) polymers, polysulfones, polyacetals, polyimides, polyether imides, polyether sulfones, polyphenylene ethers, polyether ketones, polyether-ether ketones, polyarylates, polyphenylene sulfides and polyalkyls. The chemical structure of a few of the polymeric materials subject to surface modification according to the present invention are listed in Table 16 below, and the reactive portion of these polymer units is encircled.

TABLE 16
Example polymeric materials, where reactive functionality is indicated by a circle.

| Polymer | Chemical Structure |
|---|---|
| Polycarbonate | 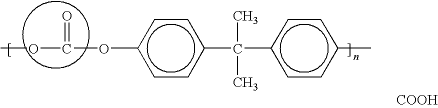 |
| Polyesters PET, PBT, PLA | 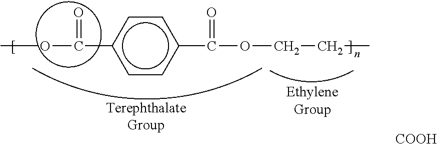 |
| Lactide polymers | 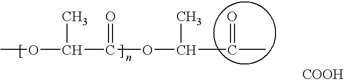 |
| Polyamides/nylon | 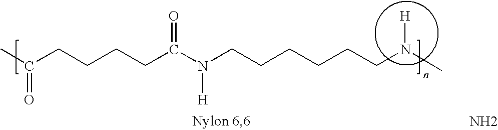 |
| Polyolefins (PE, PP) | 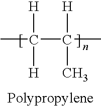 |
| PVC | 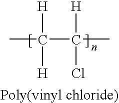 |
| Polystyrene, Styrenic Derivatives, Styrene acrylics and methacrylic copolymers, SBR, Polyurethane | 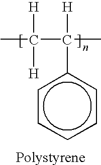 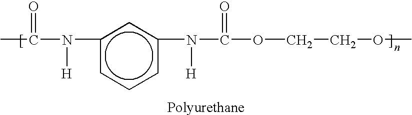 |

Depending on the reactive functionality of the polymeric material for which surface properties are to be modified, a reactive block copolymer can be made to introduce the desired functionality to the polymeric material by reacting the reactive block copolymer with the polymeric material. In making the reactive block copolymer, the acrylic monomer having functional groups can be a positively charged monomer or a monomer that becomes positively charged upon a change in pH, a neutral or uncharged monomer or a negatively charged monomer or a monomer that becomes negatively charged upon a change in pH. Some examples of functional groups that are positively charged or that become positively charged upon a change in pH include, but are not limited to, amine, amide, ammonium, alkyl ammonium, aryl ammonium, phosphonium, and alkyl or aryl phosphonium. Some examples of functional groups that are neutral or uncharged include, but are not limited to, halogen (halo), hydroxyl, carbonyl, aldehyde, carbonate ester, epoxy, carboxyl, ether, ester, hydroperoxy, peroxy, carboxamide, amine, ketimine, aldimine, anhydride, imide, azide, cyanate, isocyanide, isocyanate, isothiocyanate, nitrate, nitrile, nitrosooxy (nitrite), nitro, nitroso, pyridyl, phosphino, phosphodiester, phosphono, phosphate, sulfonyl, sulfo, sulfinyl, thiol, sulfhydryl, thiocyanate and disulfide groups. Examples of functional groups that are negatively charged or that become negatively charged upon a change in pH include, but are not limited to, monomers possessing Lewis acids, Bronsted acids such as carboxyl, sulphate, sulphonate, sulfonic acid, carboxylic acids, hydroxyl, mercapto or thio, and any acid hydrogen such as alfa carboxyl hydrogens.

The vinyl monomers typically used in the first step for making the reactive block copolymer are styrene and/or a substituted styrene, which is reacted with the acrylic monomer having functional groups that is selected for a particular application. Some residual unreacted acrylic monomer remains in the reactor at the end of the first step, and in a second step one or more vinyl monomers are reacted together and with the residual unreacted acrylic monomer that remains in the reactor after the first step is completed. These one or more vinyl monomers for the second step have been listed previously herein and include, but are not limited to, acrylates, methacrylates, oxazolines, anhydrides, long chain acrylics and/or methacrylics, styrene and/or substituted styrene.

Table 17 below provides some examples for compositions of reactive block copolymers that may be used to impart surface properties to a few of the possible polymeric materials that may be modified according to the present invention. Table 17 is not intended to be a complete listing of the possible combinations of functionality in reactive block copolymers with polymeric materials, but instead serves to teach how one may select components to achieve a desired property in a polymeric material, recognizing that some experimentation may be required to achieve a particularly desired property in the polymeric material.

TABLE 17
Examples of possible functional groups in a reactive block copolymer that can react with and/or interact with functionality
in a few of the possible polymeric materials whose properties can be modified according to the present invention.

| | DIBLOCK COPOLYMER: | | | | |
|---|---|---|---|---|---|
| | | Functional acrylic (one or more of the following) | | | |
| | | | neutral (not charged) monomers: | negatively charged monomers | |
| | | | halogen (halo), hydroxyl, carbonyl, | (or monomers that upon a | |
| | | | aldehyde, carbonate ester, epoxy,, | change in pH become nega- | |
| | | | carboxyl, ether, ester, hydroperoxy, | tively charged). Examples | |
| | | | peroxy, carboxamide, amine, | of such monomers include, | |
| | | | ketimine, aldimine, anhydride, | but are not limited to, | |
| | | | imide, azide, cyanate, isocyanide, | monomers possessing Lewis | |
| | | positively charged monomers | isocyanate, isothiocyanate, nitrate, | acids, Bronsted acids such | |
| | | or monomers that upon pH | nitrile, nitrosooxy (nitrite), | as carboxyl, sulphate, | |
| | | change become positively | nitro, nitroso, pyridyl, phosphino, | sulphonate, sulfonic acid, | |
| | | charged: ammonium, alkyl | phosphodiester, phosphono, phos- | carboxylic acids, hydroxyl, | |
| | | ammonium, aryl ammonium, | phate, sulfonyl, sulfo, sulfinyl, | mercapto or thio, and any | |
| Polymer to be | Vinyl | amide, phosphonium, alkyl | thiol, sulfhydryl, thiocyanate and | acid hydrogen such as alfa | Other monomers |
| modified: | monomers | or aryl phosphonium | disulfide groups. | carboxyl hydrogens. | (one or more) |
| Polycarbonates | styrene, | amide, amine | epoxy, hydroxyl, | x | acrylates, |
| | substituted | | acid, amine, | | methacrylates, |
| | styrene | | amide | | oxazolines, |
| | | | | | anhydrides |
| Polyesters | styrene, | amine, amide | epoxy, hydroxyl, | X | acrylates, |
| PET, PBT, PLA | substituted | | acid, amine, | | methacrylates, |
| | styrene | | amide | | oxazolines, |
| | | | | | anhydrides |
| lactide | styrene, | amine, amide | epoxy, hydroxyl, | X | acrylates, |
| polymers | substituted | | acid, amine, amide, | | methacrylates, |
| | styrene | | oxazolines, anhydrides | | |
| polyamides/ | styrene, | amide | epoxy, acid, amide, | acid | acrylates, |
| nylon, | substituted | | oxazolines, anhydrides | | methacrylates |
| | styrene | | | | |
| Polyolefins | styrene, | amide, amine | hydroxyl, carbonyl, | acid | long chain |
| (PE, PP) | substituted | | aldehyde, epoxy, | | acrylic or |
| | styrene | | carboxyl, amine, | | methacrylic, |
| | | | anydride, imide, | | styrene, |
| | | | isocyanate, | | substituted |
| | | | | | sytrene |
| PVC | styrene, | amine, amide | N-Phenyl Maleimide | | acrylates, |
| | substituted | | | | methacrylates |
| | styrene | | | | |

With reference to Table 17, surface properties of polycarbonates can be modified by mixing and/or reacting, such as in an extruder, a reactive block copolymer with the polycarbonate. For polycarbonates, the reactive block copolymer or RBC may include an amide or an amine as the functional acrylic monomer, which is positively charged or which become positively charged upon a change in pH, or a neutral or uncharged acrylic monomer having epoxy, hydroxyl, acid, amine, and/or amide functionality. The vinyl monomer reacted with the functional acrylic monomer in the first step for making the reactive block copolymer can be a styrene and/or a substituted styrene. The surface properties of the polycarbonate can also be changed by incorporating functionality into the reactive block copolymer through the one or more vinyl monomers used in the second step for making the reactive block copolymer. The one or more vinyl monomers in the second step include acrylates, methacrylates, oxazolines, and/or anhydrides for introducing functionality into the reactive block copolymer, which in turn introduces functionality into the polycarbonate material that is to be altered. Introducing one or more of the functional groups listed in Table 17 into the reactive block copolymer and mixing/reacting the reactive block copolymer with the polycarbonate changes the surface properties in the polycarbonate material, making the polycarbonate material more paintable, dyeable, wettable and coatable, more able to dissipate a static charge, more capable of adsorption, and more capable of bonding with an adhesive. Table 17 provides examples for other polymeric materials whose properties can be altered by mixing and/or reacting with a reactive block copolymer made with functionality suggested in Table 17. The present invention applies to any material having properties that can be affected by a reactive block copolymer, where one skilled in this art can select functionality for the reactive block copolymer to affect the properties of the material in a desired manner. Thus, the materials should not be limited to those listed herein, and the reactive block copolymers should not be limited to those listed herein. The principles taught here apply to wide range of materials and to a wide range of reactive block copolymers.

Table 18 below lists some of the surface properties that can be altered in a few of the polymeric materials listed in Table 17. The surface properties of additional polymeric materials not listed in Tables 16, 17 or 18 can be changed using the methods described herein. It is likely that there are additional properties not listed here that can be affected using reactive block copolymers according to the present invention.

TABLE 18
Surface properties in various polymeric materials
that can be changed with a properly-customized RBC.

| Polymer | |
|---|---|
| modified as | |
| indicated above | Property changed by modification using an RBC |
| Polycarbonates | more paintable, dyeable, wettable and coatable, more |
| | able to dissipate a static charge, more capable of |
| | adsorption, and more capable of bonding with an |
| | adhesive |
| Polyesters | more paintable, dyeable, wettable and coatable, more |
| such as PET, | able to dissipate a static charge, more capable of |
| PBT and PLA | adsorption, and more capable of bonding with an |
| | adhesive |
| Lactide | more paintable, dyeable, wettable and coatable, more |
| polymers | able to dissipate a static charge, more capable of |
| | adsorption, and more capable of bonding with an |
| | adhesive |
| Polyolefins | more paintable, dyeable, wettable and coatable, more |
| such as PE | able to dissipate a static charge, more capable of |
| and/or PP | adsorption, and more capable of bonding with an |
| | adhesive |

Example 74 provides data concerning modifying a surface property of polypropylene (PP). Two different samples of reactive block copolymer (RBC) were made and designated as NANOI-15-4 and NANOI-15-7. With reference to Table 19, in a first step for making the RBC NANOI-15-4, 0.0381 grams (g) of acrylic acid and 4.0 g of dimethyl amino ethyl methacrylate were used as functional acrylic monomers and reacted with 37.7 g of p-t-butyl styrene as a vinyl monomer in the presence of 2.0589 g of RAFT agent dibenzyl trithiocarbonate using 0.0632 g of 2,5-dimethyl-2,5-bis(t-butylperoxy)hexane and 0.1741 g benzoyl peroxide as initiators. The reaction in the first step was taken to 81.72% conversion, yielding a first copolymer block having a number average molecular weight of 3725, a weight average molecular weight of 4744 and a polydispersity index of 1.27. In a second step, 12.5 g of p-t-butyl styrene was added to 37.5 g of the reaction product from the first step, which included residual, unreacted acrylic monomer. The reaction in step 2 was taken to 96.53% conversion, yielding reactive block copolymer NANOI-15-4 having a number average molecular weight of 5377, a weight average molecular weight of 6982 and a polydispersity index of 1.30.

Reactive block copolymer NANOI-15-7 was made in a similar manner. Again with reference to Table 19, in a first step for making the RBC NANOI-15-7, 0.0321 grams (g) of acrylic acid and 4.2 g of dimethyl amino ethyl methacrylate were used as functional acrylic monomers and reacted with 27.9 g of p-t-butyl styrene as a vinyl monomer in the presence of 0.07901 g of RAFT agent dibenzyl trithiocarbonate using 0.0255 g of 2,5-dimethyl-2,5-bis(t-butylperoxy)hexane and 0.0671 g benzoyl peroxide as initiators. The reaction in the first step was taken to 90.18% conversion, yielding a first copolymer block having a number average molecular weight of 5936, a weight average molecular weight of 7696 and a polydispersity index of 1.30. In a second step, 25.0 g of p-t-butyl styrene was added to 25.0 g of the reaction product from the first step, which included residual, unreacted acrylic monomer. The reaction in step 2 was taken to 96.93% conversion, yielding reactive block copolymer NANOI-15-4 having a number average molecular weight of 13,672, a weight average molecular weight of 19,695 and a polydispersity index of 1.44.

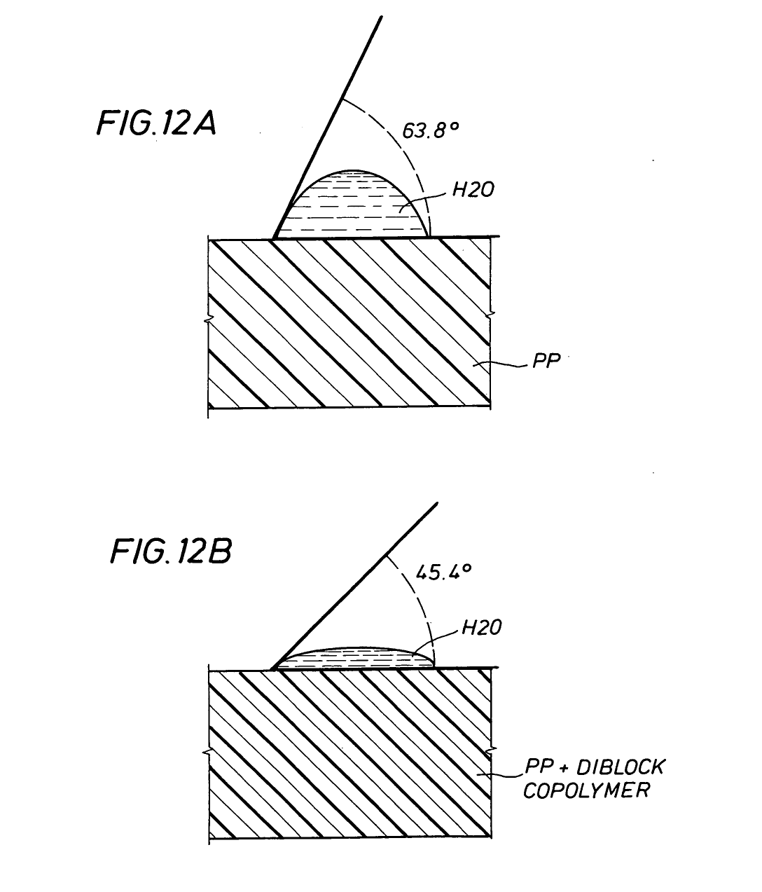

With reference to Table 20, ten weight percent of each of the reactive block copolymers NANOI-15-4 and NANOI-15-7 was mixed with 90 wt % PP in a Brabender rheometer at 200° C. at 80 rpm for 5 min. Samples of each RBC and of the PP were pressed into thin films at 200° C. Five samples of each material were obtained. Wettability of the surface of the samples, which is also indicative of paintability, dyeability and polarity of the surface of the samples, was measured by placing two microliters of deionized water on the surface of each sample followed by immediate measurement of the contact angle of the surface of the bead of water with respect to the surface of the sample of polymeric material. The contact angle was measured using a Ramé-Hart, Inc. Model 100-00 NRL Contact Angle Goniometer at 25° C. and 30% relative humidity. Table 21 provides the values of the contact angle measurements. The five samples of PP had an average contact angle of 63.8° with values ranging between 62 and 65°. FIG. 12A shows graphically the contact angle of the surface of the bead of water with respect to the surface of the sample of the reference, untreated polypropylene, showing an average contact angle of 63.8°. The five samples of a blend of 90 wt % PP with 10 wt % of the RBC identified as NANOI-15-4 had an average contact angle of 45.40°, while the five samples of the blend of 90 wt % PP with 10 wt % of the RBC identified as NANOI-15-7 had an average contact angle of 53.80° with values ranging between 52 and 56°. FIG. 12B shows graphically the contact angle of the surface of the bead of water with respect to the surface of the sample that contains 90% polypropylene and 10% wt of NANOI-15-4 diblock copolymer according to the present invention, showing an average contact angle of 45.4°. Thus, each of the PP samples treated with the reactive block copolymers NANOI-15-4 and NANOI-15-7 had lower contact angles than untreated PP, indicating the treated samples were more wettable, which indicates the treated samples were also more paintable, coatable, dyeable and in general, more polar because polarity was introduced to the treated PP through the functionality in the reactive block copolymers NANOI-15-4 and NANOI-15-7. Although not shown in the example below, after a minute and 46 seconds, the contact angle for the sample of PP blended with NANOI-15-7 decreased to about 40°; after about 3 min. and 9 sec., the contact angle further decreased to about 30°; and after about 4.5 min., the contact angle decreased to essentially zero, indicating the water droplet had completely spread out on the surface of the sample of PP blended with NANOI-15-7. These results indicate that the sample of PP blended with NANOI-15-7 was more polar and had greater surface energy than untreated polypropylene, making the treated sample more paintable, dyeable, wettable, coatable, printable, able to dissipate an electrostatic charge, colorable, capable of adsorption, and capable of bonding with an adhesive. Similar results are expected to be achieved when other polymeric materials are treated with these same and with different reactive block copolymers, and desired results can be achieved by appropriate selection of the monomers and reactants used to make a reactive block copolymer for achieving the desired results.

The example described concerns making a surface more polar and with greater surface energy, but the opposite effect can be achieved for certain polymeric materials by selecting the functionality of a reactive block copolymer appropriately. Thus, the surface of certain polymeric materials can be made less polar and have less surface energy (and thus have a greater contact angle than the untreated polymeric material) by appropriate selection and production of a reactive block copolymer that imparts the desired effect. In this case, the surface of certain polymeric materials can be made less paintable, dyeable, wettable and coatable, less able to dissipate a static charge, less capable of adsorption, and less capable of bonding with an adhesive.

### Example 74

Decrease in contact angle of water on polypropylene following treatment with reactive block copolymer.

TABLE 19
Diblock copolymer synthesis.
First Block

| | Dimethyl | p-t- | | | | | 2,5-dimethyl- | | | | |
|---|---|---|---|---|---|---|---|---|---|---|---|
| | amino ethyl | butyl | | Dibenzyl | Benzoyl | Acrylic | 2,5-bis(t- | | | | |
| | methacrylate | styrene | Monomer | trithiocarbonate | peroxide | acid | butylperoxy) | Solids, | | | |
| ID | (g) | (g) | (total, g) | (g) | (g) | (g) | hexane (g) | % | Mn | Mw | P.D. |
| NANOI- | 4.0 | 37.7 | 41.7 | 2.0589 | 0.1741 | 0.0381 | 0.0632 | 81.72 | 3725 | 4744 | 1.27 |
| 15-4 | | | | | | | | | | | |
| NANOI- | 4.2 | 27.9 | 32.1 | 0.7901 | 0.0671 | 0.0321 | 0.0255 | 90.18 | 5936 | 7696 | 1.30 |
| 15-7 | | | | | | | | | | | |

Second Block

| | First block | p-t-butyl | | | | |
|---|---|---|---|---|---|---|
| ID | (g) | styrene (g) | % solids | Mn | Mw | P.D. |
| NANOI- | 37.5 | 12.5 | 96.53 | 5377 | 6982 | 1.30 |
| 154 | | | | | | |
| NANOI- | 25 | 25 | 96.93 | 13672 | 19695 | 1.44 |
| 15-7 | | | | | | |

TABLE 20

| Blend | HS013 Valtech | Diblock | Diblock |
|---|---|---|---|
| components | (INDELPRO) | copolymer | copolymer |
| (% wt) | (PP homopolymer) | NANOI-15-4 | NANOI-15-7 |
| Reference | 100 | | |
| NANOI-15-4 | 90 | 10 | |
| NANOI-15-7 | 90 | | 10 |

Blends were prepared in a brabender rheometer at 200° C. and 80 rpm during 5 min. After that a sample was obtained and then pressed at 200° C. to obtain a thin film.

TABLE 21

| | Polypropylene | PP + | PP + |
|---|---|---|---|
| Sample | HS013 Valtech | NANOI-15-4 | NANOI-15-7 |
| 1 | 65 | 44 | 53 |
| 2 | 65 | 45 | 54 |
| 3 | 63 | 45 | 56 |
| 4 | 64 | 47 | 54 |
| 5 | 62 | 46 | 52 |
| Average | 63.8 | 45.4 | 53.8 |
| Std. Dev. | 1.3 | 1.1 | 1.5 |

Contact angles were measured using a Ramé-Hart, Inc. Model 100-00 NRL Contact Angle Goniometer and adding 2 microliters of DI water to the surface to be evaluated at 25° C. and 30% relative humidity.

### Example 75

Preparation of Reactive Block Copolymer Surface Modifiers

Reagents: Tert-butylstyrene (TBS) was acquired from Quimica Anher; 2-(dimethylamino)ethyl methacrylate (DMAEMA) and N,N-dimethyl acrylamide was acquired from Corporacion Mexicana de Polimeros; dibenzyl trithiocarbonate (DBTTC) was acquired from Arkema; Perkadox LW-75 (BPO) and Trigonox 101 were acquired from Akzo Nobel; and acrylic acid (AA) from Aldrich;

General Procedure: (see Table 22 for the amount of reagents in each example). Tert-butylstyrene (St), 2-(dimethylamino)ethyl methacrylate (DMAEMA), N,N-dimethyl acrylamide (DMA), DBTTC, initiator 1 (BPO), initiator 2 (Trigonox 101) and AA were placed in a double jacket glass reactor and oxygen was removed with nitrogen bubbling for 3 minutes. Oil was preheated to 120° C. and then circulated through the outside jacket, and the mixture was stirred at 145 rpm. After the desired conversion was reached, heating was suspended and additional styrene was added to the reactor with stirring. After 3 min. of stirring, the mixture was poured directly into a second reactor. Nitrogen was bubbled through, and the reactor was immersed in an oil bath, which was previously heated to 130° C., for 16 hours to reach the desired conversion.

TABLE 22
Reactive block copolymer. First step composition.

| | First Step | | | | | | |
|---|---|---|---|---|---|---|---|
| | | | | | | | Con- |
| Example | TBS | DMAEMA | DBTTC | BPO | AA | T101 | version |
| Number | (mmol) | (mmol) | (mmol) | (mmol) | (mmol) | (mmol) | % |
| 75 | 139.37 | 167.19 | 4.10 | 0.42 | 0.66 | 0.13 | 83.96 |

TABLE 23
Reactive block copolymer. Second-step composition.

Second Step

| Example | TBS | Conversion |
|---|---|---|
| Number | (mmol) | % |
| 75 | 312.00 | 100 |

Molecular weight distributions relative to polystyrene were determined through GPC (ASTM D3536-91) using a Waters 410, RI detector, THF eluent, 1.0 mL/min, at 40° C.; Styragel linear columns HR 4 and HR 3. Results are shown in Table 24.

TABLE 24
Properties of reactive block copolymer.

| Diblock | | | | | | |
|---|---|---|---|---|---|---|
| Copolymer | | | | | | |
| example | First Step | | | Total | | |
| Number | Mn | Mw | PDI | Mn | Mw | PDI |
| 75 | 6238 | 7696 | 1.23 | 9274 | 11323 | 1.22 |

### Example 76

Analyzing PP with the Reactive Block Copolymer Surface Modifier

Raw materials: Polypropylene HS013 (PP) was acquired from Indelpro. Material and was used as received.

PP and reactive block copolymer (RBC) from example 75 was mixed in different concentrations of reactive block copolymer in a Brabender at 80 rpm and 200° C. for 5 minutes. The blends were pressed to obtain a smooth surface to measure the contact angle. Contact angles were measured using a Ramé-Hart, Inc model 100-00 NRL Contact Angle Goniometer and adding 2 microliters of deionized water to the surface to be evaluated at 25° C. and 30% relative humidity. Surface energy was calculated using the following modified Owens and Wendt's equation. See S. Wu “Polymer Interface and Adhesion,” Marcel Dekker, New York 1982.

γ_{L}(1+cosθ)=2(γₛ^{d}γ_{L}^{d})^{1/2}+2(γₛ^{p}γ_{L}^{p})^{1/2} Equation 1.

where:

γ_{L}: Liquid's surface tension.

θ: Contact angle

γₛ^{d}: Substrate dispersive component

γₛ^{p}: Substrate polar component

γ_{L}^{d}: Liquid dispersive component

γ_{L}^{p}: Liquid polar component

Equation 1 is divided by 2(γ_{L}^{d})^{1/2} to obtain equation 2.

$$Modified Owens and Wendt equation . \\ ( 1 + cos θ ) \frac{{γ}_{L}}{2 {( {γ}_{L}^{d} )}^{1 / 2}} = {( {γ}_{s}^{d} )}^{1 / 2} + {( {γ}_{s}^{p} )}^{1 / 2} {( \frac{{γ}_{L}^{p}}{{γ}_{L}^{d}} )}^{1 / 2} . \qquad Equation 2$$

With this equation, it is possible to plot the left side of equation 2 as a function of

$${( \frac{{γ}_{L}^{p}}{{γ}_{L}^{d}} )}^{1 / 2}$$

to obtain the slope as (γₛ^{p})^{1/2} and intercept on the y-axis as (γₛ^{d})^{1/2}. With this plot, values for polar and dispersive forces were obtained.

Surface energy was calculated using equation 3.

γₛ=γₛ^{p}+γₛ^{d} Equation 3. Surface energy.

Water and ethylene glycol were used to calculate surface energy, and the results are shown in Table 25.

TABLE 25
Surface energy.

| | RBC | Polar | Dispersive | Surface |
|---|---|---|---|---|
| PP | example 75 | energy | energy | energy |
| % w | % w | γ^{p}ₛ | γ^{d}ₛ | γₛ |
| 100 | 0 | 32.74 | 4.10 | 36.83 |
| 95 | 5 | 34.40 | 4.37 | 38.77 |
| 90 | 10 | 37.69 | 4.48 | 42.17 |
| 85 | 15 | 40.35 | 4.59 | 44.94 |
| 80 | 20 | 40.24 | 5.15 | 45.39 |
| 75 | 25 | 42.67 | 5.24 | 47.92 |

It is understood that an increase in surface energy indicates that the wettability of the surface also increases. As is shown in the Table 25, the surface energy of the PP increased as the amount of RBC was increased. The PP with no RBC added had a surface energy of 36.83. Adding increments of 5, 10, 15, 20 and 25% wt RBC from example 75 increased the surface energy of the PP to 38.77, 42.17, 44.94, 45.39 and 47.92, respectively. Consequently, by adding the RBC made in example 75 to PP, the PP was made more wettable, paintable, coatable, etc., because polar functional groups were added to the PP in that the RBC bonded to the PP and contained the polar functional groups.

In general, the stable free radical controlling agents described herein are believed to form a diblock copolymer having an AB structure. However, it is believed that use of dibenzyl trithiocarbonate or DBTTC as the stable free radical leads to formation of a triblock copolymer. With DBTTC, in the first step a block A is formed from monomers A and residual monomer, which includes a functional monomer, remains unreacted. However, in the second step, when a group of monomers B is added, the unreacted residual monomers from the first block is incorporated into the B block, but instead of yielding an AB diblock copolymer, it is believed that a final structure of ABBA (ABA) is obtained. It is believed that the triblock is formed automatically, because during the polymerization, S—C bonds break and incorporate monomers, which forms the ABBA (ABA) structure, instead of an AB structure that would be expected from a nitroxide-based stable free radical.

Summarizing, a process has been described in which a tailored or customized reactive block copolymer is made in a two-step process, where residual, unreacted acrylic monomer with functional groups from the first step is incorporated into a second block during a second step for making the reactive block copolymer and reacting the reactive block copolymer with a polymeric material, where the functional groups on the acrylic monomer alter the surface properties of the polymeric material. A treated polymeric material, formed by mixing and/or reacting a reactive block copolymer with the polymeric material, has a surface energy that is different from the surface energy of the polymeric material, having either greater or lesser surface energy. Desired properties can be imparted to a polymeric material by careful selection of acrylic monomers and by careful selection of functional groups on the acrylic monomers. Desired properties can be further achieved by careful selection of the vinyl monomers used in the second step for making a reactive block copolymer.

Applications for reactive block copolymers for chain extension and for surface modification have been described herein. A further application for reactive block copolymers is in a combination of chain extension and surface modification. A properly-selected reactive block copolymer can be used to extend the length of polymer chains in recycled PET, increasing the molecular weight of the recycled PET and improving the performance characteristics of the recycled PET. The properly-selected reactive block copolymer used for chain extension can also alter the surface properties of the recycled PET; for example, increasing the surface energy and/or polarity of the recycled PET to make the recycled PET more paintable, dyeable, wettable, coatable, printable, able to dissipate an electrostatic charge, colorable, capable of adsorption, and capable of bonding with an adhesive. Thus, another aspect of the present invention is a process for increasing the average molecular weight of a polymeric material and changing the surface properties of the polymeric material, comprising the steps of reacting a first polymer with a reactive block copolymer; wherein the reactive block copolymer is made by a process comprising (a) reacting an acrylic monomer having functional groups and one or more vinyl monomers in the presence of a free radical initiator and a stable free radical in a first step to form a reaction product, wherein the reaction product includes residual unreacted acrylic monomer; and (b) reacting in a second step one or more vinyl monomers with the reaction product from the first step to form a second block, wherein the second block incorporates the residual unreacted acrylic monomer; and reacting a second polymer with the reactive block copolymer, wherein the first and second polymers may be the same polymers or different polymers, wherein the first and second polymers have reactive functional groups whereby a bond forms between the first polymer and the reactive block copolymer and a bond forms between the second polymer and the reactive block copolymer such that the reactive block copolymer serves as a common backbone for the first and second polymers, and wherein the functional groups on the acrylic monomer alter the surface properties of the first and second polymers.

The claims for this invention follow this specification, and the claims in this application and the claims in its parent application published as U.S. Publication No. 2007/0049696 A1 are incorporated by reference into this specification for further description of the invention. Having described the invention above, various modifications of the techniques, procedures, materials, and equipment will be apparent to those skilled in the art. It is intended that all such variations within the scope and spirit of the invention be included within the scope of the appended claims or within the scope of claims subsequently made to the invention.

What is claimed is:

1. A process for effectively extending the length of polymer chains using a chain extender, comprising the steps of:
reacting a first polymer with the chain extender; wherein the chain extender is made by a process comprising:
a) reacting an acrylic monomer having functional groups and one or more vinyl monomers in the presence of a free radical initiator and a stable free radical in a first step to form a reaction product, wherein the reaction product includes residual unreacted acrylic monomer; and
b) reacting in a second step one or more vinyl monomers with the reaction product from the first step to form a second block, wherein the second block incorporates the residual unreacted acrylic monomer; and
reacting a second polymer with the chain extender, wherein the first and second polymers may be the same polymers or different polymers, and wherein the first and second polymers have reactive functional groups whereby a bond forms between the first polymer and the chain extender and a bond forms between the second polymer and the chain extender such that the chain extender serves as a common backbone for the first and second polymers.

2. The process of claim 1, wherein the first and second polymers are selected from the group consisting of polyesters, polycarbonates, polyurethanes, polylactic acids, lactide polymers, polyhydroxyalkanoate (PHA) polymers, polysulfones, polyacetals, polyamides, polyimides, polyether imides, polyether sulfones, polyphenylene ethers, polyether ketones, polyether-ether ketones, polyarylether ketones, polyarylates, polyphenylene sulfides and polyalkyls.

3. The process of claim 2, wherein the first and second polymers are essentially the same polymeric material.

4. The process of claim 2, wherein the acrylic monomer is selected from the group consisting of glycidyl methacrylate, acrylic acid, methacrylic acid, 2-hydroxyethyl methacrylate, maleic anhydride, 2-dimethylaminoethyl methacrylate and 2-diethylaminoethyl methacrylate, and wherein the functional groups on the acrylic monomer alter the surface properties of the first and second polymers.

5. The process of claim 4, wherein the one or more vinyl monomers in steps (a) and (b) are selected from the group consisting of styrene, N-phenylmaleimide, methyl methacrylate and butyl acrylate.

6. The process of claim 1, wherein the first and second polymers are selected from the group consisting of polyesters, polycarbonates, polyurethanes, polylactic acids, lactide polymers, polyhydroxyalkanoate (PHA) polymers, polysulfones, polyacetals, polyamides, polyimides, polyether imides, polyether sulfones, polyphenylene ethers, polyether ketones, polyether-ether ketones, polyarylether ketones, polyarylates, polyphenylene sulfides and polyalkyls, wherein the acrylic monomer is glycidyl methacrylate, wherein the one or more vinyl monomers in steps (a) and (b) is styrene, and wherein the reaction product includes at least 0.03 mole percent unreacted residual acrylic monomer.

7. The process of claim 1, wherein the stable free radical is a nitroxyl free radical, and wherein the stable free radical is formed from an alkoxyamine.

8. The process of claim 1, wherein the stable free radical is iodine.

9. The process of claim 8, wherein the process for making the chain extender is carried out at a temperature below about 110° C.

10. A method for increasing the molecular weight of a polymeric material, comprising:
a) mixing the polymeric material with a chain extender in a reactor, wherein the polymeric material has a number average molecular weight (MWn), and wherein the chain extender comprises a first block comprising monomeric units of a functionalized acrylic monomer and monomeric units of a vinyl monomer and a second block comprising monomeric units of one or more vinyl monomers and monomeric units of the functionalized acrylic monomer in the first block; and
b) forming a product material having a number average molecular weight, wherein the MWn of the product material is greater than the MWn of the polymeric material.

11. The method of claim 10, wherein the polymeric material has reactive functional groups, and wherein the functional groups on the acrylic monomer increase the polarity of the polymeric material so that the polarity of the product material is greater than the polarity of the polymeric material.

12. The method of claim 10, wherein chain extender comprises less than about 20 weight percent of the product material.

13. The method of claim 10, wherein the number average molecular weight of the chain extender ranges between about 5,000 and about 200,000.

14. The process of claim 10, wherein the stable free radical is selected from the group consisting of 2,2,6,6-tetramethyl-1-piperidinyloxy, 4-hydroxyl-2,2,6,6-tetramethyl-1-piperidinyloxy, 4-oxo-2,2,6,6-tetramethyl-1-piperidinyloxy, tert-butyl 1-diethylphosphono-2,2-dimethylpropyl ntroxide, tert-butyl 1-phenyl-2-methylpropyl nitroxide, and iodine.

15. A method for recycling polymers, comprising:
reclaiming a polymeric material that was previously formed in a polymerization reaction, wherein the polymeric material has reactive functional groups, and wherein the polymeric material has an average molecular weight;
feeding the polymeric material to a reactor;
feeding a chain extender to the reactor, wherein the chain extender comprises a block copolymer comprising first and second blocks, wherein the first block comprises monomeric units of a functionalized acrylic monomer and monomeric units of a vinyl monomer, and wherein the second block comprises monomeric units of one or more vinyl monomers and monomeric units of the functionalized acrylic monomer in the first block; and
recovering a polymer product from the reactor, wherein the average molecular weight of the polymer product is greater than the average molecular weight of the polymeric material.

16. The method of claim 15, wherein the polymeric material comprises one or more polymers selected from the group consisting of polyesters, polycarbonates, polyurethanes, polylactic acids, lactide polymers, polyhydroxyalkanoate (PHA) polymers, polysulfones, polyacetals, polyamides, polyimides, polyether imides, polyether sulfones, polyphenylene ethers, polyether ketones, polyether-ether ketones, polyarylether ketones, polyarylates, polyphenylene sulfides and polyalkyls.

17. The method of claim 15, wherein the vinyl monomer of the first block are selected from the group consisting of styrene, substituted styrenes, substituted acrylates and substituted methacrylates, wherein the one or more vinyl monomers in the second block is selected from the group consisting of styrene, substituted styrenes, acrylonitrile, N-aromatic substituted maleimides, N-alkyl substituted maleimides, maleic anhydride, acrylic acid, methyl methacrylate, alkyl substituted acrylates, aryl substituted acrylates, alkyl substituted methacrylates, aryl substituted methacrylates and 2-hydroxyethyl methacrylate, and wherein the acrylic monomer is selected from the group consisting of glycidyl methacrylate, acrylic acid, methacrylic acid, 2-hydroxyethyl methacrylate, maleic anhydride, 2-dimethylaminoethyl methacrylate and 2-diethylaminoethyl methacrylate.

18. The method of claim 15, wherein the amount of chain extender fed to the reactor is less than or equal to about 10 weight percent of the polymer product recovered.

19. A composition for a recycled plastic, comprising:
80-99 weight percent of reclaimed polymer, wherein the reclaimed polymer is a polymeric material formed by polymerization and molded into one or more articles, wherein the reclaimed polymer is derived from the articles, and wherein the reclaimed polymer has reactive functional groups and an average molecular weight; and
1-20 weight percent of a chain extender comprising a block copolymer comprising first and second blocks, wherein the first block comprises monomeric units of a functionalized acrylic monomer and monomeric units of a vinyl monomer, and wherein the second block comprises monomeric units of one or more vinyl monomers and monomeric units of the functionalized acrylic monomer in the first block,
wherein the reclaimed polymer and the chain extender are bound together to form the recycled plastic, and wherein the recycled plastic has an average molecular weight that is greater than the average molecular weight of the reclaimed polymer.

20. The composition of claim 19, wherein the reclaimed polymer comprises a polyester selected from the group consisting of polyethylene terephthalate (PET), polybutylene terephthalate (PBT), polyethylene naphthalate (PEN), polycyclohexane-bis-methylene terephthalate (PCT), copolymers of PET, copolymers of PBT, copolymers of PEN and copolymers of PCT, and wherein the functionalized acrylic monomer comprises from about 5 to about 15 weight percent of the chain extender.
